(19) United States
(12) Patent Application Publication
(10) Pub. No.: US 2024/0338908 A1
(43) Pub. Date: Oct. 10, 2024

(54) TECHNIQUES AND GRAPHICS-PROCESSING ASPECTS FOR ENABLING SCENE RESPONSIVENESS IN MIXED-REALITY ENVIRONMENTS, INCLUDING BY USING SITUATED DIGITAL TWINS, AND SYSTEMS AND METHODS OF USE THEREOF

(71) Applicant: Meta Platforms Technologies, LLC, Menlo Park, CA (US)

(72) Inventors: Mohamed Kari, Essen (DE); Rajinder Sodhi, Seattle, WA (US)

(21) Appl. No.: 18/625,186

(22) Filed: Apr. 2, 2024

Related U.S. Application Data
(60) Provisional application No. 63/494,449, filed on Apr. 5, 2023.

(51) Int. Cl. G06T 19/00; G06F 3/01

(52) U.S. Cl. CPC G06T 19/006; G06F 3/011; G06T 2200/24

(57) ABSTRACT

A method includes obtaining image data captured by an imaging device communicatively coupled with an artificial-reality system. The method includes generating a plurality of layers based on the image data including a first layer including an image of a real-world scene that includes a real-world object, and a second layer including a geometric representation of the real-world scene. The method includes, in accordance with determining that the real-world object meets digital-interaction criteria, generating a digital twin of the real-world object. The method includes, while causing presentation of a portion of one or more layers of the plurality of layers, in response to an interaction with one of the real-world object or the digital twin, updating the second layer such that the digital twin of the object is modified in response to the interaction, and ceasing to cause presentation of the portion of the real-world scene from within the first layer.

### CROSS-REFERENCE TO RELATED APPLICATIONS

This application claims priority to U.S. Prov. App. No. 63/494,449, filed on Apr. 5, 2023, and entitled “Techniques And Graphics-Processing Aspects For Enabling Scene Responsiveness In Mixed-Reality Environments, Including By Using Situated Digital Twins, And Systems And Methods Of Use Thereof,” which is hereby incorporated by reference in its entirety.

### TECHNICAL FIELD

This disclosure relates generally to presenting mixed-reality environments via artificial-reality systems, including but not limited to techniques for presenting responsive representations of real-world scenes via artificial-reality headsets.

### BACKGROUND

In recent years, artificial-reality continues to gain interest. Many artificial-reality systems present immersive artificial-reality environments to users. Some artificial-reality systems can present image data of real-world scenes to users (e.g., passthrough mode). But such systems are limited in providing users with the ability to interact with the real-world scenes from within the artificial-reality environments presented by the artificial-reality systems. Such artificial-reality systems lack the ability to present realistic representations of real-world scenes that are responsive to interactions by users and virtual content presented in the artificial-reality environments, and thus, fall short of exampled visual illusions to believable environment manipulations.

As such, there is a need to address one or more of the above-identified challenges. A brief summary of solutions to the issues noted above are described below.

### SUMMARY

The methods, systems, and devices described herein allow users to experience scene responsive artificial-reality environments where virtual actions (e.g., virtual character interactions) affect representations of real-world scenes. In some embodiments, the scene responsive artificial-reality environments provide interactions with digital twins of real-world objects in the real-world scenes. In some embodiments, the scene responsive artificial-reality environments provide interactions between virtual characters (e.g., digitally-generated assistants) and the representations of the real-world scenes. Further, through the use of the systems and methods disclosed herein, virtual characters can appear to interact with physical objects in a user's real-world environment while maintaining visual coherence in an artificial-reality environment.

Thus, the artificial-reality environments described herein provide technical improvements to current artificial-reality systems, many of which not explicitly described here will become apparent to one of skill in the art in light of this disclosure. The artificial-reality environments described herein provide intuitive for integrating virtual and physical reality, allowing users to efficiently situate themselves within artificial-reality environments. Some of the embodiments described herein include graphics processing techniques that improve responsiveness of representations of real-world scenes to virtual interactions (e.g., virtual content, virtual actions).

One example method of presenting a visual representation of a real-world scene within an artificial-reality environment is described. The method includes obtaining image data captured by an imaging device communicatively coupled with an artificial-reality system. The method includes generating a plurality of layers based on the image data, the plurality of layers includes a first layer including an image of a real-world scene that includes a real-world object. And the plurality of layers includes a second layer including a geometric representation of the real-world scene. The method includes, in accordance with determining that the real-world object meets digital-interaction criteria, generating, via the artificial-reality system, a digital twin of the object. And the method includes, while causing presentation, via the artificial-reality system, of a portion of one or more layers of the plurality of layers, in response to an interaction with one of (i) the real-world object or (ii) the digital twin of the real-world object, updating the second layer such that the digital twin of the object is modified in response to the interaction, and ceasing to cause presentation of the portion of the real-world scene from within the first layer.

Having summarized the first aspect generally related to presenting a visual representation of a real-world scene within an artificial-reality environment above, a second aspect generally related to presenting visual previews of modifications that would be caused by an interaction with a digital twin of an object in the user's real-world scene-is now summarized.

In an example method of the second aspect, a method of interacting with visual representation of a real-world scene within an artificial-reality environment is described. The method includes operations that are performed while causing presentation of a representation of a real-world environment at an artificial-reality headset. The operations include identifying a real-world object in the real-world environment that meets digital-interaction criteria. The operations include causing presentation, via the artificial-reality system, of a user-interface element for interacting with a digital twin corresponding to the real-world object within the real-world scene. The operations include, in response to a user moving a focus selector within an interaction distance of the user-interface element, causing presentation of a visual preview of a modification to the digital twin that would be made upon selection of the user-interface element, wherein causing presentation of the visual preview of the modification includes accounting for another aspect of the real-world environment, distinct from the real-world object.

Having summarized the second aspect generally related to presenting visual previews of modifications that would be caused by an interaction with a digital twin of an object in the user's real-world scene, a third aspect generally related to facilitating interactions, via artificial-reality environments, between different users in different real-world scenes is now summarized.

In an example method of the third aspect, a method of sharing artificial-reality experiences is described. The method includes operations that are performed while causing presentation of a first representation of a first real-world environment at a first artificial-reality headset and a second representation of a second real-world environment at a second artificial-reality headset. The operations include, in response to receiving an indication of a user input provided by a first user interacting with a first digital twin corresponding to a real-world object in the first real-world environment that meets digital-interaction criteria: (a) causing presentation of a modified first digital twin in the first real-world environment, wherein the modified first digital twin is a modification of the first digital twin based on the user input, (b) in accordance with a determination that no digital twins in the second real-world environment match the first digital twin, determining whether a second digital twin corresponding to a real-world object in the second real-world environment satisfies similarity criteria with the first digital twin, and (c) responsive to a determination that the second digital twin satisfies the similarity criteria, causing presentation of a modified second digital twin in the second real-world environment, wherein the modified second digital twin is (i) a modification of the first digital twin based on the user input and (ii) accounts for an aspect of the second real-world environment.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1V illustrate interaction with a digital twin, in accordance with some embodiments.

FIGS. 2A-2C illustrate an example sequence of presenting artificial-reality environments to users in different physical environments, in accordance with some embodiments.

FIGS. 3A-3M illustrate an example sequence for scanning and presenting a representation of a real-world scene, in accordance with some embodiments.

FIGS. 4A-4J illustrate additional examples of interactions between users and/or virtual characters (e.g., digitally-generated assistants) and the respective real-world scenes being presented by respective artificial-reality headsets, in accordance with some embodiments.

FIG. 5 shows an example logical flow diagram indicating interactive relationships between users and virtual characters presented by artificial-reality systems, in accordance with some embodiments.

FIGS. 6A-6B illustrates a flow diagram of a method for the generation of a representation of a real-world scene and one or more digital twins, in accordance with some embodiments.

FIG. 7 shows an example method for presenting a visual representation of a real-world scene within an artificial-reality environment, in accordance with some embodiments.

FIG. 8 shows an example method for presenting visual previews of modifications that would be caused by an interaction with a digital twin of a real-world object in the user's real-world scene, in accordance with some embodiments.

FIG. 9 shows an example method for facilitating interactions, via artificial-reality environments, between different users in different real-world scenes, in accordance with some embodiments.

FIGS. 10A-10C-2 illustrate example artificial-reality systems, in accordance with some embodiments.

FIGS. 11A and 11B illustrate an example wrist-wearable device 1100, in accordance with some embodiments.

FIGS. 12A-12C illustrate example head-wearable devices, in accordance with some embodiments.

FIGS. 13A and 13B illustrate an example handheld intermediary processing device, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with various types or embodiments of artificial-reality systems. Artificial-reality, as described herein, is any superimposed functionality and or sensory-detectable presentation provided by an artificial-reality system within a user's physical surroundings. Such artificial-realities (AR) can include and/or represent virtual reality (VR), augmented reality, mixed artificial-reality (MAR), or some combination thereof.

In some embodiments of an AR system, ambient light (e.g., a live feed of the surrounding environment that a user would normally see) can be passed through a display element of a respective head-wearable device presenting aspects of the AR system (e.g., via a passthrough mode of an AR headset within the AR system). In some embodiments, ambient light can be passed through respective aspect of the AR system. For example, a visual user interface element (e.g., a notification user interface element) can be presented at the head-wearable device, and an amount of ambient light (e.g., 15-50% of the ambient light) can be passed through the user interface element, such that the user can distinguish at least a portion of the physical environment over which the user interface element is being displayed. In some embodiments, the passing through of the ambient light and additional photometric data about the real-world scene surrounding the user is accommodated via cameras, which may be in electronic communication with the AR headset. That is, there may be no physical light passed through any display portion (e.g., lenses of the AR headset), but instead imaging data of the user's surroundings may be integrated with the artificial-reality environment being presented to the user.

Artificial-reality content can include completely generated content or generated content combined with captured (e.g., real-world) content. The artificial-reality content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create content in an artificial reality and/or are otherwise used in (e.g., to perform activities in) an artificial reality.

As described herein, scene responsiveness is a visual effect that causes physical scenes to respond to virtual actions. For example, scene responsiveness can include visual effects that cause physical objects' poses, shapes, and states to appear to be manipulated by virtual characters and/or virtual actions of a user within an artificial-reality environment that is presenting a representation of the physical object (e.g., a photometric representation, a geometric representation, a digital twin, etc.).

As described herein, scene awareness is a visual effect that causes virtual objects and characters to appear to be respecting semantics of a physical environment that is being represented within the artificial-reality environment (e.g., a real-world scene).

As described herein, semantics of real-world objects, include characteristics of the real-world object that are reflected in how the real-world object is interacted with. Such semantics may include, for example, structural aspects of real-world objects (e.g., determining that an object includes a navigable surface (e.g., a floor), determining that an object includes sub-objects (e.g., a bookshelf that includes a plurality of books), determining that an object is in a particular pose (e.g., that a chair is in an upright position)). Semantics may include identifiable functional aspects of the real-world objects (e.g., identifying a seat of a chair), and/or identifiable aspects of the scene as a whole (e.g., recognizing that the real-world scene is a portion of a library or a basketball court).

As described herein, a real-world object can either refer to the physical object itself, or a representation of the real-world object that is not a digital twin of the real-world object (e.g., a non-interactable representation of the object within a representation of the real-world scene being presented by a user's artificial-reality headset).

As described herein, a reality toggle (e.g., reality toggling) can include spatial computing and shading components that change (e.g., toggle) a real-world objects reality state by virtualizing it for the core illusion of scene-responsiveness.

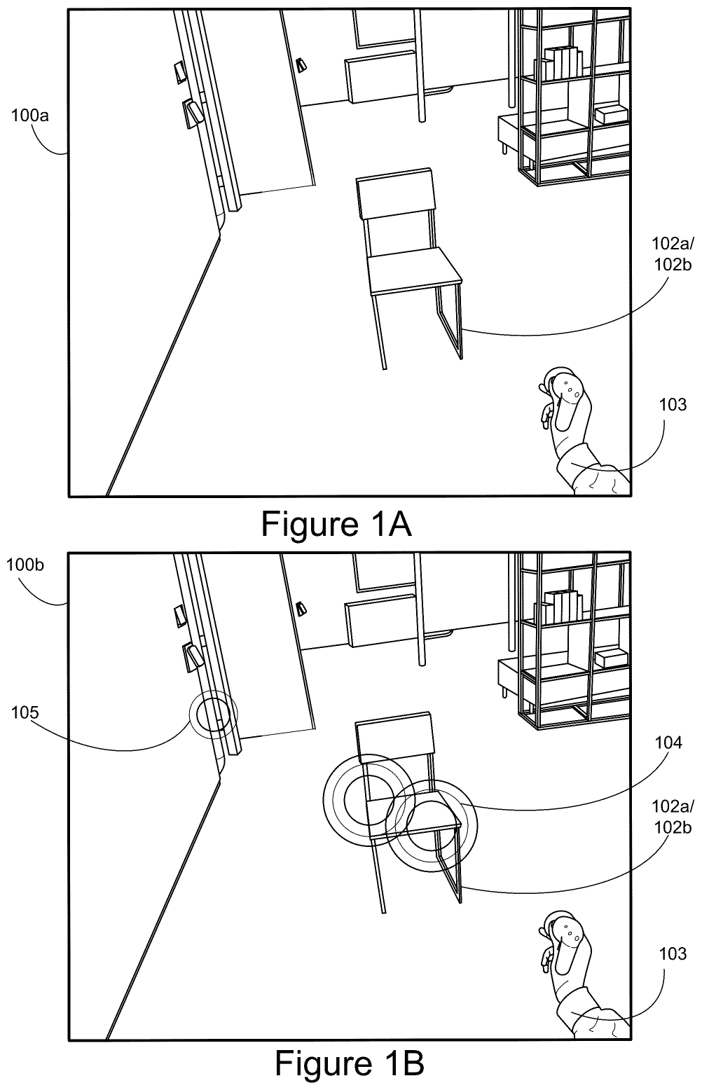

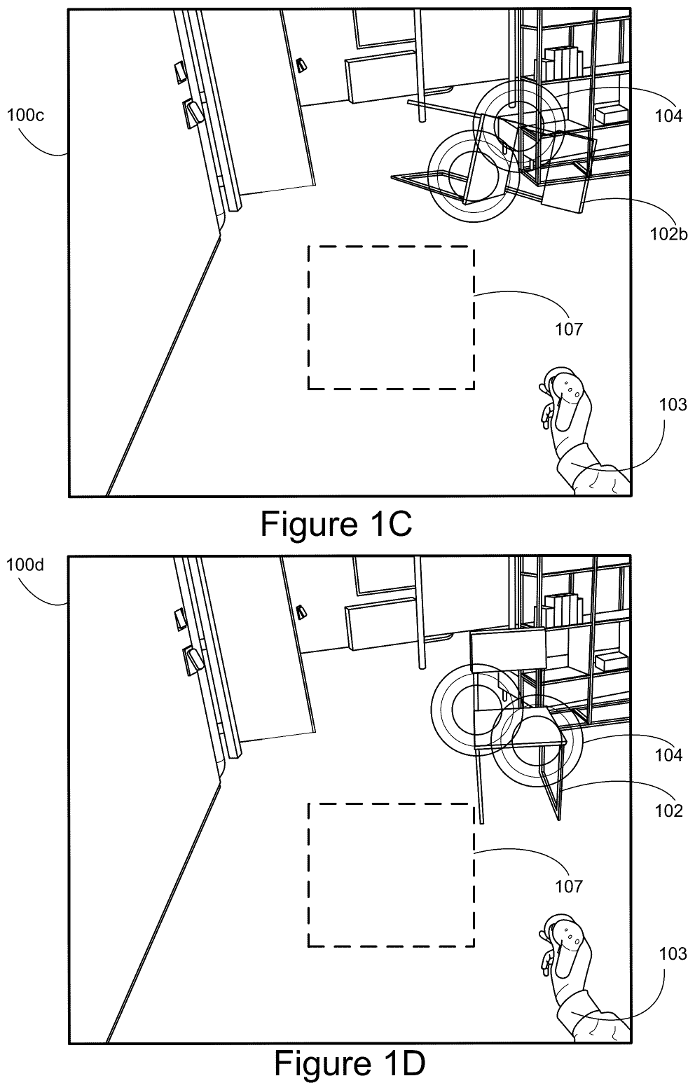

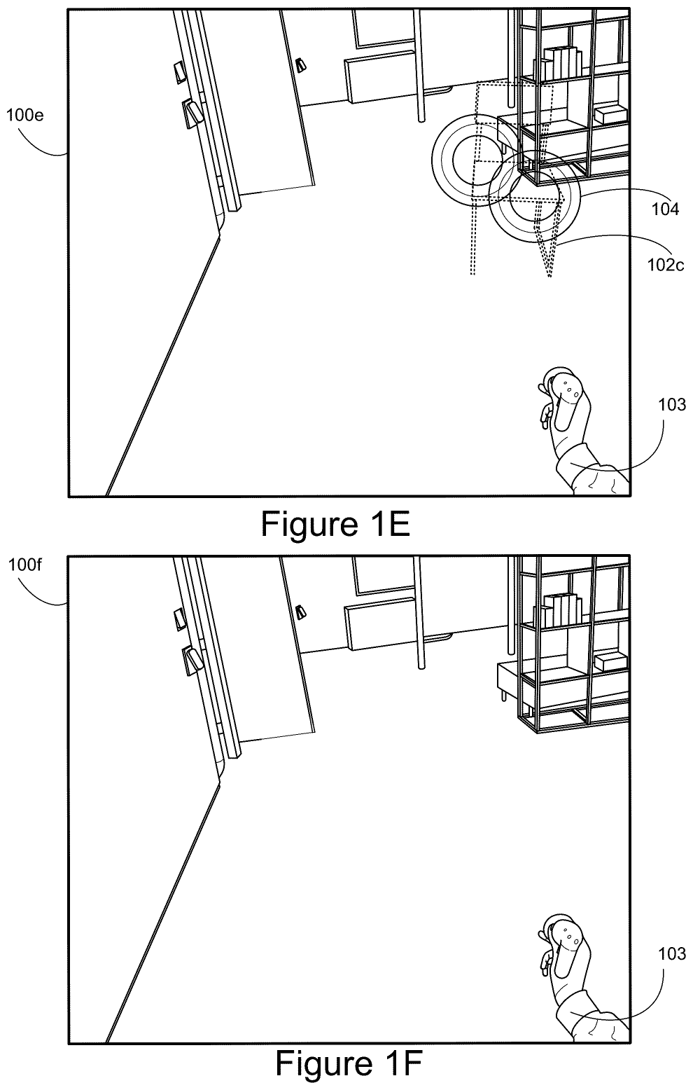

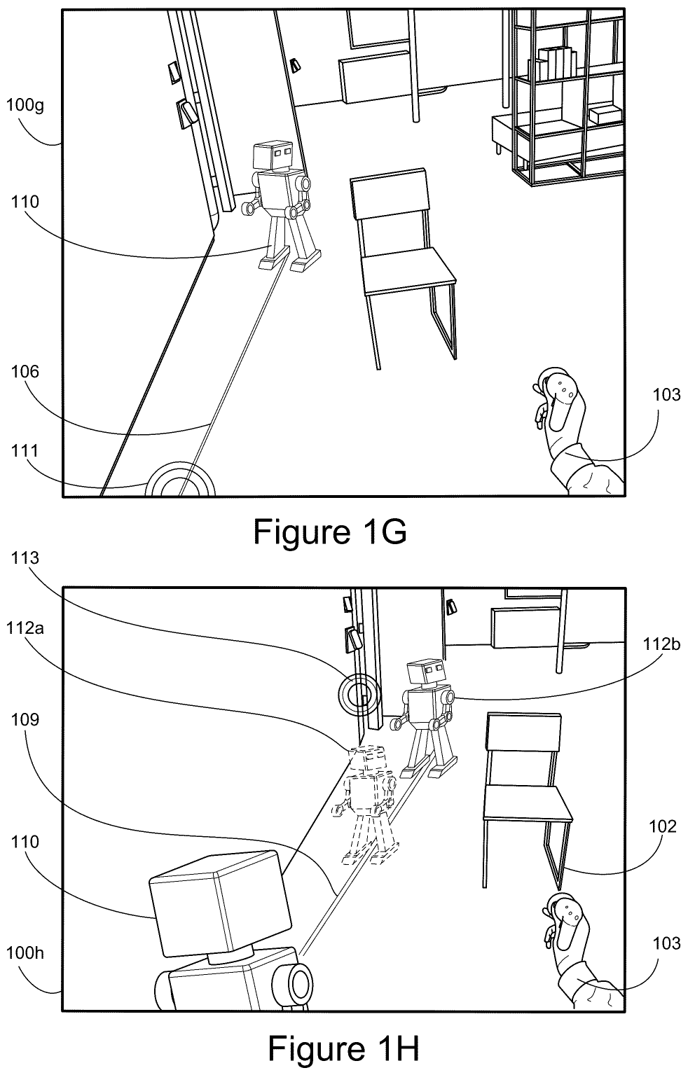

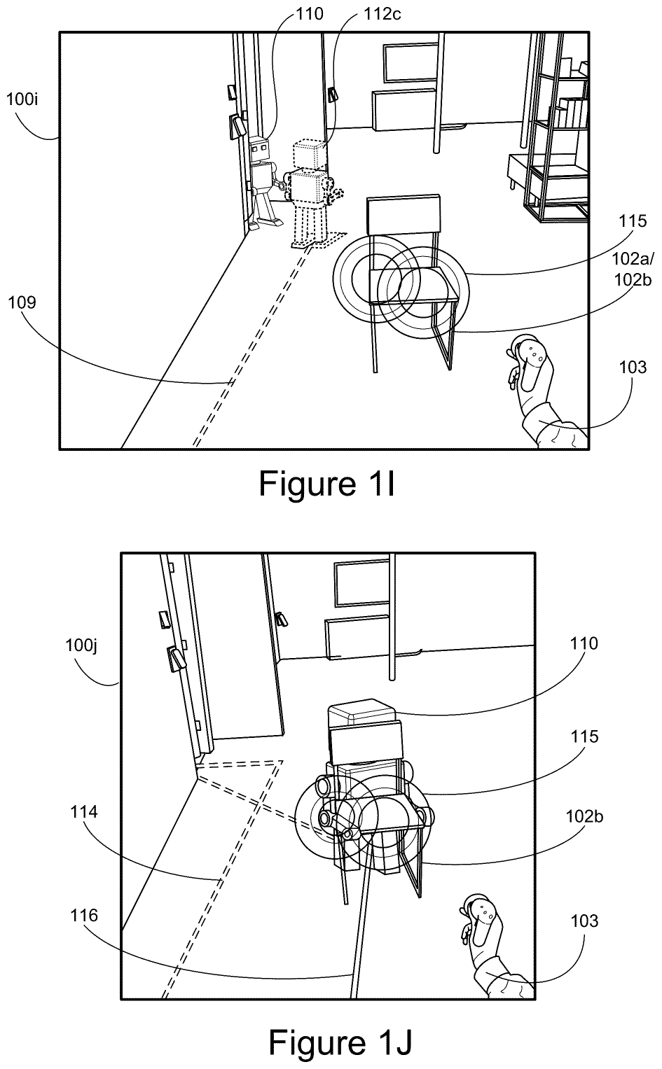

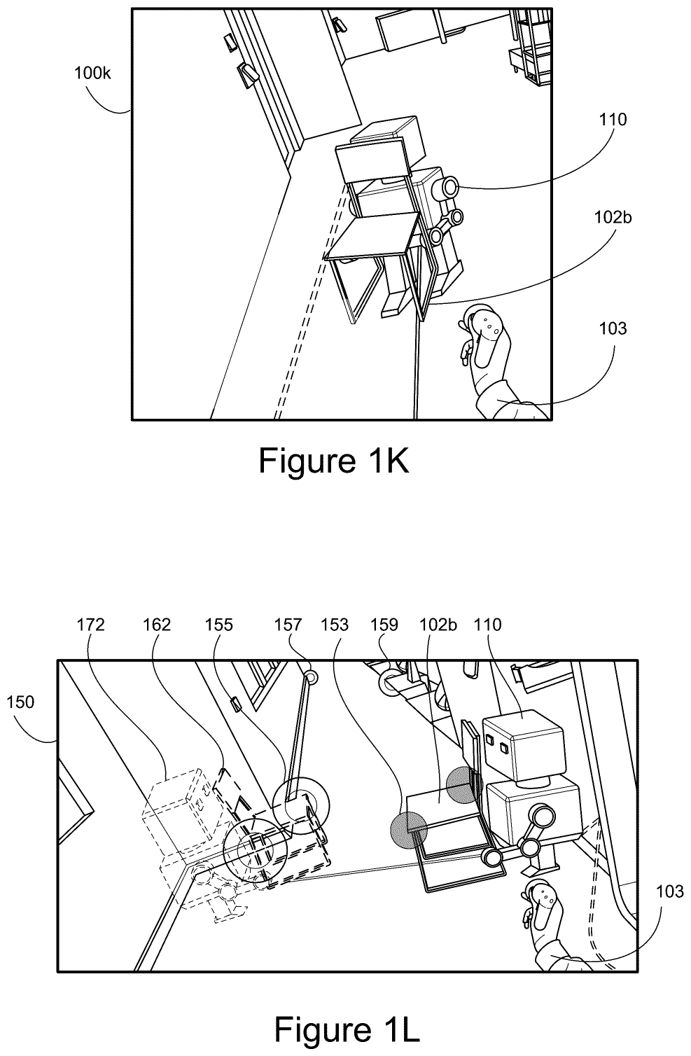

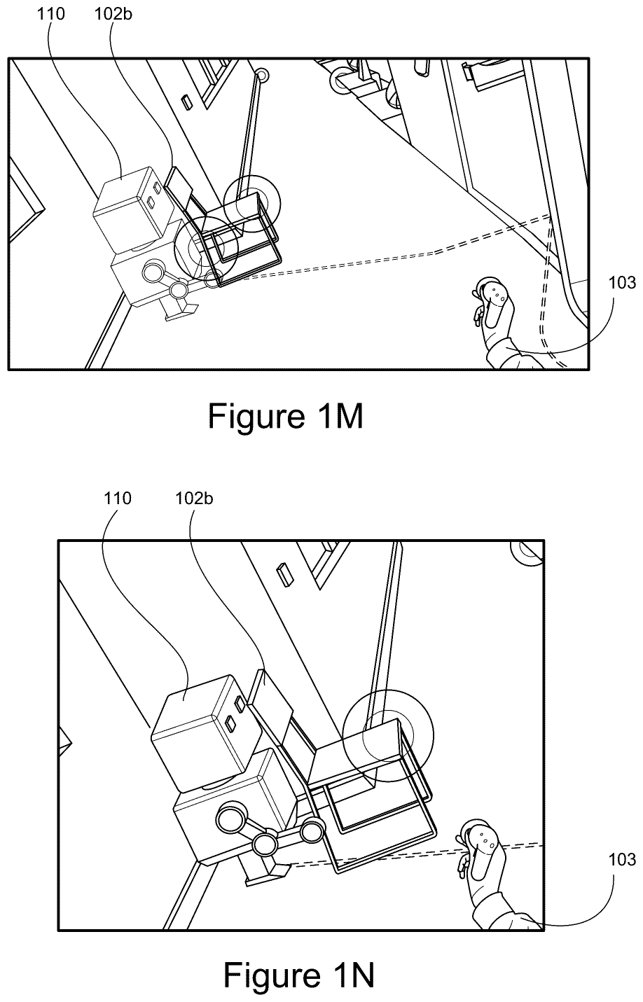

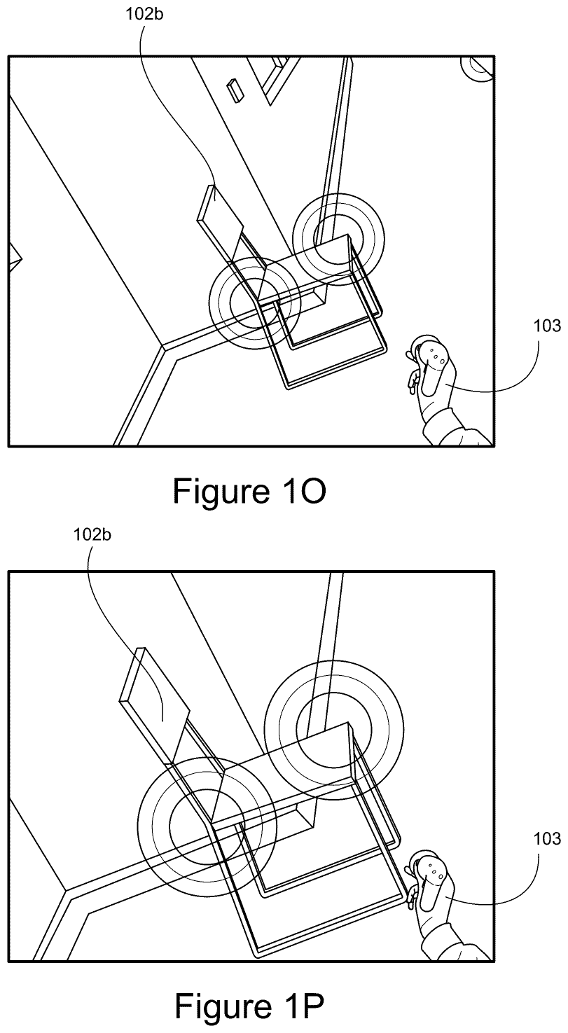

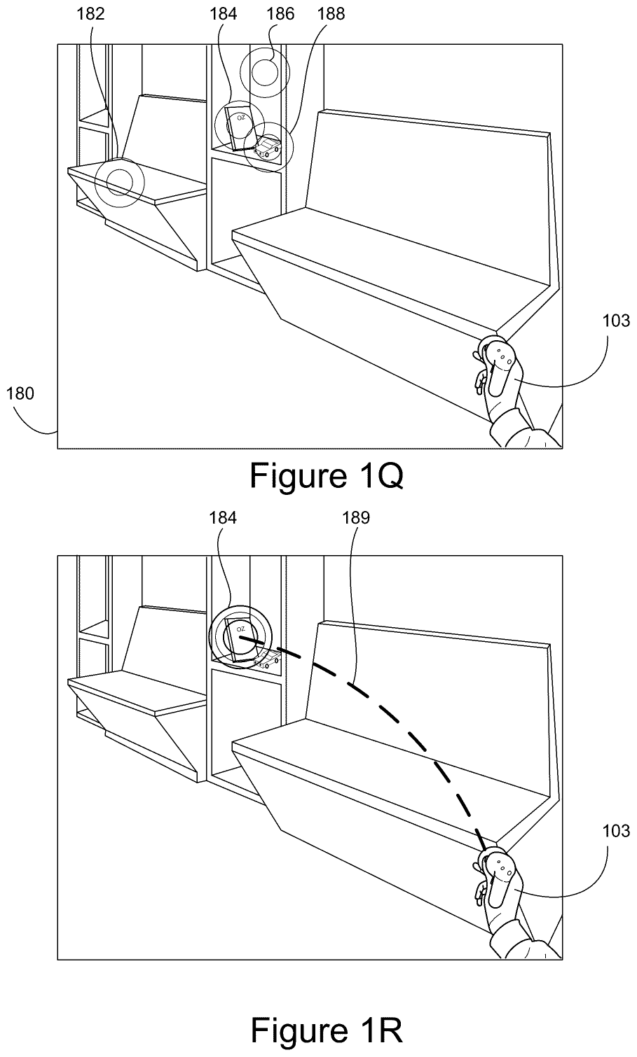

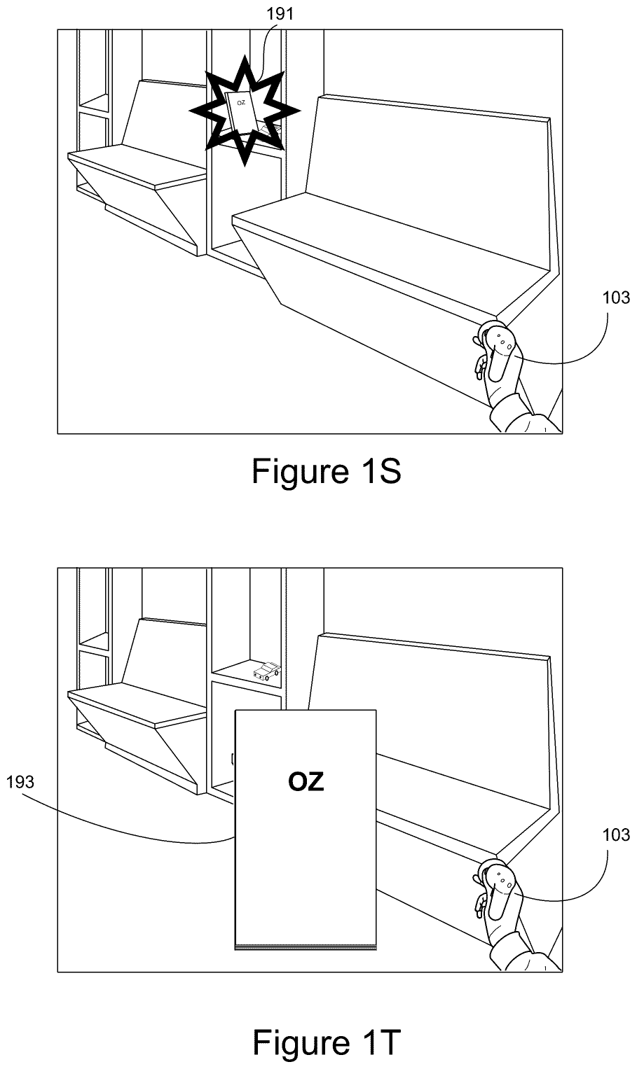

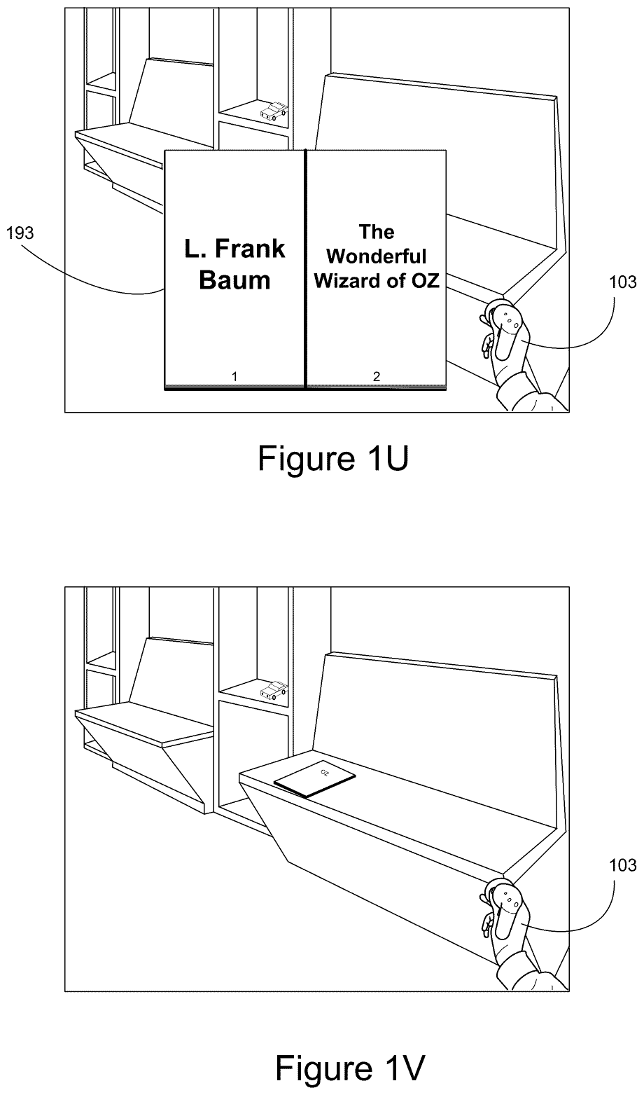

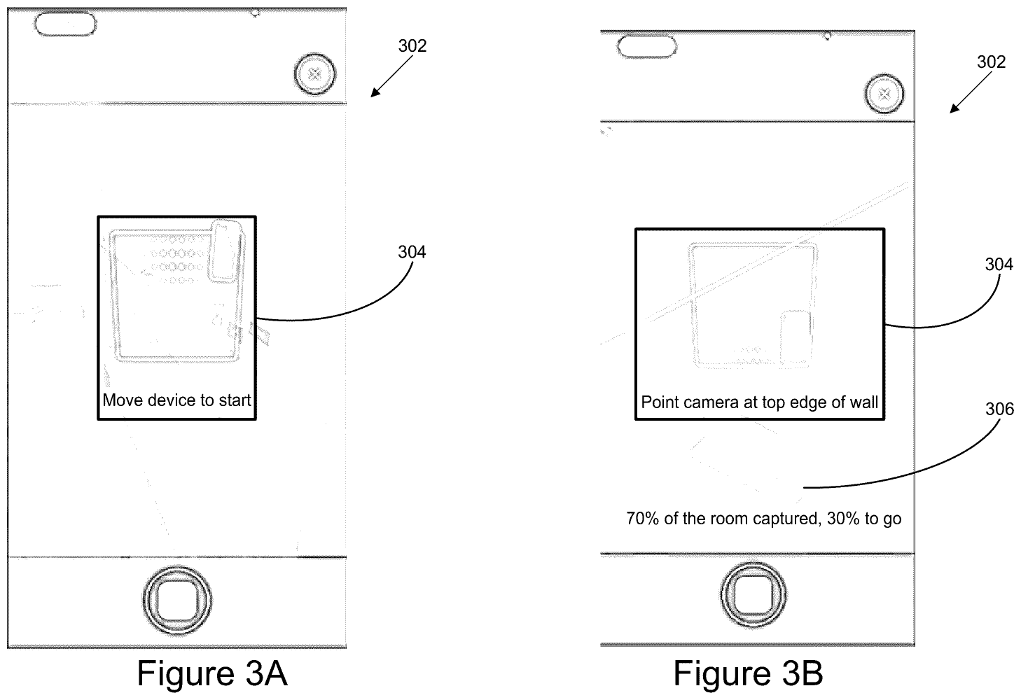

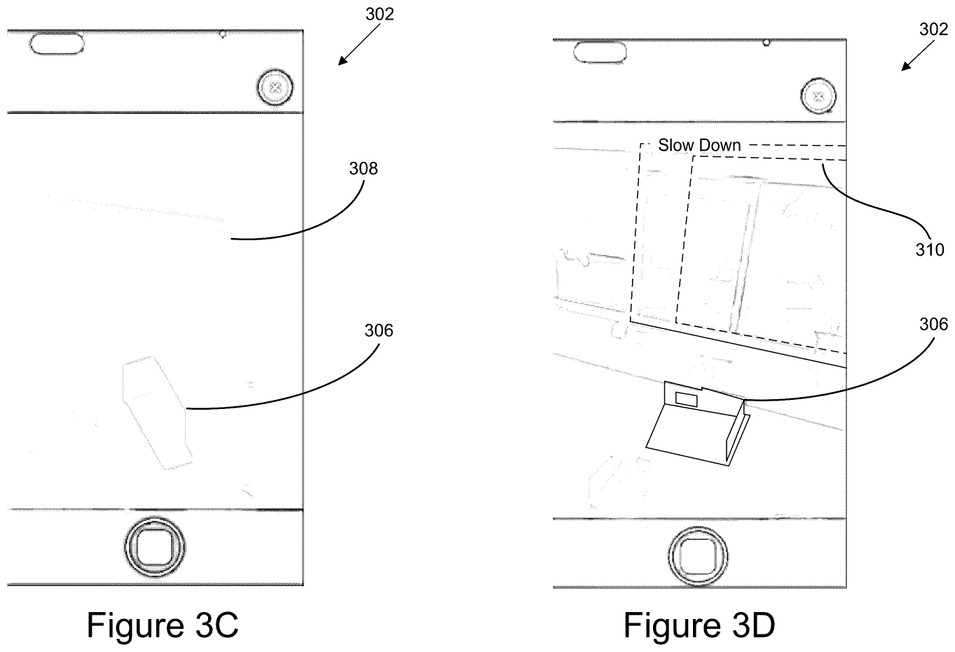

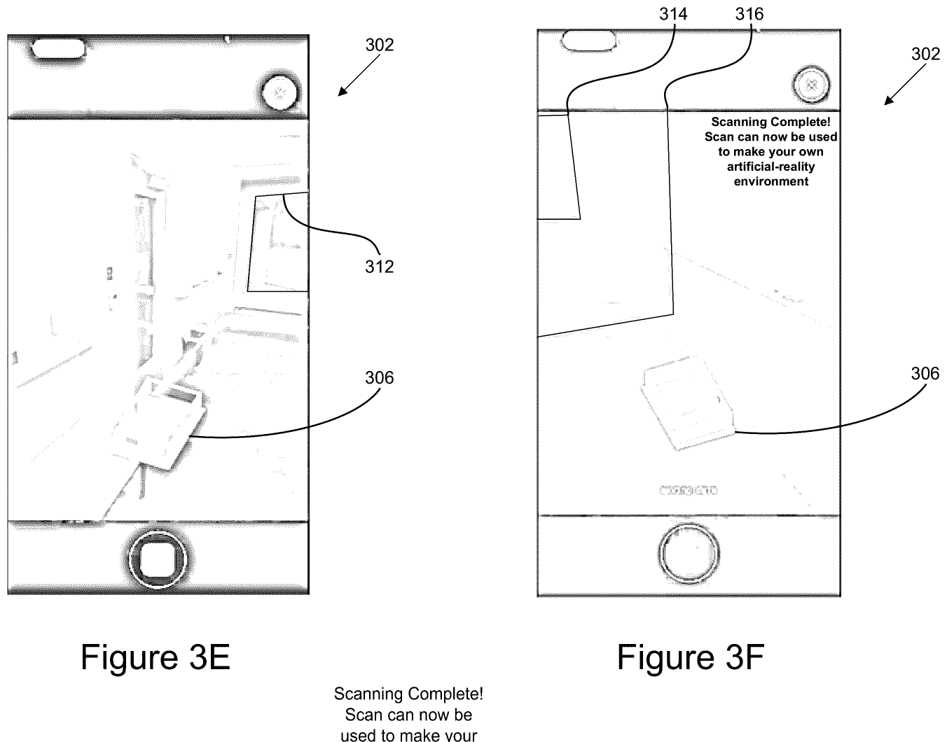

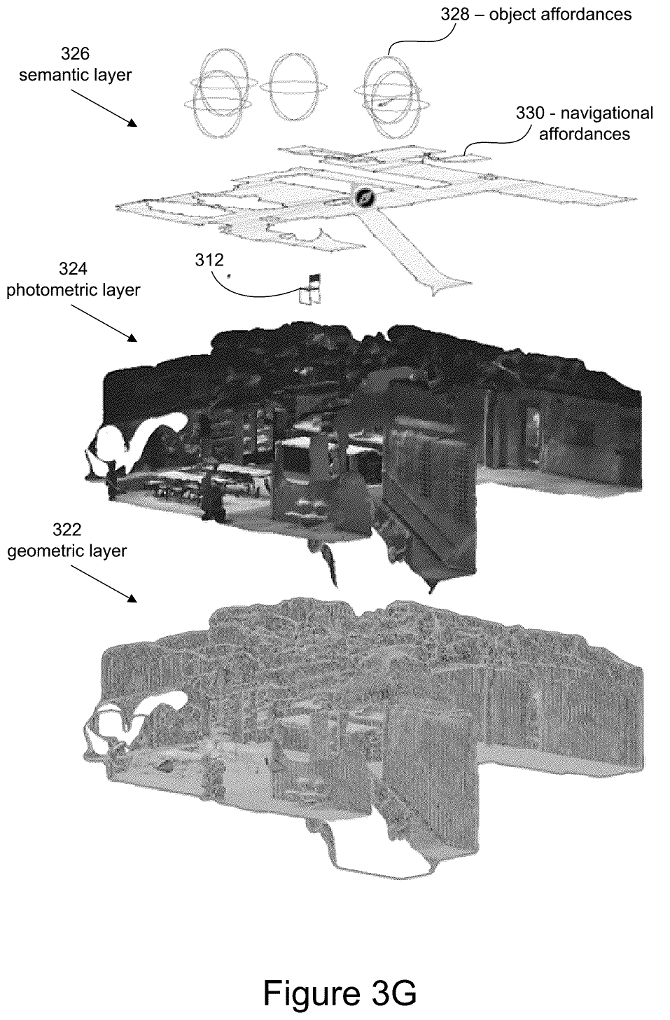

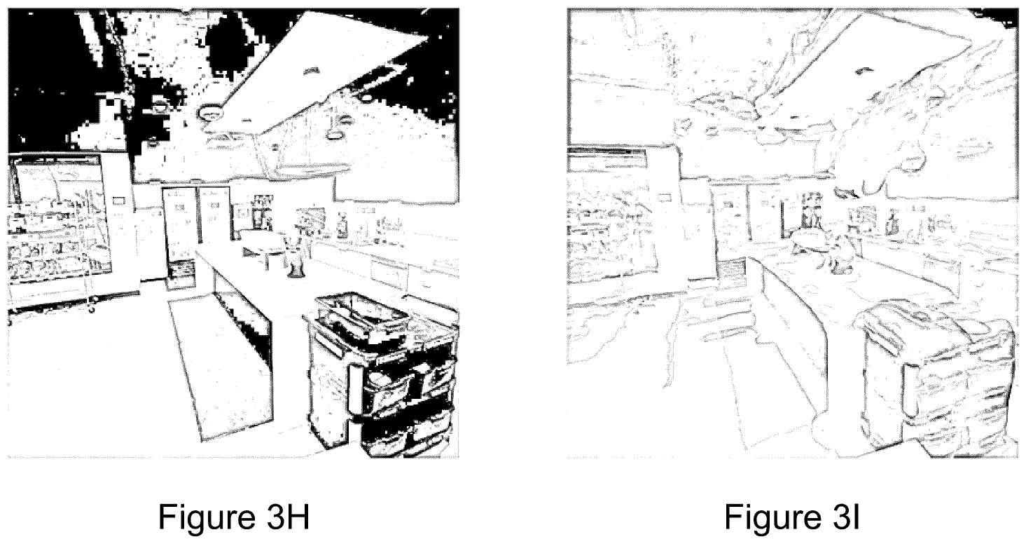

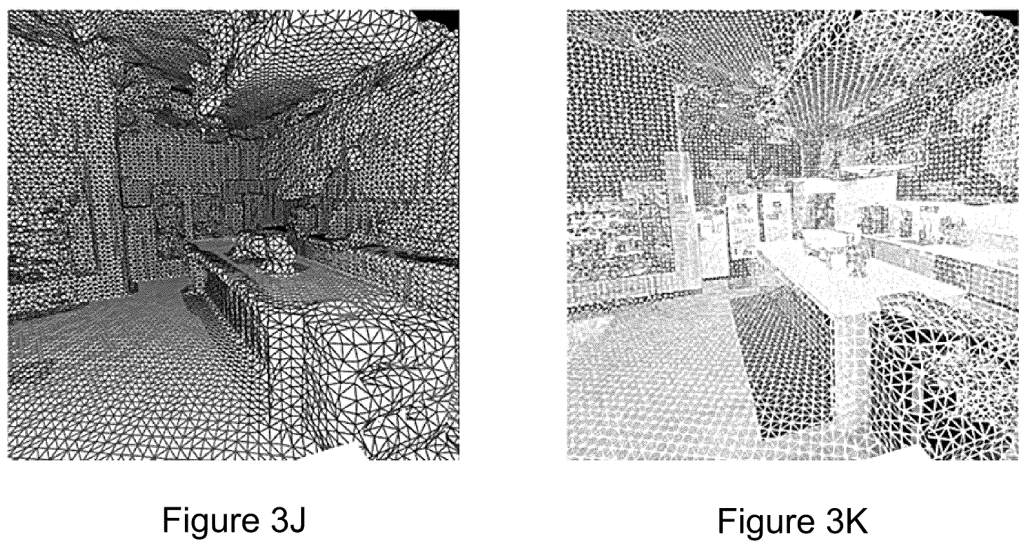

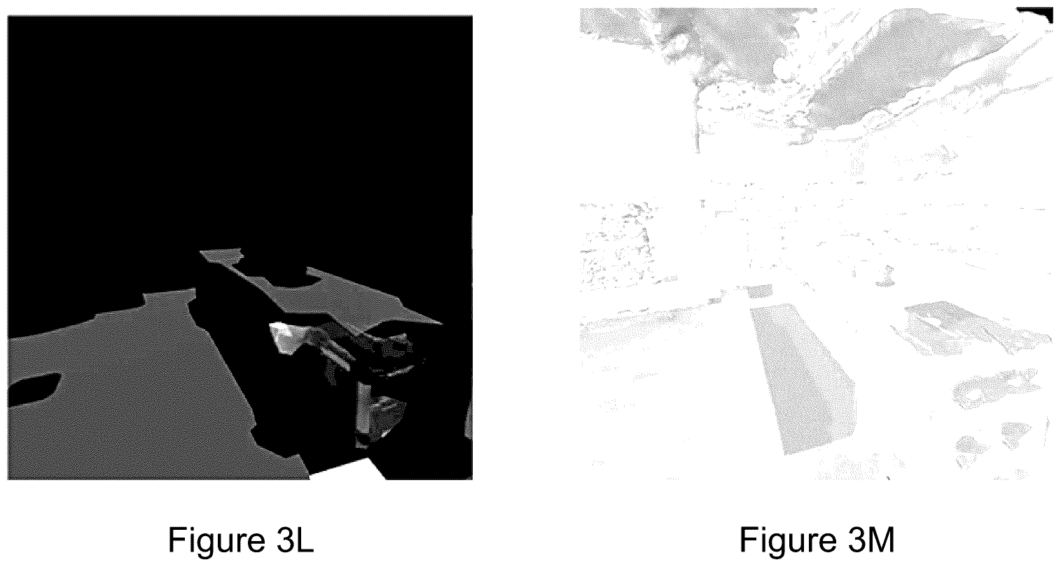

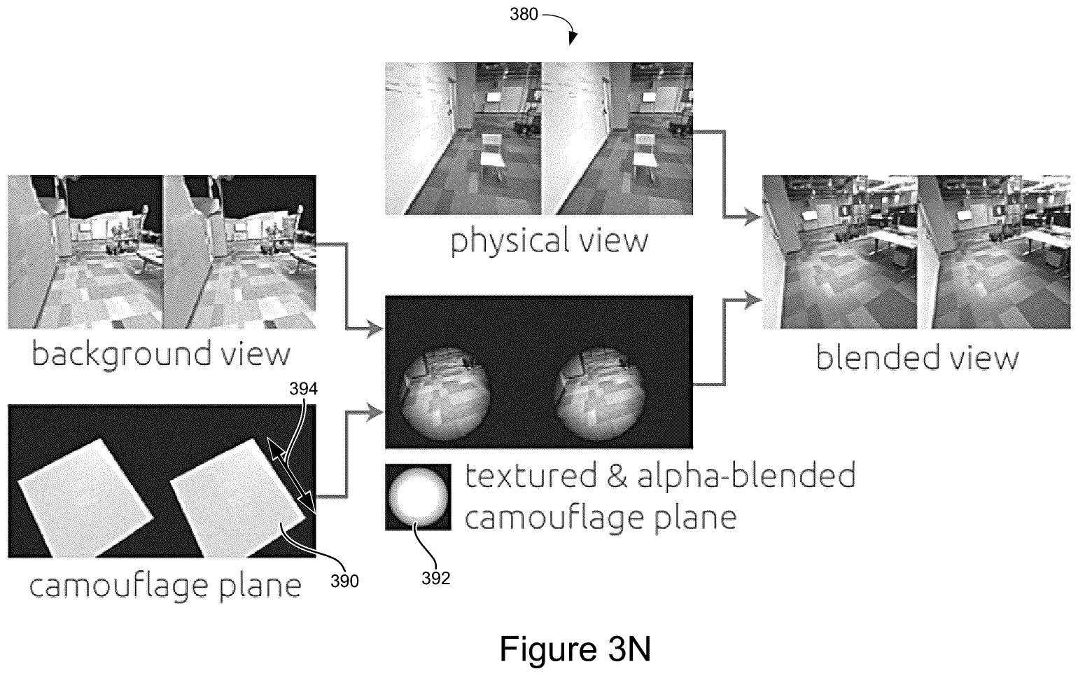

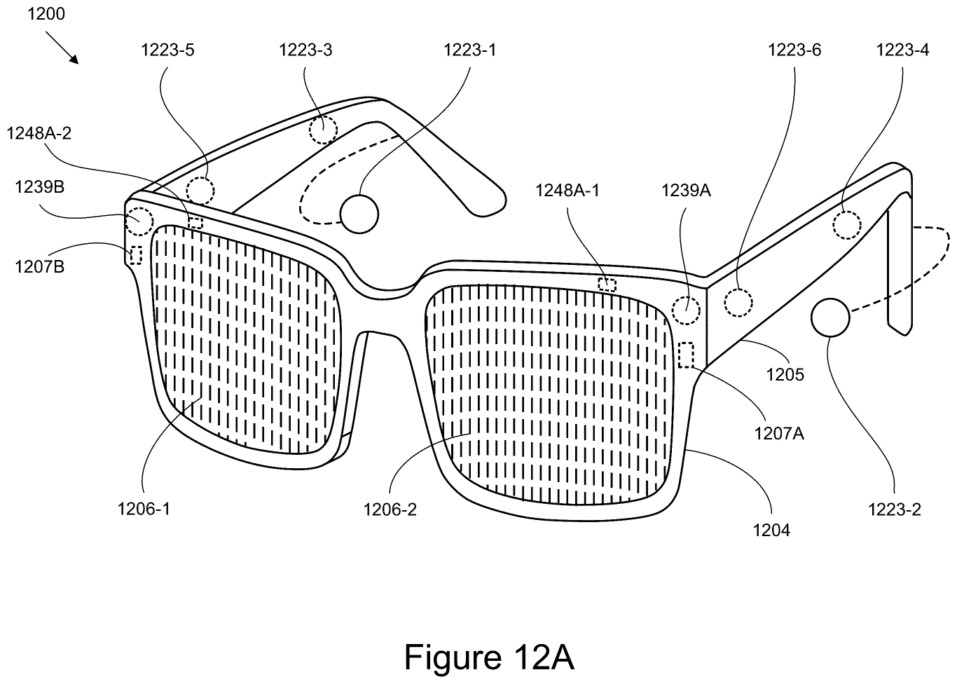

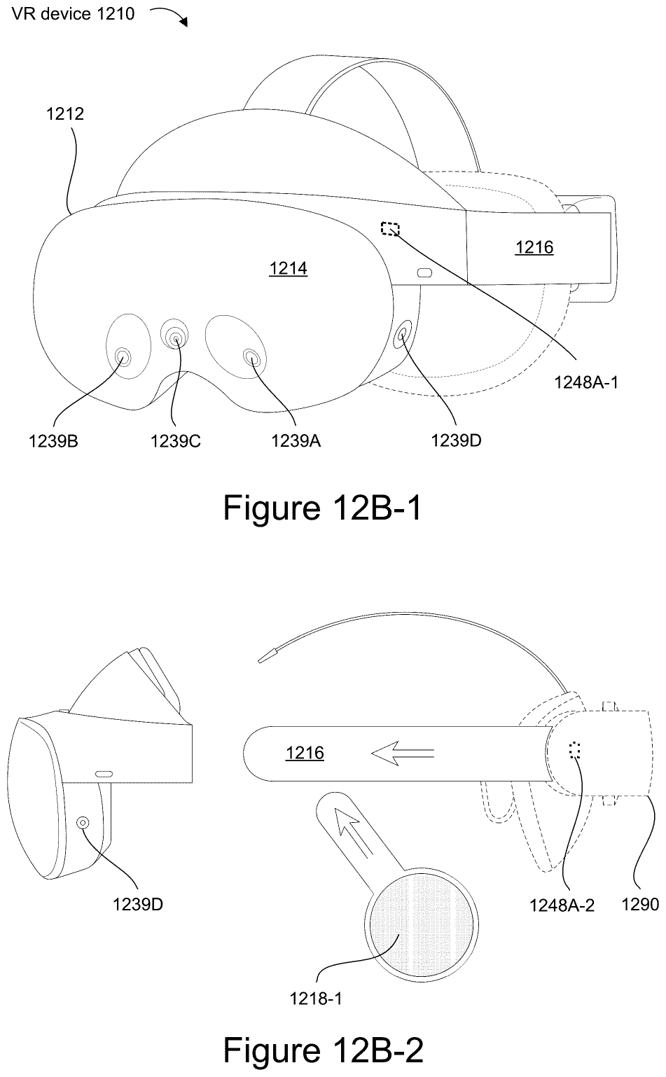

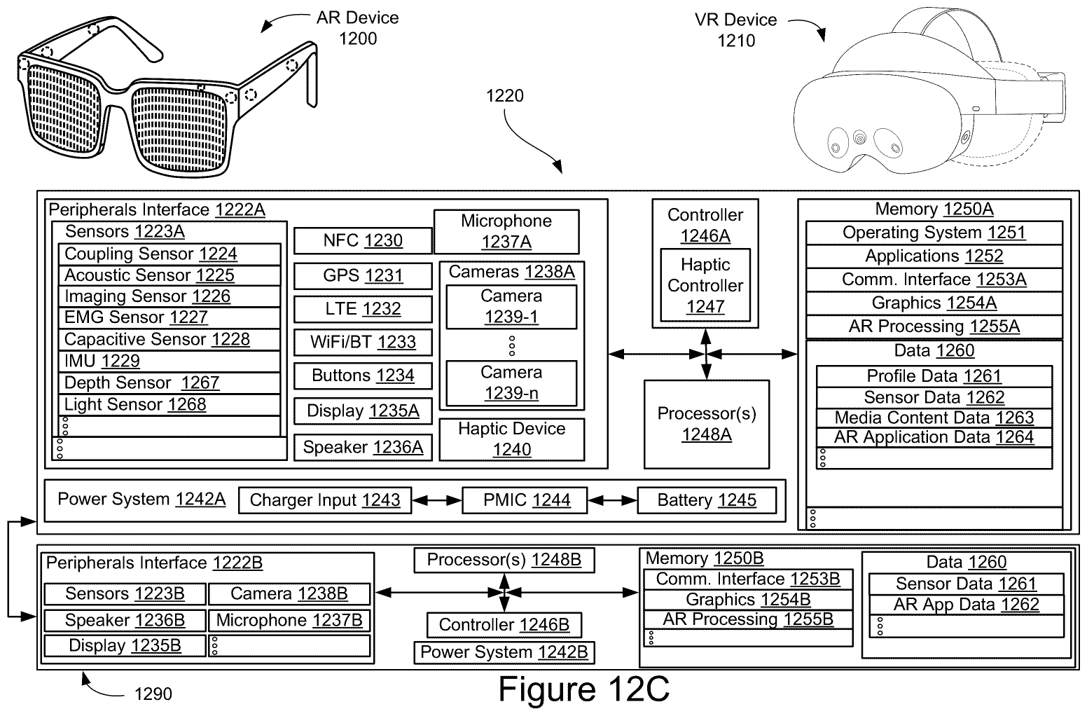

FIGS. 1A-1V illustrate interaction with a digital twin, in accordance with some embodiments. In particular, FIGS. 1A-1F show user interaction with a digital twin, FIGS. 1G-1O show user interaction with a digital twin via a digitally-generated assistant, and FIGS. 1P-1V show user and digitally-generated assistant interaction. FIGS. 1A-1O show a representation of a real-world scene presented by an AR device 1200 (e.g., head-wearable device shown and described below in reference to FIGS. 12A-12C). A representation of a real-world environment can be formed by a plurality of layers including at least a photometric layer and a geometric layer. In some embodiments, the plurality of layers further includes a semantic layer. As described in reference to FIGS. 3A-3M, the photometric layer is configured to support and/or allow for scene responsiveness, the geometric layer is configured to support and/or allow for visual coherence, and the semantic layer is configured to support and/or allow for scene awareness. The plurality of layers is visually coherent (e.g., distinctions between respective layers of the plurality of layers are substantially transparent (e.g., distinguishable) to a user 103) such that the user 103 views representations of the real-world scene as a cohesive and complete reproduction of the real-world scene. The plurality of layers allows the user 103 to interact with real-world objects and/or digital twins of the real-world objects such that modifications to the representation of the real-world scene, as discussed below.

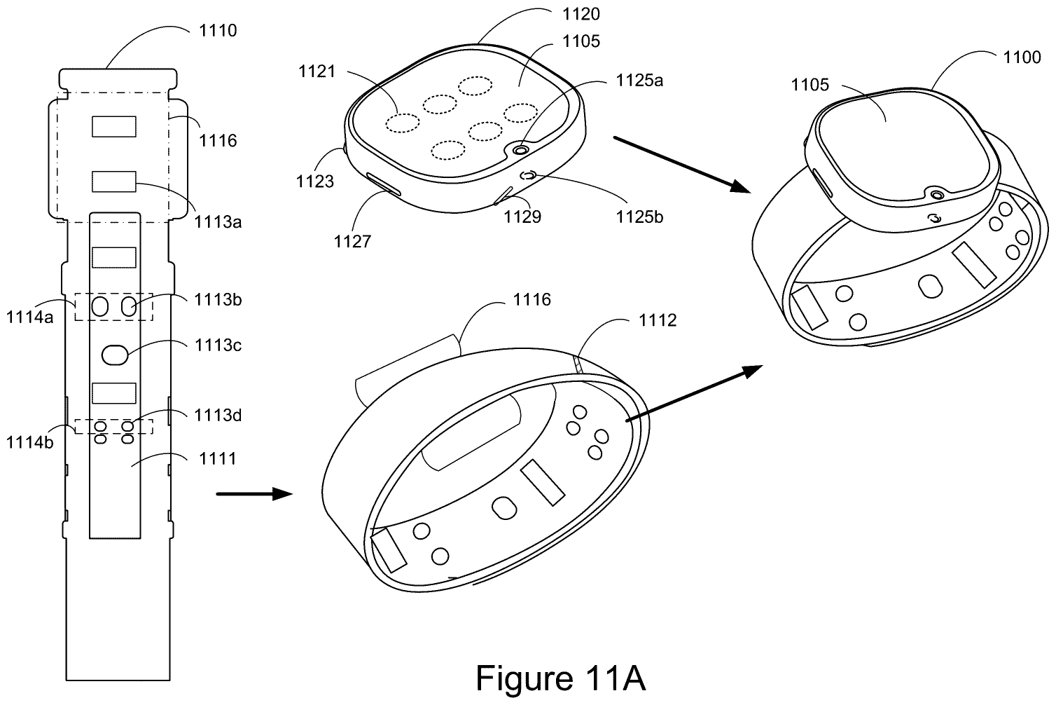

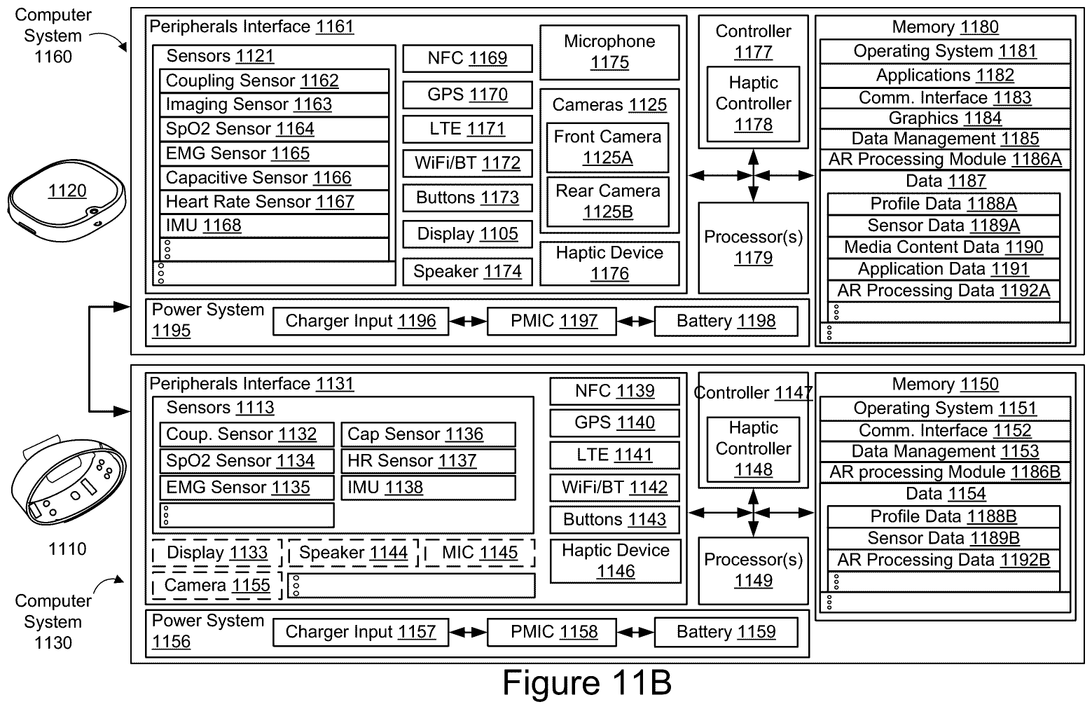

Turning to FIG. 1A, a first representation of a real-world scene 100a (e.g., a representation of the real-world scene 100a at a first point in time) is presented to the user 103 via the AR device 1200. While the first representation of the real-world scene 100a is being presented to the user 103, the AR device 1200 and/or one or more other devices communicatively coupled with the AR device 1200 (e.g., a wrist-wearable device 1100 (FIGS. 11A and 11B), a handheld intermediary processing device, etc.) identify a real-world object in the first representation of the real-world scene 100a that meets digital-interaction criteria. The digital-interaction criteria include one or more of (i) structure of the real-world object, (ii) function of the real-world object, (iii) appearance of the real-world object, (iv) pose of the real-world object, (v) physical characteristics of the real-world object, etc. For example, in FIG. 1A, the chair 102 is identified as a real-world object 102a that meets the digital-interaction criteria. In some embodiments, one or more digital-interaction criteria are based on a sufficiency image data obtained related to the real-world object 102a. In some embodiments, while the user 103 is viewing the real-world object 102a within the representation of the real-world scene, and the digital-interaction criteria are not meant, an indication is presented to the user, prompting the user to obtain more image data for the real-world object 102a.

As described below in reference to FIGS. 3A-3N, in accordance with a determination that the real-world object 102a meets the digital-interaction criteria, the AR device 1200 and/or other device communicatively coupled with the AR device 1200 generate a digital twin of the real-world object (e.g., chair digital twin 102b). A representation of a real-world scene may include multiple real-world objects that meet the digital-interaction criteria. For each real-world object that meets the digital-interaction criteria, a respective digital twin can be generated. In some embodiments, one or more digital twins are associated with the same or distinct set of user interactions described below. For example, the chair digital twin 102b may be associated with a set of user interactions that is shared by other chairs and functionally similar object (e.g., benches) within the real-world scene.

While the AR device 1200 presents the first representation of the real-world scene 100a, the user 103 can interact, via the AR device 1200 and/or other device communicatively coupled with the AR device 1200, with the real-world object or the digital twin of the real-world object. Prior to detecting a user input selecting the real-world object, the real-world object can be presented via a passthrough or substantially passthrough view (e.g., the chair 102 is shown). Alternatively, when a user input selecting the real-world object is detected, the digital twin of the real-world object is presented in place of the real-world object (e.g., the digital twin of the chair 102 is shown).

In some embodiments, before any user input is detected, the AR device 1200 presents the first representation of the real-world scene 100a as a passthrough view or substantially passthrough view (e.g., user 103's real-world environment or photometric layer is presented, either alone or in conjunction with additional artificial-reality content). In some embodiments, responsive to a detected user input, a portion of the user 103's real-world environment is presented as a passthrough view of the real-world scene associated with the user's physical environment. For example, to improve the user 103's immersion in an AR environment, a portion of the user 103's real-world environment can be presented as a passthrough view while the user 103 interacts with a digital twin in another portion of the representation of the real-world environment. Additional information on the representation of the real-world environment presented by the AR device 1200 is discussed below.

In FIG. 1B a first user interaction with the real-world object or the digital twin of the real-world object is shown. In some embodiments, the AR device 1200 present and/or the other device communicatively coupled with the AR device 1200 cause the AR device 1200 to present one or more user-interface elements (e.g., user-interface elements 104 and 105) for interacting with a real-world object or a digital twin corresponding to the real-world object within a second representation of the real-world environment 100b (e.g., a representation of the real-world scene at a second point in time, as modified by interactions with the representation of the real-world scene). For example, as shown in FIG. 1B, a user-interface element 104 can be presented over the real-world object 102a or the chair digital twin 102b. The one or more user-interface elements provide the user 103 with an indicator of one or more real-world objects and/or digital twins corresponding to the one or more real-world objects (within the second representation of the real-world environment 100b) with which the user 103 can interact.

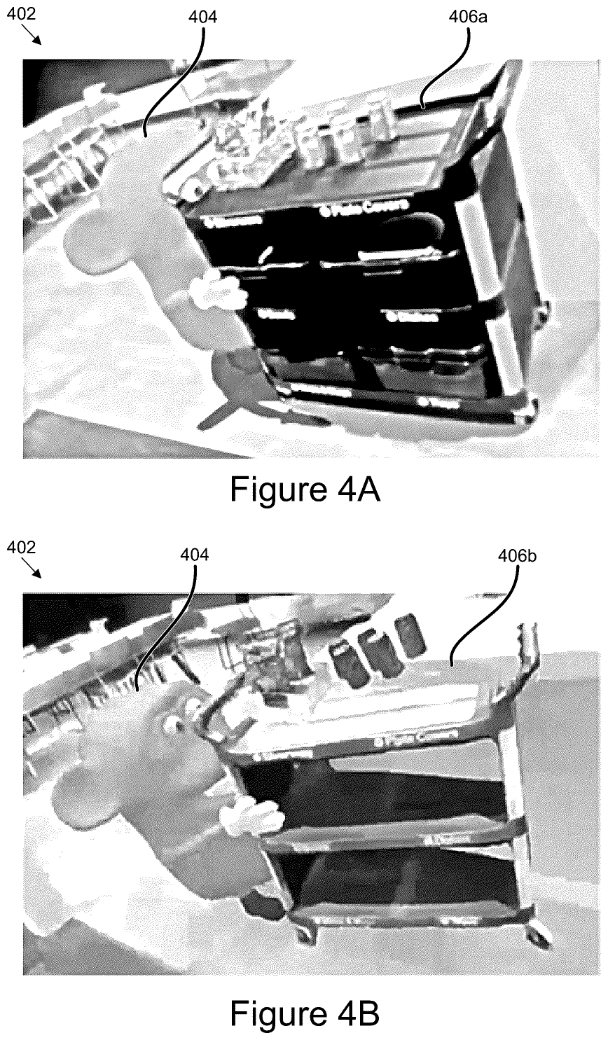

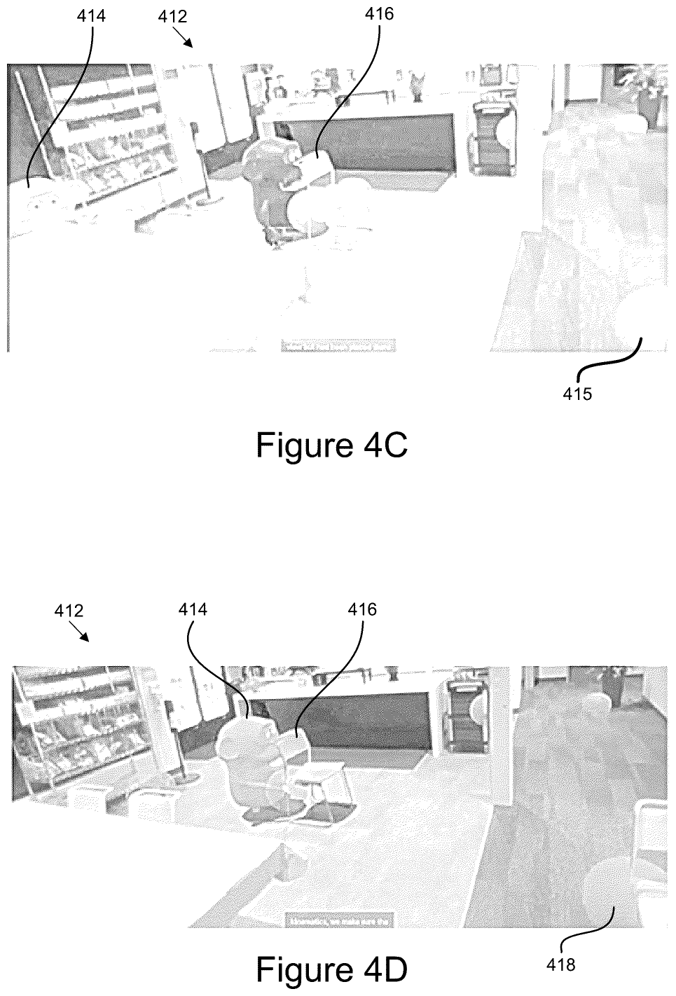

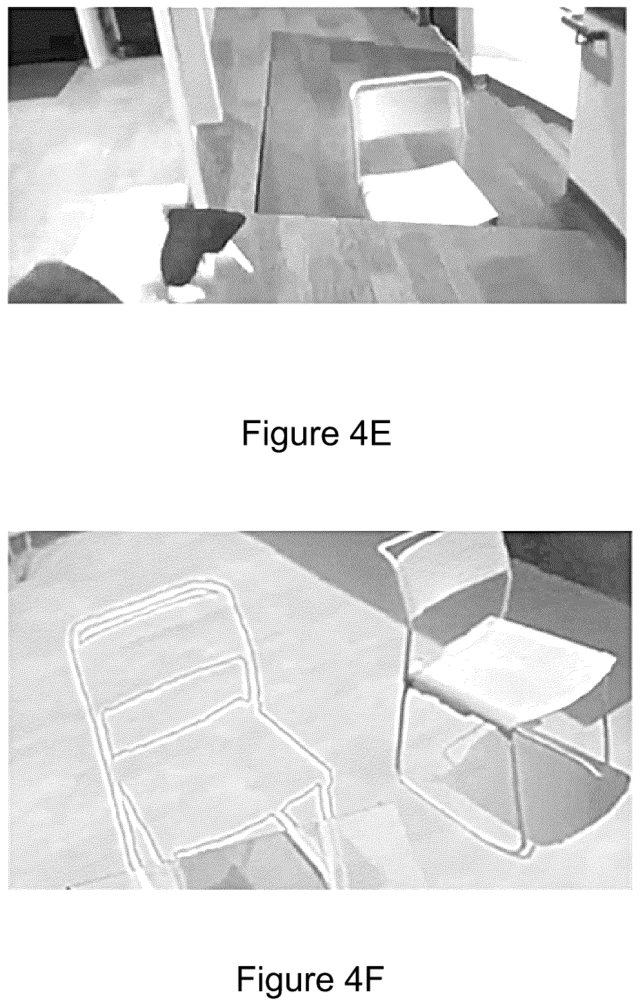

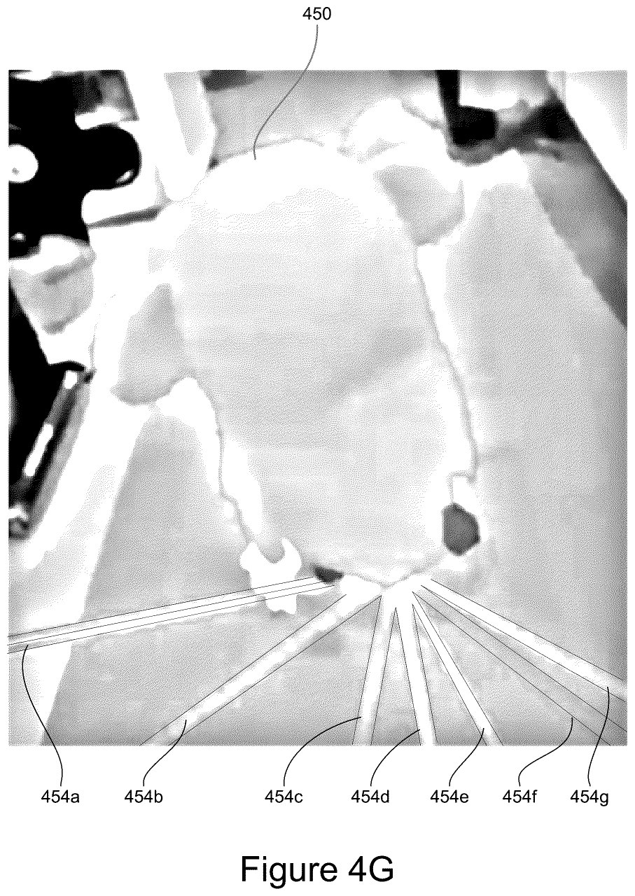

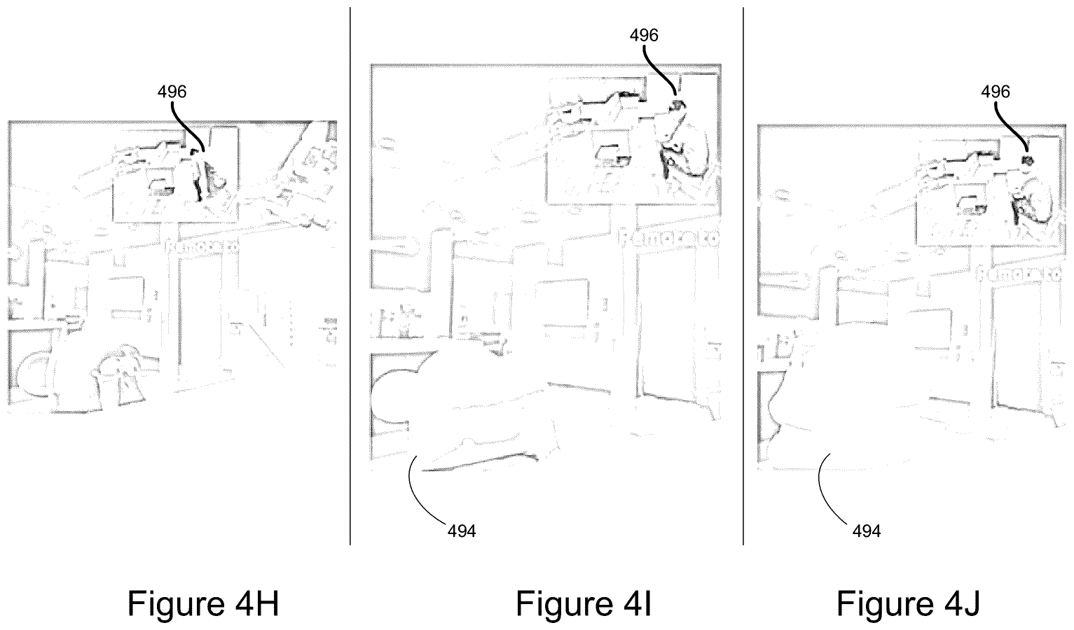

In some embodiments, the one or more user-interface elements as associated with one or more affordances. As described herein, affordances are meaningful action possibilities that a physical scene offers to a user. Actions are physical actions (e.g., moving or dragging a physical chair) or virtual actions (e.g., making the chair transparent or removing the chair from a representation of a real-world scene) that a user can perform. The affordances can be receptive affordance or responsive affordances. Receptive affordances represent the meaningful augmentation possibilities offered by the physical scene that do not require modification to the physical scene or representation thereof (e.g., moving a digital twin to an empty area of a desk, sitting in an empty chair). Responsive affordances represent the meaningful manipulation possibilities offered by the physical scene that do require modification to the physical scene or representation thereof (e.g., pulling a chair out from under a table and dragging the chair). Each affordance can be associated with one or more affordance features that describe the spatial and operational details of the afforded user-object or character-object interaction. Additional information on the affordances and the affordance features is provided below in reference to FIGS. 3G-4J.

In some embodiments, a focus selector is presented to assist the user 103 in determining which user interface element is selected. A focus selector can be a change in the presentation the user interface element, such as a color change, a highlight, a size change, etc. For example, in FIG. 1B, the user-interface element 104 (which is presented over the chair 102) includes three rings to notify the user 103 that it is currently in focus (or selected) and another user-interface element 105 (which is presented over a portion of the door frame) is presented with two rings to notify the user 103 that it is not currently in focus (or selected).

The user interactions can be detected by the AR device 1200 and/or the other device communicatively coupled with the AR device 1200. The user interactions can includes one or more of adjusting a pose (e.g., position and/or orientation); adjusting a structure (e.g., opening a book); adjusting functionality (e.g., the chair when lifted can no longer be used as a chair while lifted); and/or adjusting visual coherence (e.g., occlusion) of the one or more real-world objects and/or the digital twins corresponding to the one or more real-world objects. Additionally, the user interactions can adjust visual coherence of the representation of the real-world scene presented by the artificial-reality system. Non-limiting examples of the different user interactions are provided below.

FIG. 1C shows a second user interaction with the chair digital twin 102b. In particular, the user 103 selects the chair 102 within a third representation of the real-world scene 100c (e.g., a representation of the real-world scene at a third point in time) and the AR device 1200 (and/or other device communicatively coupled with the AR device 1200) makes one or more adjustments to the pose and visual coherence of the chair 102 and one or more adjustments to the visual coherence of the third representation of the real-world scene 100c based on the user input. As noted above, prior to a user input selecting the chair 102, the real-world object 102a and the chair digital twin 102b are presented as a single object to the user 103 (with the real-world object 102a being prioritized as part of a passthrough view); however, when a user input selecting the chair 102 is detected, the AR device 1200 (and/or other device communicatively coupled with the AR device 1200) replaces the real-world object 102a with the chair digital twin 102b. The transition between the real-world object 102a and the chair digital twin 102b is transparent or substantially transparent to the user 103.

As further shown in FIG. 1C, the user 103 can rotate the chair digital twin 102b, change a position of the chair digital twin 102b, and/or hover the chair digital twin 102b (e.g., causing the chair digital twin 102b to float or fly) via their interaction with the chair digital twin 102b. While the user 103 adjusts a pose of the chair digital twin 102b, the AR device 1200 (and/or other device communicatively coupled with the AR device 1200) can maintain the chair digital twin 102b's visual coherence within the third representation of the real-world scene 100c. For example, the chair digital twin 102b will continue to contact (e.g., impact, push, etc.) other real-world objects and/or other digital twins of real-world objects within the third representation of the real-world scene 100c. In some embodiments, while the user 103 interacts with the chair digital twin 102b, the chair digital twin 102b can be shown transparent or semi-transparent (e.g., with an outline or border) to assist the user 103 in visualizing changes to the third representation of the real-world scene 100c.

Additionally, while the user 103 interacts with the chair digital twin 102b, the AR device 1200 (and/or other device communicatively coupled with the AR device 1200) adjusts the visual coherence of the third representation of the real-world scene 100c based on the user input. For example, when the user 103 moves the chair digital twin 102b, the original position (represented by box 107) of the real-world object 102a is camouflaged (e.g., masked with an accurate representation of the real-world environment without the chair 102) such that the user 103's immersion is maintained. More specifically, the AR device 1200 (and/or other device communicatively coupled with the AR device 1200) adjust the visual coherence of the third representation of the real-world scene 100c such that interactions with one or more real-word objects and/or one or more digital twins corresponding to real-word objects do not generate artifacts (e.g., blank or missing portions) that are inconsistent with the third representation of the real-world scene 100c. Additional information of the generation of a camouflage portion of a representation of the real-world scene is provided below in reference to FIG. 3N.

In FIG. 1D, the user 103 ceases to interact with the chair digital twin 102b and places the chair digital twin 102b upright in front of a shelf. The AR device 1200 and/or another device communicatively coupled with the AR device 1200 adjusts a fourth representation of the real-world scene 100d (e.g., a representation of the real-world environment at a fourth point in time) to maintain visual coherence. In particular, the AR device 1200 presents (and/or the other device communicatively coupled with the AR device 1200 causes the AR device 1200 to present) the chair digital twin 102b as a stationary object that occludes a portion of the shelf within the fourth representation of the real-world scene 100d. Similarly, the AR device 1200 will continue to camouflage the original position (e.g., box 107).

Turning to FIG. 1E, the user 103 performs an additional user interaction with the chair digital twin 102b to adjust the visual coherence of the chair digital twin 102b. In particular, the user 103 performs a user interaction to change the appearance of the chair digital twin 102b from a solid object to a transparent object (represented by transparent chair digital twin 102c, which is a variation of the chair digital twin 102b). As described above, the AR device 1200 and/or the other device communicatively coupled with the AR device 1200 maintains a visual coherence of a fifth representation of the real-world scene 100e (e.g., the real-world scene at a fifth point in time). For example, as shown in FIG. 1E, the transparent chair digital twin 102c is shown with a dotted outline and the shelf behind the transparent chair digital twin 102c is visible.

In FIG. 1F, the user 103 performs another user interaction with the transparent chair digital twin 102c to remove the object. When the user 103 remove the transparent chair digital twin 102c via the other user interaction, the AR device 1200 and/or the other device communicatively coupled with the AR device 1200 maintains visual coherence of a sixth representation of the real-world scene 100f (e.g., the real-world scene at a sixth point in time) as described above in reference to Figures IC-1E. Although the above example describes the user interaction for removing the transparent chair digital twin 102c, the user 103 can also perform a user interaction to remove the real-world object 102a and/or the chair digital twin 102b presented by the AR device 1200.

FIG. 1G shows the user 103 performing a user interaction to summon or call a digitally-generated assistant 110. In some embodiments, the AR device 1200 (and/or the other device communicatively coupled with the AR device 1200) can generate the digitally-generated assistant 110 to interact, on the user 103's behalf, with one or more real-world objects and/or digital twins of the one or more real-world objects within a seventh representation of the real-world scene 100g (e.g., the real-world scene at a seventh point in time). The digitally-generated assistant 110 can be generated in response to user input (e.g., based on a user input to summon the digitally-generated assistant 110 and/or a request to interact with a real-world object (e.g., an electronic device, such as a radio) or a digital twin of the real-world object).

The digitally-generated assistant 110, like the one or more real-world objects and/or digital twins of the one or more real-world objects, include scene responsiveness, scene awareness, and/or visual coherence with the representation of the real-world environment. The digitally-generated assistant 110 can be configured to interact with the one or more real-world objects and/or the digital twins of the one or more real-world objects in accordance with the user interactions described above in reference to FIGS. 1A-IF. Additionally, or alternatively, in some embodiments, the digitally-generated assistant 110 is configured to interact with the user 103 (e.g., play games with the user 103, hand one or more real-world objects and/or one or more digital twins to the user 103, etc.). For example, in FIG. 1G, the user 103 provides a user input (as shown by user interface element 111 and assistant pathing 106) instructing the digitally-generated assistant 110 to stand next to the user 103. Responsive to the user's input instructing the digitally-generated assistant 110 to stand next to the user 103, the AR device 1200 and/or the other device communicatively coupled with the AR device 1200 causes the digitally-generated assistant to perform the user 103's instructions.

As shown in FIG. 1H, in some embodiments, the AR device 1200 presents (and/or the other device communicatively coupled with the AR device 1200 causes the AR device 1200 to present) a visual preview of the digitally-generated assistant 110's pathing (e.g., the assistant pathing 109). The AR device 1200 (and/or the other device communicatively coupled with the AR device 1200) can determine the assistant pathing 109 based on the user inputs and to account for one or more aspects of the real-world scene 100h. For example, as shown in FIG. 1H, an eighth representation of the real-world scene 100h (e.g., the real-world scene at an eighth point in time) includes a visual preview that shows the digitally-generated assistant 110 moving (along another assistant pathing 109) from a starting position (e.g., next to the user 103) to an intermediary position 112a, from the intermediary position 112a to a remote position 112b (e.g., a position that is further away from the user than the intermediary position 112a), and from the remote position 112b to a door frame selected via user-interface element 113 (as shown in a ninth representation of the real-world scene 100i; FIG. 1I).

In some embodiments, the visual preview of the digitally-generated assistant 110 includes and/or is based on semantic information associated with another real-world object in the real-world scene. For example, the visual preview can include an indication that the digitally-generated assistant 110 will move around a chair or a table if the chair or the table is between the digitally-generated assistant 110's start and end points. Alternatively, or additionally, in some embodiments, the visual preview can include an indication that the digitally-generated assistant 110 will interact with another real-world object in the real-world environment. For example, the visual preview can include an indication that the digitally-generated assistant 110 will move a chair if the chair is between the digitally-generated assistant 110's start and end points.

In FIG. 1I, responsive to a user input confirming or approving of the visual preview, the AR device 1200 and/or the other device communicatively coupled with the AR device 1200 causes the digitally-generated assistant 110 to perform the assistant pathing shown in the visual preview. For example, in the ninth representation of the real-world scene 100i (e.g., the real-world scene at a ninth point in time), the digitally-generated assistant 110 is shown completing the other assistant pathing 109 (e.g., moving from pathing position 112c to the door frame) and looking back at the user 103 from the door frame. In some embodiments, the door frame is identified as another real-world object within the real-world environment that meets the digital-interaction criteria and the digitally-generated assistant 110 performs an interaction associated with a digital twin of the door frame (e.g., hugging or pecking into the room from the door frame digital twin). Alternatively, in some embodiments, the door frame does not meet the digital-interaction criteria; however, semantic information associated with the representation of the real-world scene can be used to provide the digitally-generated assistant 110 with scene awareness (e.g., understanding of the real-world scene). For example, the digitally-generated assistant 110 can use the semantic information to interpret the door frame as an entry point to the room and use the door frame to peck into the room.

FIG. 1I further shows the user 103 moving a focus selector (e.g., as shown by user-interface element 115) on chair 102. As described below, the user 103 can cause the digitally-generated assistant 110 to interact with one or more real-world objects and/or digital twins corresponding to the one or more real-world objects within a representation of a real-world scene.

In FIG. 1J, responsive to the user input selecting the chair 102, the AR device 1200 (and/or other device communicatively coupled with the AR device 1200) cause the digitally-generated assistant 110 to interact with the chair digital twin 102b. The user 103 can, via the AR device 1200 (and/or other device communicatively coupled with the AR device 1200), use the digitally-generated assistant 110 as user interaction and cause the digitally-generated assistant 110 to perform any user interaction described above in reference to FIGS. 1A-IF. The AR device 1200 (and/or other device communicatively coupled with the AR device 1200) cause the digitally-generated assistant 110, a real-world object, a digital twin, and/or a representation of a real-world scene during an interaction to maintain their visual coherence, scene responsiveness, and/or scene awareness. For example, in a tenth representation of the real-world scene 100j (e.g., the real-world scene at a tenth point in time), the digitally-generated assistant 110 is shown interacting with the chair digital twin 102b without distorting the structure of the chair digital twin 102b (e.g., grabbing the chair digital twin 102b via the edges showing scene awareness). Further, the visual coherence is maintained by showing the chair digital twin 102b occluding a portion of the digitally-generated assistant 110. As noted above, prior to a user input selecting the chair 102, the real-world object 102a and the chair digital twin 102b are presented as a single object to the user 103; however, when a user input selecting the chair 102 is detected, the AR device 1200 (and/or other device communicatively coupled with the AR device 1200) replaces the real-world object 102a with the chair digital twin 102b.

In some embodiments, the digitally-generated assistant 110's pathing history is presented to the user 103. For example, as further shown in the tenth representation of the real-world scene 100j, the previous assistant pathing 114 is presented to the user 103. This allows the user 103 to view previous actions performed by the digitally-generated assistant 110 and to be aware of changes to a representation of a real-world scene. In some embodiments, the previous assistant pathing 114 is presented with the digitally-generated assistant 110's current assistant pathing 116.

FIG. 1K shows the digitally-generated assistant 110 making one or more adjustments to the pose and visual coherence of the chair 102 and one or more adjustments to the visual coherence of an eleventh representation of the real-world scene 100k (e.g., the real-world scene at an eleventh point in time) based on the user input. In particular, the AR device 1200 (and/or other device communicatively coupled with the AR device 1200) causes the digitally-generated assistant 110 to pick up and move the chair digital twin 102b toward the user 103 and, at the same time, camouflages the original position of the chair 102 within the tenth representation of the real-world scene 100j (e.g., to maintain visual consistency for the user 103 in the eleventh representation of the real-world scene 100k).

Turning to FIG. 1L, another representation of a real-world scene is presented to the user 103 via the AR device 1200. The other representation of the real-world scene 150 is a continuation of the first through eleventh representations of the real-world scene. In particular, the digitally-generated assistant 110 has moved the chair digital twin 102b into a distinct portion of the room or a distinct room connected to the room shown in FIGS. 1A-IK. In some embodiments, distinct image data can be used to cause presentation of the real-world scene 150 than was used to cause presentation of the real-world scene 100. In some embodiments, an interaction user-interface element 153 (e.g., shade in circles) is presented to the user 103 to notify the user 103 of a real-world object or digital twin with which they are currently interacting. While the interaction user-interface element 153 is presented, the user 103 can move a focus selector to a distinct portion of a representation of a real-world scene (e.g., the real-world scene 150). For example, in the other representation of the real-world scene 150, the user 103 moves a focus selector (e.g., shown by user-interface element 155) to a portion of the other representation of the real-world scene 150.

In some embodiments, the AR device 1200 (and/or other device communicatively coupled with the AR device 1200) presents a visual preview of an action to be performed by the digitally-generated assistant 110. For example, as shown in the other representation of the real-world scene 150, the user 103 moving the focus selector to user-interface element 155 (a corner portion of the room) causes the AR device 1200 (and/or other device communicatively coupled with the AR device 1200) to present a visual preview of the digitally-generated assistant 110 and the chair digital twin's position (e.g., assistant preview 172 and chair digital twin preview 162). This allows the user 103 to visualize a user interaction before it is performed.

In some embodiments, a representation of a real-world scene includes one or more of user-interface elements (e.g., user-interface elements 155, 157, and 159) identifying one or more predetermined portions of the representation of a real-world scene with which the user 103 can interact. In some embodiments, the user-interface elements are predetermined locations that can be used to complete or perform a user interaction (e.g., performed directly by the user 103 or via the digitally-generated assistant 110). In some embodiments, the user-interface elements are associated with semantic information that is used by the AR device 1200 (and/or other device communicatively coupled with the AR device 1200) to allow for scene awareness. For example, as shown in the other representation of the real-world scene 150, the user-interface element 155 identifies a location to which the chair digital twin 102b can be moved and, because of the semantic information associated with the user-interface element 155, the digitally-generated assistant 110 orients the chair digital twin 102b such that it corresponds to a real-world object in the real-world environment (e.g., chair seat facing the hallway). In this way, if the user 103 decides to place the chair digital twin 102b at the location indicated by the user-interface element 155, the user 103 can physically use the chair digital twin 102b as an actual chair (as shown and described below in reference to Figures IP-1Q).

Additionally, or alternatively, in some embodiments, the user-interface elements identify one or more real-world objects that have been camouflaged or otherwise concealed to maintain visual coherence. In some embodiments, a camouflaged or otherwise concealed real-world object is identified by a user-interface element when the user is within a predetermined distance (e.g., 1 to 2 meters) of the camouflaged or otherwise concealed real-world object. In this way, the user can avoid accidentally hurting themselves on a concealed real-world object.

FIG. 1M shows the digitally-generated assistant 110 moving the chair digital twin 102b to the location of the user-interface element 155 and FIG. 1N shows the digitally-generated assistant 110 placing the chair digital twin 102b at the location of the user-interface element 155. As described above, because semantic information associated with the user-interface element 155 is used for placing and orienting the chair digital twin 102b, the chair digital twin 102b functions as a usable chair for the user 103 in the real-word.

FIG. 1O shows the user 103 dismissing the digitally-generated assistant 110 (e.g., by performing a user input, such as a gesture directed to a physical input of the controller, and/or an in-air hand gesture). In some embodiments, the digitally-generated assistant 110 is automatically dismissed after completion of the user interaction. Alternatively, in some embodiments, the digitally-generated assistant 110 is dismissed responsive to a user input.

FIG. 1P shows the user 103 approaching and sitting at the chair digital twin 102b. When the user 103 sits in the chair digital twin 102b, yet another representation of the real-world scene 180 (FIG. 1Q) is presented to the user 103 via the AR device 1200. Each of the transitions between the different representation of the real-world scene are seamless and imperceptible to the user 103. More specifically, the AR device 1200 presents to the user 103 a continuous and immersive AR environment that reflects a user 103's real-world scene and that allows the user 103 to interact with representations of rea-world objects within the AR environment while maintaining scene awareness, scene responsiveness, and visual coherence.

Turning to FIG. 1Q, the yet other representation of the real-world scene 180 is presented at a first point in time. As described above, the AR device 1200 (and/or other device communicatively coupled with the AR device 1200) identifies one or more real-world objects that meet the digital-interaction criteria and generates respective digital twins for the one or more real-world objects that meet the digital-interaction criteria. The user 103 can perform, via the AR device 1200 (and/or other device communicatively coupled with the AR device 1200), a user interaction with each of the one or more real-world objects that meet the digital-interaction criteria. In some embodiments, the AR device 1200 presents one or more user-interface elements for each of the identified one or more real-world objects (e.g., user-interface elements 182, 184, 186, and 188). In this way, the user 103 can move a focus selector to highlight and provide a user input at a particular user-interface element.

In FIG. 1R, the user 103 provides a user input, the user input directed to selecting the user-interface element 184 (e.g., highlight over a book). Selection of a real-world object and/or a digital twin of the real-world object within a representation of a real-world scene is discussed above in reference to FIGS. 1A-1P. In some embodiments, a pointing element 189 is presented to assist the user 103 in selecting a user-interface element. Responsive to the user input, an indication (e.g., a confirmation animation 191) can be presented to the user 103 via the AR device 1200. For example, as shown in FIG. 1S, user selection of the user-interface element 184 causes the AR device 1200 to present a flash or spark animation (e.g., the confirmation animation 191).

In FIG. 1T, after user selection of the user-interface element 184, the AR device 1200 (and/or other device communicatively coupled with the AR device 1200) retrieves and presents a digital twin of the real-world object selected by the user 103. For example, a digital twin corresponding to a book “Oz” is put in focus and enlarged for the user 103 to view. As shown in FIG. 1U, the user 103 can interact with the digital twin corresponding to a book “Oz.” In some embodiments, the real-world object corresponds to a publicly accessible source, the AR device 1200 (and/or other device communicatively coupled with the AR device 1200) can obtain a copy of the publicly accessible source a reproduce a copy for the user 103. For example, the user 103 can open the digital twin 193 and flip through the different pages, each of the different pages being populated with the information received from the publicly accessible source. In some embodiments, in accordance with the user 103 causing the book digital twin 193 of the book to be removed from the bookshelf, additional image data can be obtained remotely, based on a portion of the book that is visible from within the real-world scene. For example, an artificial-intelligence model can be used to identify cover art of the book based on a visible portion of the binding from the image data of the real-world scene captured by the artificial-reality headset.

In FIG. 1V, the user 103 performs a user interaction to put the book digital twin 193 on a distinct portion of the yet other representation of the real-world. For example, instead of putting the book digital twin 193 back on the bookshelf, the user 103 places the book on a bench. The AR device 1200 (and/or other device communicatively coupled with the AR device 1200) maintains visual coherence and camouflages the previous location of the book digital twin 193. In some embodiments, the user 103 can perform a user action to view passthrough view of the real-world environment, such that the user can easily view their real-world environment. When the passthrough view is active, the digital twins and their current state are stored and removed from visibility. If the user 103 decides to continue their previous AR scenario, the user 103 can initiate the previously stored state of the digital twins.

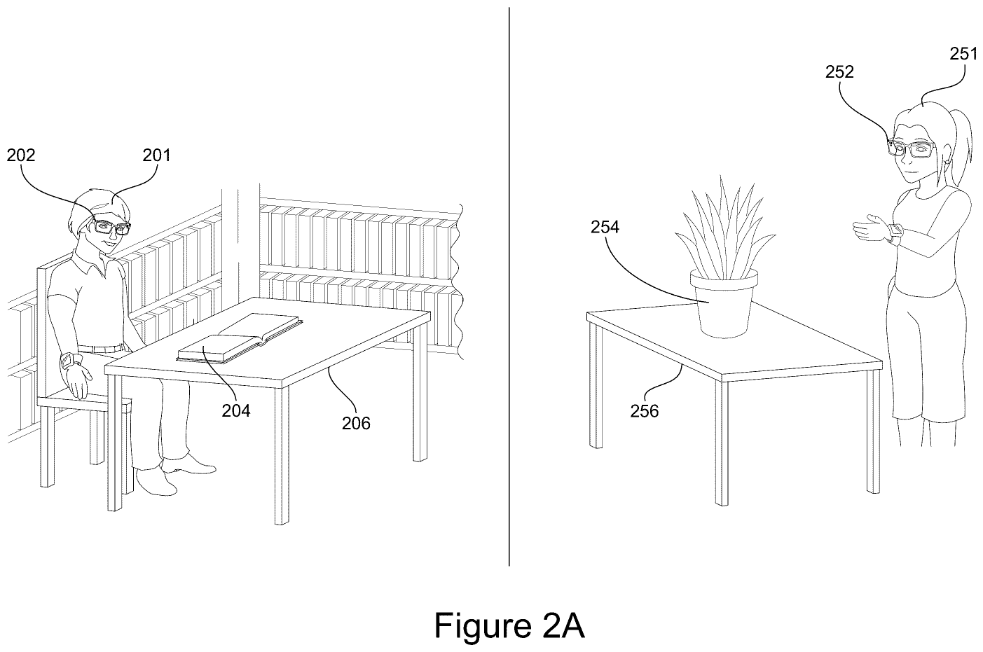

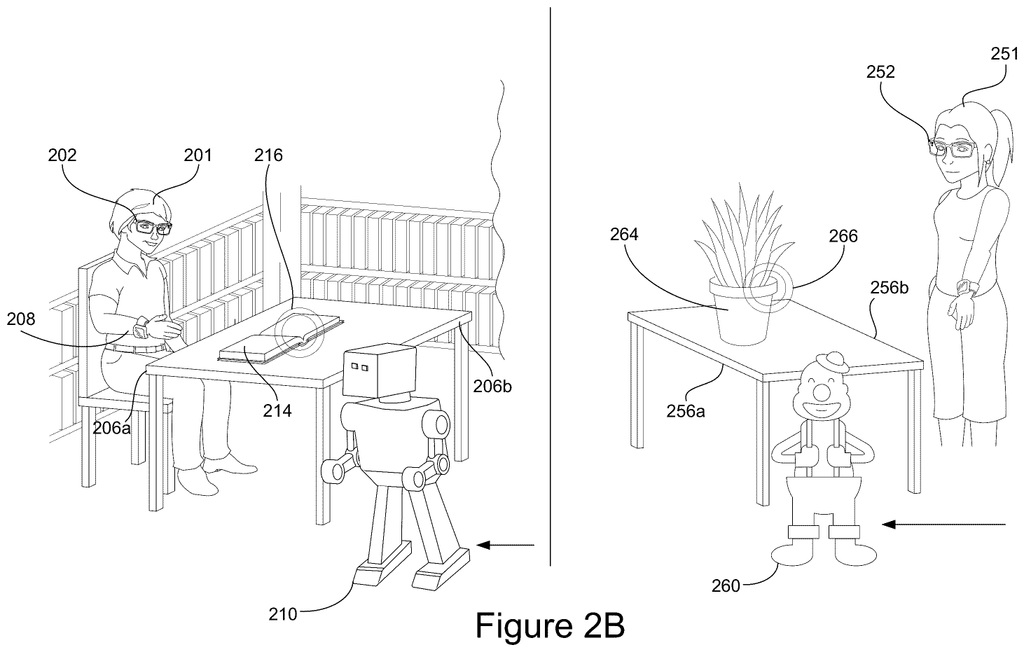

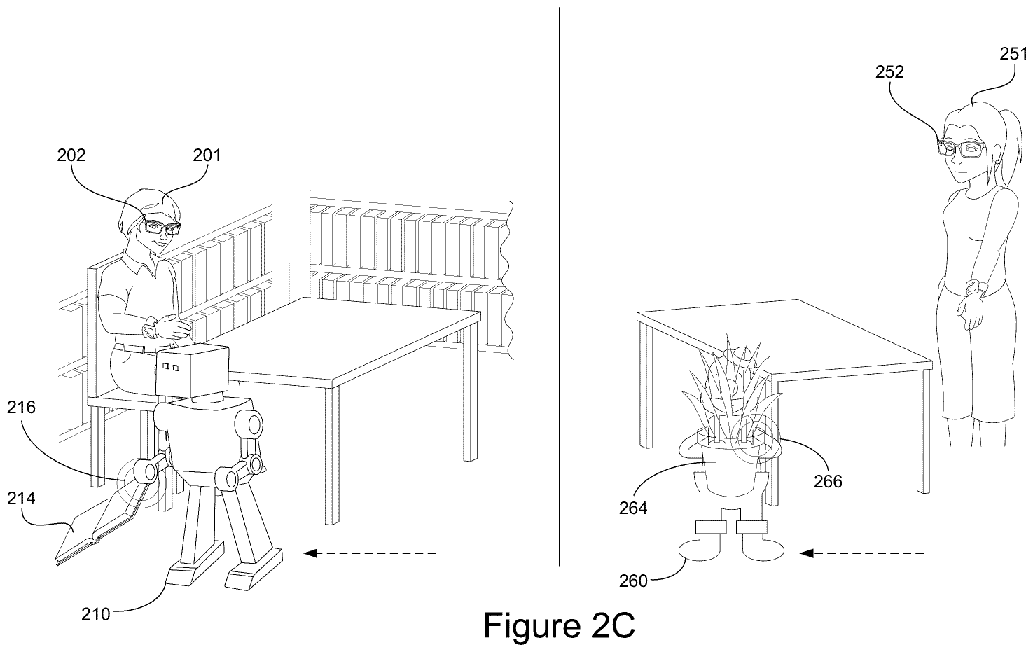

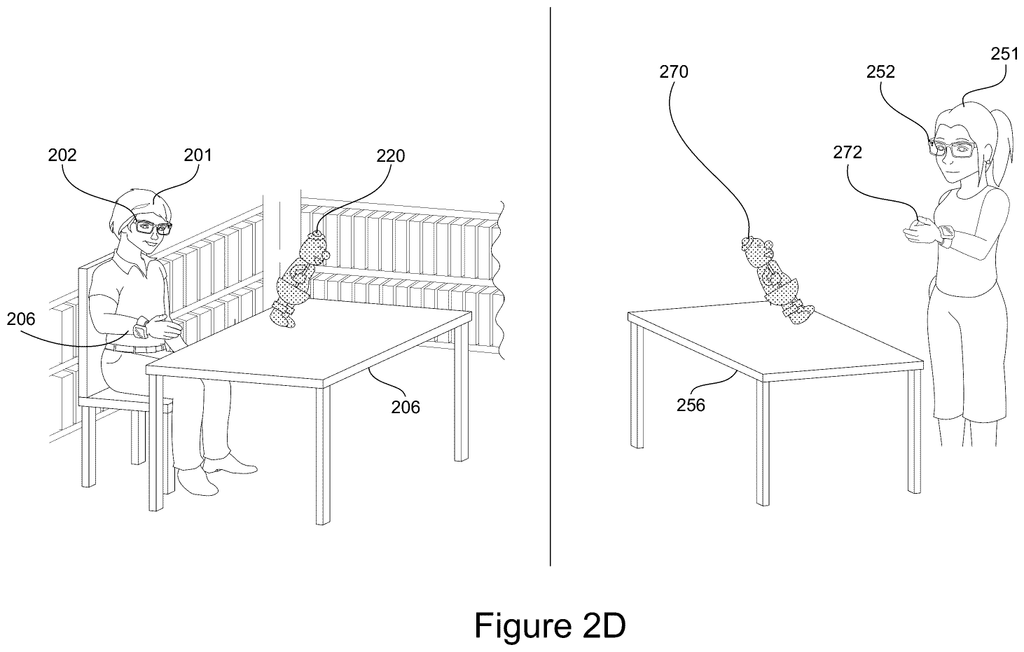

FIGS. 2A-2D illustrate shared mixed-reality experiences using semantic processing of a first user's activities to then render a representation of that first user's activity as a mixed-reality experience for a second user in a different physical location, in accordance with some embodiments. FIGS. 2A-2D show users (e.g., a first user 201 and a second user 251) wearing artificial-reality headsets (e.g., a first artificial-reality headsets 202 and a second artificial-reality headsets 252), which can include some or all of the components of the AR devices 1200 and the VR devices 1210 described below in reference to FIGS. 12A-12C. The first and second users 201 and 251 are in separate physical locations and participating in a shared interaction that is provided at each of the first and second artificial-reality headsets 202 and 252. Each of the first and second artificial-reality headsets 202 and 252 presents a respective artificial-reality environment that includes a respective representation of each user's real-world scene. In some embodiments, each of the respective representations is formed by a plurality of layers as described in reference to FIGS. 3A-3M. The plurality of layers includes one or more layers that are used to convey information identified via image data, which can be obtained by the first and second artificial-reality headsets 202 and 252, and/or additional imaging sensors that are in electronic communication with the first and second artificial-reality headsets 202 and 252.

FIG. 2A shows the first user 201 in a first physical location that includes a first real-world scene. The first user 201 is sitting near a desk 206, and a real-world object 204 (e.g., a book) is resting on a flat surface of the desk 206. As described herein, the AR device 1200 and/or another device communicatively coupled with the AR device 1200 can identify one or more interactable real-world object via the plurality of layers generated based captured on image data (e.g., identifying a real-world object that meets digital-interaction criteria). For example, the first artificial-reality headsets 202 can identify the flat surface of the desk 206 as a surface for presenting artificial-reality content associated with the shared interaction between the first user 201 and the second user 251 (e.g., via a semantic layer of one or more layers used to present a representation of the real-world scene to the first user 201). FIG. 2A also shows the second user 251 in a second physical location, distinct from the first physical location, that includes a second real-world scene. The second user 251 is standing near a different desk 256 that has a different real-world object 454 on it (e.g., a plant in a vase). The second artificial-reality headset 252, like the first artificial-reality headset 202, can identify the different desk 256 also includes a flat surface that can be used for presenting artificial-reality content associated with the shared interaction between the first user 201 and the second user 251.

While the first and second users 201 and 251 participate in a shared artificial-reality activity, the first and/or second artificial-reality headsets 202 and/or 252 (and/or another communicatively coupled device) allow the first and second users 201 and 251 to share artificial-reality interactions. More specifically, each user can interact with their respective representation of a real-world scene presented via the first and second artificial-reality headsets 202 and 252, and their interactions are shared with other users in their respective representation of a real-world scene such that the shared interactions are scene responsive, scene aware, and visually coherent. For example, in the shared artificial-reality activity of FIGS. 2A-2D, the first user 201 interacts with real-word objects or digital twins within a first representation of the first real-world scene, the first user 201's interactions are associated with corresponding real-word objects or digital twins within a second representation of the second real-world scene; and a second interaction (corresponding to the first user 201's interaction) is performed in the second representation of the second real-world for the second user 251. In other words, the interactions of each user are interconnected and shared such that respective interactions are replicated or reproduced in another user's representation of a respective real-world scene.

FIG. 2B shows the first user 201 performing a gesture 208 associated with a user input for interacting with the real-world object 204. The user input is directed to an interaction (e.g., a selection, a user command to modify a digital twin of, etc.) with the real-world object 204 via a digitally-generated assistant (e.g., a first digitally-generated assistant 210). Responsive to an indication that the first user 201 performed the gesture 208, the first artificial-reality headsets 202 presents or is caused to present (e.g., via an intermediary processing device) a digital twin 214 corresponding to the real-world object 204 within an updated first representation of the first real-world scene, as well as the first digitally-generated assistant 210. The first artificial-reality headset 202 further presents or is caused to present an animation sequence that includes the first digitally-generated assistant 210 moving towards the digital twin 214 and interacting with the digital twin based on the gesture 208. In some embodiments, the first artificial-reality headset 202 also presents or is caused to present a user-interface element 216 (which is associated with one or more affordances) near the digital twin 214, which can be used to indicate an interactive aspect of the digital twin 214. For example, a digital twin of a chair can be associated with one or more affordances (which define possible interactions with the digital twin), such as (i) an affordance at or near the seat of the chair that indicates the user's ability to sit in the physical location corresponding to the seat of the chair (e.g., based on the location of the real-world chair or an object having sufficient similarity criteria) or (ii) an affordance within the artificial-reality environment that indicates that the user or a virtual character within the artificial-reality environment can simulate sitting in the chair at the simulated location of the seat. Additional examples of affordances are discussed below in reference to FIGS. 4C-4D.

Additionally, responsive to the indication that the first user 201 performed the gesture 208, the second artificial-reality headset 252 can present, or be caused to present, a user-interface element 266 near another digital twin 264 to notify the second user 251 that the other digital twin 264 has been selected and/or an interaction is being performed that is directed to the other digital twin 264. The other digital twin 264 can be selected based on the interconnectedness of the artificial-reality environments presented by the first and second artificial-reality headsets 202 and 252. More specifically, the other digital twin 264 (which corresponds to another real-world object 254) is determined to satisfy (e.g., meet) similarity criteria with the digital twin 214 (e.g., the other real-world object 254 is identified as an interactive real-world object on a surface that is proximate to the second user 251), and the first user 201's interactions with the digital twin 214 are associated with the other digital twin 264. In some embodiments, the similarity criteria are based on other aspects of the respective digital twins within the users' real-world environments (e.g., structural aspects of the real-world object, relative orientations of the respective user and the respective real-world object, etc.). The first user 201's interactions with the digital twin 214, are presented (e.g., translated to the corresponding contextual scenario in the second artificial-reality environment) or caused to be presented to the second user 251, via the second artificial-reality headsets 252, as interaction with the other digital twin 264 within the second representation of the second real-world scene. For example, responsive to the indication that the first user 201 performed the gesture 208, the second artificial-reality headsets 252 presents or is caused to present another animation sequence that includes a second digitally-generated assistant 260 moving towards the other digital twin 264.

In some embodiments, the second artificial-reality headset 252 modifies or is caused to modify the other digital twin 264 and/or the other animation sequence to account for one or more aspects of the second real-world environment. For example, in FIG. 2B, the first user 201 is seated at a first side 206a of the desk 206 and the second user 251 is seated at a second side 256b of her desk 256 (which is opposite to the first user 201's position), and the first digitally-generated assistant 210 can be caused to interact with the digital twin 214 from the second side 206b of the desk and the second digitally-generated assistant 260 can be caused to interact with the other digital twin 264 from the first side 256a of the desk 256. In this way, when users are engaging in an interactive artificial-reality activity, different real-world objects in the respective real-world scenes corresponding to the users' respective locations can be used in conjunction with related animations as part of the shared artificial-reality interaction.

FIG. 2C shows the first and second digital-generated assistants 210 and 260 moving the digital twins 214 and 264 as part of the interconnected animation between the representations of the first and second real-world scenes. In some embodiments, after the first and second digital-generated assistants 210 and 260 move their respective digital twins, the first and second artificial-reality headsets 202 and 252 can update the respective representations of the first and second real-world scenes to maintain visual coherence (e.g., camouflage the area of the desks including the moved real-world objects, which can be performed by generating a camouflage layer within a plurality of layers that is being used to present the artificial-reality environment). In some embodiments, information identified by image data about the respective real-world scenes (e.g., image data obtained by the first and second artificial-reality headsets 202 and 252) is used to determine respective paths of animation for the respective digitally-generated assistants within the real-world scenes. For example, there can be another chair or other obstacle in either of the first or second real-world scenes that one of the respective digitally-generated assistants is configured to responsively navigate around. In some embodiments, the respective real-world scenes can include doors that the digitally-generated assistants exit through as part of the animation sequence, and one or more of the first digitally-generated assistant 210 and/or the second digitally-generated assistant 260 opens a closed door as part of the exiting step of the animation.

FIG. 2D shows new representations of the first and second real-world scenes that include artificial-reality content items 220 and 270, in accordance with the second user 251 performing a gesture 272 (e.g., a gesture that includes a pinch contact between a thumb and a first finger of the second user 251). That is, both the first user 201 and the second user 251 can cause operations that modify the representation of the real-world scene of the other respective user (e.g., by performing user commands, such as gestures that correspond to a gesture interaction space provided by the artificial-reality environment). The artificial-reality content items 220 and 270 are caused to be presented so as to appear on respective surfaces of the desks 206 and 256, which can be based on the desks 206 and 256 meeting the similarity criteria of having respective surfaces identified in accordance with generating one or more layers in conjunction with presenting the artificial-reality environment.

FIGS. 3A-3G illustrate the capture of image data that is used to generate a plurality of layers for forming a representation of a real-world scene, in accordance with some embodiments. In some embodiments, a user is prompted to scan a real-world environment. In some embodiments, the prompt is presented in response to a user input requesting to generate an AR environment representative of the user's real-world scene. Alternatively, or additionally, in some embodiments, the prompt is presented in response to a user input requesting to participate in an AR experience (e.g., an interaction with a representation of their real-world environment, participate in a shared mixed-reality experience, etc.). In some embodiments, while a scan of a real-world scene is being performed, the prompt can provide an indication that obtained image data, available at the AR system, for generating the real-world scene is insufficient for generating one or more aspects of a representation of the real-world scene within an artificial-reality environment (e.g., the captured image data is insufficient or that a particular real-world environment does not meet the minimum requirements to be used in forming a representation of a real-world scene). In some embodiments, scanning can include, capturing data, via one or more imaging sensors. The image sensors can be part of (e.g., constituent components of) an artificial-reality headset (e.g., the AR devices 1200 and/or the VR devices 1210 shown and described in reference to FIGS. 12A-12C) and/or one or more devices communicatively coupled with the artificial-reality headset. The devices communicatively coupled with the artificial-reality headset can include a wrist-wearable device 1100 shown in FIGS. 11A and 11B, a mobile device (e.g., a smart phone), a handheld intermediary processing device 1300 to process data for use within an AR system, a computer, etc.

FIG. 3A shows an example prompt presented to the user at a first point in time via a scanning user interface 302. The prompt can include instructions to assist the user in scanning of a real-world environment, such that a representative real-world scene can be accurately replicated and presented within an AR environment presented to the user via an artificial-reality headset. The scanning user interface 302 includes a prompt user interface element 304 that can be used to provide instructions to users regarding a scanning process such that a minimum capture threshold is satisfied to form a representation of the real-world scene (e.g., the image data captures 50% of a room, 80% of a wall, etc.). For example, in FIG. 3A, the prompt user interface element 304a includes an indication stating: “Move device to start.” In some embodiments, the prompt user interface element 304 is configured to provide dynamic instructions to users regarding scanning operations.

FIG. 3B shows the scanning user interface 302 at a second point in time after a user has initiated scanning of the real-world scene. The scanning user interface 302 includes an updated prompt user interface element 304b. The updated prompt user interface element 304b includes a new textual prompt stating: “Point camera at the top edge of wall.” Alternatively, or additionally, in some embodiments, the prompt user interface element 304 includes visual instructions (e.g., showing a user where to direct a camera). In some embodiments, the scanning user interface 302 also includes a progress indicator user interface element 306 that includes a representation of a portion of the real-world scene captured in the image data. In some embodiments, the progress indicator user interface element 306 indicates a portion of the real-world scene captured by the image data in relation to the minimum capture threshold (e.g., “70% of the room captured, 30% to go!”).

FIG. 3C shows the scanning user interface 302 at a third point in time after the user has performed additional scanning of the real-world scene. The progress indicator user interface element 306 is updated based on the additional scanning. In some embodiments, the scanning user interface 302 includes a mapping indicator user interface element 308 that defines aspects of the real-world scene (e.g., depth defined by the corners of a room). In some embodiments, the mapping indicator user interface element 308 identifies portions of the real-world scene that will be represented within one or more layers of a plurality of layers representing the real-world scene (e.g., a photometric layer 324, a geometric layer 322, a semantic layer 326, etc.).

FIG. 3D shows the scanning user interface 302 at a fourth point in time after the user has performed additional scanning of the real-world scene. In some embodiments, the scanning user interface 302 provides additional instructions for improving the accuracy of the image data captured for forming a representation of a real-world scene. For example, as shown in FIG. 3D, the scanning user interface 302 can include a textual prompt requesting the user slow down movement of the image sensor while scanning the real-world scene. Additional instructions for improving the accuracy of the accuracy of the image data can include requesting the user to put the image sensor in focus, requesting the user to move closer or further to a target area, requesting the user to adjust a capture angle, requesting the user to capture in landscape or portrait mode, requesting a user to adjust an image sensor movement speed, etc.

As further shown in FIG. 3D, the progress indicator user interface element 306 is also updated based on the additional scanning, and includes a portion representing a window. For example, the progress indicator user interface element 306 can show the window as a transparent or cutout portion of a representation of a real-world scene. In some embodiments, another mapping indicator user interface element 310 is presented adjacent to the scan of the window of the real-world scene. The other mapping indicator user interface element 310 can indicate an interactive aspect of the real-world scene. For example, the other mapping indicator user interface element can indicate that a window (e.g., a physical, or real-world window in the real-world scene is interactable (e.g., that the window can be used for a particular interactive feature within an artificial-reality environment). As described above, the other mapping indicator user interface element 310 identifies portions of the real-world scene that will be represented within one or more layers of the plurality of layers representing the real-world scene).

FIG. 3E shows the scanning user interface 302 at a fifth point in time after the user has performed additional scanning of the real-world scene. The progress user interface element 306 is further updated based on the additional scanning, and includes additional information about the real-world scene (e.g., three walls and an indication that the window in the real-world scene is a transparent object). A set of mapping indicator user interface elements 312 is presented within the scanning user interface 302. The set of mapping indicator user interface elements 312 can identify one or more interactive aspects and/or other aspects (e.g., navigational aspects, structural aspects, functional aspects, etc.) of the real-world scene that are to be included in a representation of the real-world scene formed by the plurality of layers.

FIG. 3F shows the scanning user interface 302 at a sixth point in time after the user has completed a scan of the real-world scene. The progress user interface element 306 is updated based on a completed scan, and includes details of the real-world scene, such as each wall of the real-world scene, real-world objects within the real-world scene, navigable paths in the real-world scene, etc. In some embodiments, one or more mapping elements 314 and 316 outline one or more portions of the room (e.g., indicating an outer perimeter of the real-world scene, and/or a navigable area (which may be spatially annotated within a semantic layer, in accordance with some embodiments)). In some embodiments, the progress indicator user interface element 306 provides an indication that the captured image data satisfies the minimum capture threshold (e.g., room scanning complete). For example, an indication can be provided to the user after a minimum amount of image data of the real-world scene has been obtained to accurately form a representation of the real-world scene within an artificial-reality environment. As further shown in FIG. 3F, an artificial-reality headset and/or one or more devices communicatively coupled with the artificial-reality headset can store the captured image data. The captured image data of a real-world scene can be used to generate a plurality of layers for forming a representation of the real-world scene. In some embodiments, the stored image data of a real-world scene can be used to update previously stored image data of the real-world scene. Alternatively, or additionally, in some embodiments, the stored image data of a real-world scene can be combined with stored image data of other real-world scenes to enable an AR system to generate a plurality of layers for forming an AR environment that includes a number of different representations of real-world scenes combined (e.g., form a cohesive AR world that includes any number of representations of real-world scenes).

FIG. 3G shows one or more layers of the plurality of layers generated based on captured image data, in accordance with some embodiments. In some embodiments, the plurality of layers includes at least two layers. For example, the plurality of layers can include a photometric layer 324 and a geometric layer 322. The plurality of layers includes different aspects (e.g., representations of visual components) of a real-world scene. One or more layers of the plurality of layers can be used to form a representation of a real-world scene that is displayed by an artificial-reality system, which can include an artificial-reality headset. The image data for generating the plurality of layers is obtaining via a scanning process as described above in reference to FIGS. 3A-3F and/or via an imaging device (e.g., a camera) that is communicatively coupled with an artificial-reality system (e.g., an AR device 1200 and/or a VR devices 1210). For example, any of the cameras 1239A, 1239B, and 1239C of an artificial-reality VR devices 1210 can be used for obtaining the image data used in generating the plurality of layers. In some embodiments, all three of the cameras 1239A, 1239B, and 1239C are used to obtain image data. In some embodiments, additional image data can be provided to the artificial-reality system in conjunction with or alternatively to camera data obtained by imaging sensors of the artificial-reality headset.

As shown in FIG. 3G, the plurality of layers can include a geometric layer 322, a photometric layer 324, and a semantic layer 326. In some embodiments, each of the layers 322, 324, and 326 includes distinct information about aspects of the real-world scene that can be used to form a representation of the real-world scene for presentation via an artificial-reality system as described herein. In particular, the plurality of layers include information for defining interactions by the user with digital twins and other virtual objects within the representation of the real-world scene (e.g., the interactions digital twins and/or between a digitally-generated assistant and a digital twin as described above in reference to FIGS. 1A-2D). In some embodiments, each layer can be a single layer or include one or more sublayers. For example, a semantic layer 326 can be a single layer that includes one or more object affordances (e.g., object affordance 328) and/or one or more navigational affordances 330, or can include sublayers such as a semantic object layer (e.g., including object affordance 328) and/or semantic navigable area layer (e.g., including navigational affordances 330). The object affordance 328 (e.g., an affordance associated with a real-world object or corresponding digital twin) can be a receptive and/or responsive affordance. Similarly, a navigational affordance (e.g., a feature of the real-world environment, such as a wall corner) can be a receptive and/or responsive affordance.

In some embodiments, less than all of the layers shown in FIG. 3G are used to represent the corresponding real-world scene within a particular artificial-reality environment (e.g., the representation of the real-world scene). For example, in some embodiments described herein (e.g., method 600), a method for presenting a representation of a real-world scene within an artificial-reality environment can include generating a first layer including an image of a real-world scene that includes a real-world object (e.g., the photometric layer 324), and a second layer including a geometric representation of a real-world scene (e.g., the geometric layer 322). Alternatively, in some embodiments, the at least three layers shown in FIG. 3G are used to form the representation of the real-world scene. In some embodiments, information from two or more of the layers 322, 324, and 326 can be contained within a single layer and/or other data object configured to perform operations related to an artificial-reality representation of the real-world environment.

In some embodiments, the geometric layer 322 includes information about relative dimensions of objects within the real-world scene, and/or the artificial-reality representation of the real-world scene. The geometric layer 322 can be used to maintain visual coherence. Visual coherence is the illusion that physically non-existing virtual objects or virtual characters are situated in local physical space. Visual coherence can be achieved by geometrically coherent world-locked rendering, occlusion, physically-coherent lighting, gravity, and/or collision detection via a geometric 3D environment representation and 6 degree of freedom (6DoF) device tracking. For example, the geometric layer 322 can be used to represent occlusion, lighting, and/or collision.

In some embodiments, the photometric layer 324 includes color information about respective locations of the real-world scene based on the image data. The photometric layer 324 can be used to maintain scene responsiveness. Scene responsiveness is the illusion that a real-word physical object's poses, shapes, and states, are manipulated by virtual characters or virtual actions of the user. Scene responsiveness is achieved by re-rendering the respective objects in the desired pose, shape, and state, while filling any revealed background. For example, the photometric layer 324 can be used to fill vacancies or gaps created by movement of a representation of a real-world object and/or corresponding digital twin.

In some embodiments, the semantic layer 326 includes one or more affordances based on the real-world scene (e.g., object affordances 328, and navigational affordances 330). In some embodiments, digital twins of real-world objects (e.g., a digital twin 312 of a chair, which can be the same chair digital twin 102b shown in FIGS. 1A-1V)). The semantic layer 326 can be used for scene awareness. Scene awareness is a perception (e.g., an illusion) that virtual objects and characters respect the semantics of the physical environment (e.g., semantic aspects of real-world objects, including identified functional meanings of the real-world objects (e.g., identifying that a functional meaning of a chair can indicate the chairs function as a seat)). Scene awareness is achieved by purposeful placement, path planning, and situated animations through structural scene understanding (surfaces, object instances with their respective classes, poses, shapes, and states), functional scene understanding (object affordances, walkable area, scene hierarchy), scene-related user understanding (activities, interaction space, attention space), etc.

In some embodiments, the semantic layer 326 includes one or more affordances associated with one or more real-world objects. The one or more affordances define one or more properties for interacting with a respective real-world object and/or portions of a real-world scene. More specifically, the one or more affordances can have respective affordance features. Both receptive and responsive affordances include affordance features that describe the spatial and operational details of the afforded user-object (e.g., user-real-world or user-digital twin) or character-object interaction (e.g., user-digitally-generated assistant (or other virtual character)). Non-limiting examples of receptive affordances include sitting, lying, hiding, climbing, etc. Non-limiting examples of responsive affordances include dragging, pushing, carrying, pressing, etc.

For example, a character affordance (e.g., a receptive and/or responsive affordance associated with a digitally-generated assistant) can define how to situate an animation (e.g., how a digitally-generated assistant will orient and place a chair in a representation of a real-world scene, how the digitally-generated assistant will navigate the representation of the real-world scene (e.g., how the digitally-generated assistant will sit in a chair, hide at a corner, etc.), how a digital twin will interact with other digital twins or representations of real-world objects, how a digital twin will interact with the digitally-generated assistant, etc.) and a receptive affordance can define (e.g., indicate) a change in state of the real-world object, and/or the digital twin of the real-world object (e.g., an elevator door opening, a cart moving, etc.). The two types of affordances described above are non-limiting. Additional types of affordances can be included in a semantic layer.

In some embodiments, a visually-responsive relationship is determined between two or more of the layers presented by the artificial-reality headset (e.g., two or more of the layers 322, 324, and 326). In some embodiments, the visually-responsive relationship causes (i) respective layers of the plurality of layers to appear to be indistinguishable via the artificial-reality headset, and (ii) interactions by the user with the user with the real-world object or the digital twin of the real-world object to appear to be interconnected.

In some embodiments, digital twins of real-world objects can be generated such that the digital twins can be interacted with by the user via the artificial-reality environment. In some embodiments, once a digital twin has been generated for a real-world object within the real-world scene, determining the visually-responsive relationship includes applying the geometric representation of the real-world scene of the second layer (e.g., the geometric layer 322) to the image of the real-world scene of the first layer (e.g., the photometric layer 324), to allow for generation of the digital twin of the real-world object (e.g., the digital twin 312). In other words, information from two or more layers of the artificial-reality representation of the real-world scene can be combined in order to generate a digital twin that is respective of the properties of the real-world object within the real-world scene.

FIGS. 3H-3M show additional examples of layers that can be generated as part of presenting a representation of a real-world scene. For example, FIG. 3H shows a color passthrough layer, FIG. 3I shows a mesh layer, FIG. 3J shows a wireframe geometric layer, FIG. 3K shows a transparent wireframe with a navigation mesh, FIG. 3L shows masked layer with a navigation mesh, and FIG. 3M shows a normal mapping mesh. In some embodiments, the user can manually select one or more layers to adjust a representation of a real-world scene. For example, the user can select one or more layers to co-locate the layers. This allows the user to tune a representation of a real-world scene to further improve the accuracy of an AR environment.

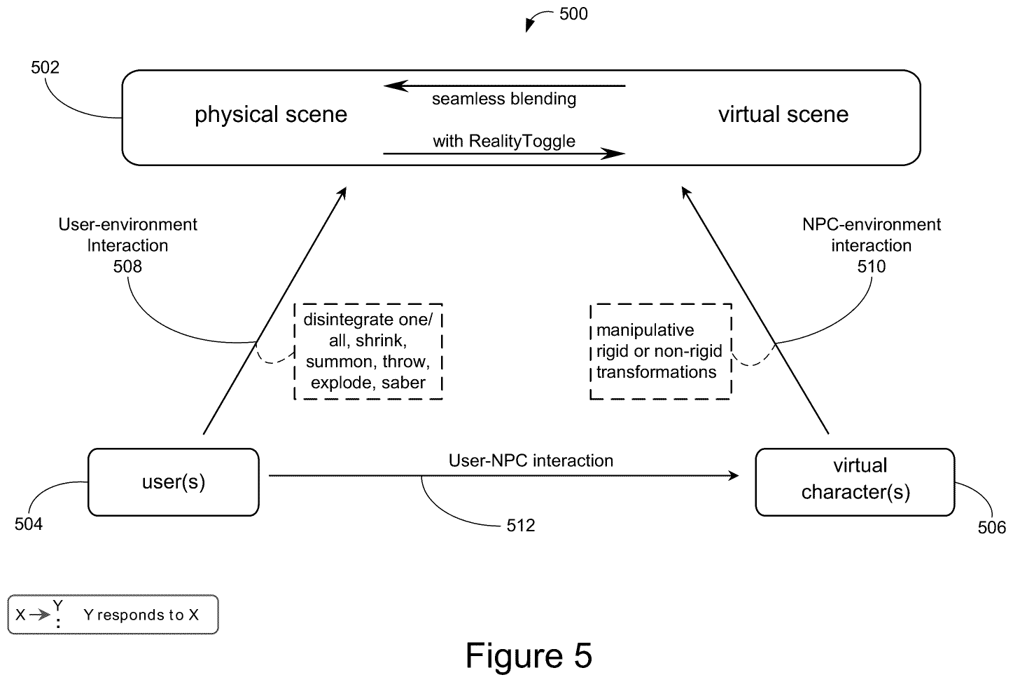

In some embodiments, at least one respective layer of the plurality of layers includes (i) geometric, (ii) photometric information, and (iii) semantic information. In some embodiments, one or more layers include geometric and/or photometric information that is configured to allow spatial annotation of semantic information into one or more additional layers. In some embodiments, layers that include semantic information are generated based on the information in the geometric and/or photometric layers (e.g., the layers 322 and 324). That is, the geometric and/or photometric information can be configured to provide spatial annotation of semantic information within an additional layer and/or a layer that includes such information. For example, in some embodiments, the semantic layer 326 can be spatially annotated based on the information in one or more of the first and second layers. In some embodiments, each object in a representation of a real-world scene is annotated with character object affordances, user-object affordances, or both. Character affordances can include receptive affordances, such as sit, lie, hide, climb, and responsive affordance, such as drag, push, carry, press. User affordances are responsive affordances and include summoning, particle-system-based disintegration, and repulsion interactions (as described below in reference to FIG. 5).

FIG. 3N shows an example method 380 of modifying a real-world object within a scene-responsive representation of a real-world scene is provided, in accordance with some embodiments. The method 380 may also be described herein as a reality toggle, object removal, a masking algorithm, and/or camouflaging (e.g., via a camouflage layer and/or a camouflage quad). In some embodiments, the method 380 includes using one or more spatial computing and/or shader components to modify (e.g., toggle) a real-world object's reality state (e.g., generating a digital twin of the real-world object, which may be performed for the purposes of scene responsiveness.

In some embodiments, the method 380 includes one or more operations performed in three-dimensional space, in addition, or alternatively to, in image space. In some embodiments, the method 380 can be used to present realistic representations of real-world scenes behind manipulated objects (e.g., objects for which one or more digital twins have been generated). In some embodiments, the method 380 uses a photometric three-dimensional representation (e.g., the photometric layer 324 shown in FIG. 3G). In some embodiments, one or more layers (e.g., the geometric layer 322, the photometric layer 324, and the semantic layer 326) can be used to remove representations of real-world objects from the representation of the real-world scene (e.g., the photometric layer 324 can be used for object removal). For example, a photometric layer can be used for object removal by instantiating a camouflage layer, and/or camouflage portion of an existing layer within the artificial-reality representation of the real-world scene.

In some embodiments, the method 380 includes generating a camouflage layer portion (e.g., a camouflage quad 390) that is configured to completely surround a real-world object (e.g., the chair digital twin 102b) in the obtained image data. One of skill in the art will recognize that the red representation of the camouflage quad 390 may not be indicative of actual visual qualities of the camouflage quad 390 as presented within the representation of the real-world scene. In some embodiments, the camouflage quad is sized to be larger than the portion of the real-world object being removed. In some embodiments, the method 380 includes generating the camouflage layer such that it does not include complicated edges, and/or such that it is configured to enable smooth alpha-blending towards the edges.

In some embodiments, the method 380 includes positioning the camouflage quad along a virtual ray extending from a camera that is in electronic communication with the artificial-reality system to an object center of the real-world object to be camouflaged within the real-world scene. In some embodiments, the method 380 includes positioning the camouflage quad at a distance (e.g., a depth relative to the artificial-reality headset) that is half of a maximum side length (e.g., a side length 394) of the camouflage quad 390.

In some embodiments, the method 380 further includes texturing the camouflage quad 390 with a stereoscopic render texture. In some embodiments, the stereoscopic render texture is obtained (e.g., generated, produced) by combining additional image data with the image data obtained to generate the layers (e.g., the layers 322, 324, and 326) of the representation of the real-world scene. In some embodiments, the additional image data is obtained by additional cameras (e.g., the camera 1239C) of the artificial-reality headset that are calibrated to be more similar to a representation as viewed by human eyes (e.g., additional cameras with the same calibration as the eyes (e.g., cameras that are aligned with a user's field of view, a real-world height, perspective, and/or viewpoint of the user's eyes while they are viewing the real-world scene)).

In some embodiments, the method 380 further includes causing the camouflage quad to have a modified transparence near one or more edges and/or corners of the camouflage quad. In some embodiments, a circular transparency texture map (e.g., a circular transparency texture map 392) is applied to the camouflage quad 390 to cause the modification of the transparency of the camouflage near the one or more edges and/or corners of the camouflage quad. In some embodiments, the method 380 includes texturing the camouflage quad 390 with a stereoscopic render texture, produced from two additional masking cameras having the same calibration as the eye cameras. In some embodiments the stereoscopic render texture includes rendering the background mesh. In some embodiments, the method 380 includes obtaining a circular two-step gradient texture map for alpha blending to achieve a smooth fade-out towards the edges. In some embodiments, the masking quad uses the color of the background mesh as seen from the artificial-reality headset.

In some embodiments, the method 380 further includes rendering a virtual object twin in a respective pose (e.g., a physical location and orientation) of the physical object (e.g., a camouflage representation of the real-world object), while presenting the camouflage quad with respective occlusion and/or lighting caused by the background mesh (e.g., a mesh corresponding to one or more of the layers 322, 324, and/or 326). In some embodiments, a virtual character (e.g., a digitally-generated assistant) within the artificial-reality representation of the real-world scene is rendered so as to overlay the camouflage quad 390, while (i) respecting occlusions caused by the background mesh and every virtual object presented within the artificial-reality representation of the real-world scene, and (ii) casting shadows (using a custom lighting model with attenuation as shadow) on the background mesh. In some embodiments on or more of the shadows cast by the virtual object are caused to be occluded and/or augmented (e.g., via shading superposition) in accordance with the presence of other virtual objects and/or the background mesh (e.g., via self-shadowing of the background mesh).

In some embodiments, in accordance with a camouflage object (e.g., the camouflage quad) being instantiated, passthrough image data obtained by one or more cameras of the artificial-reality headset (e.g., the cameras 1239A and 1239B) is caused to be rendered in the background of the camouflage object, as opposed to directly accessing entire sets of RGB values within image frames captured via the artificial-reality headset. In some embodiments, alternative rendering queue positions, depth write flags, and depth test flags are used to cause all occlusions to be respected in adjusting the presentation of one or more of the layers 322, 324, and 326 (e.g., the photometric layer 324) that represents the real-world scene. In some embodiments, a masking quad (e.g., the camouflage quad 390 can be applied to as many objects as needed in the scene and seamlessly works for multiple masks, even in the same line of sight. In some embodiments the method 380 includes blending (e.g., via compositing) the passthrough layer in the background with the rendered quad (e.g., which may be represented in a software program as SrcAlpha, OneMinusSrcAlpha, etc.).

FIGS. 4A-4J illustrate additional examples of interactions between users and/or virtual characters (e.g., digitally-generated assistants) and the respective real-world scenes being presented by respective artificial-reality headsets, in accordance with some embodiments. In some embodiments, analogs to interactions shown in FIGS. 4A-4J can be performed in conjunction with the operations and/or interactions performed in FIGS. 1A-3N.

FIGS. 4A-4B show a representation of a real-world scene 402 that includes a virtual character 404 (e.g., a digitally-generated assistant), a representation of a real-world object 406a (e.g., a rolling cart), and a digital twin 406b of the real-world object. In some embodiments, the digital twin 406b of the representation of the real-world object 406a is presented in place of the representation of a real-world object 406a in response to an interaction between a virtual character, such as the virtual character 404, and the representation of the real-world object 406a presented within the representation of the real-world scene. As described above in reference to FIG. 1A-2D, a user can interact with a representation of a real-world object via a digitally-generated assistant without any interaction with the representation of the real-world object (e.g., without performance of any user commands directed to the representation and/or digital twin of the real-world object). In some embodiments, the representation of the real-world object 406a is recognized as meeting digital-interaction criteria before an interaction sequence is performed.

FIGS. 4C-4D show a representation of a real-world scene 412 that includes the digitally-generated assistant 414 and a digital twin 416. In FIG. 4C, additional brown affordances are presented (e.g., a brown affordance 415). The brown affordances are examples of receptive affordances (e.g., FIG. 3G) and are associated with real-world objects and/or representations of real-world objects within the real-world scene. The receptive affordances indicate real-world objects within the representation of the real-world scene with which the digitally-generated assistant 414 (and/or a user interacting with the representation of the real-world scene 412) can interact and a state in which they are interact (e.g., cartwheels are spinning). Blue affordances are examples of object or character affordances (e.g., FIG. 3G) and are associated with digital twins and/or digitally-generated assistants. The character affordances define how to situate an animation for interacting with representations of real-world objects and/or their corresponding digital twins (e.g., in which way to push the cart, how to orient a digital twin of a chair so that it reflects a physical chair in the real world that the user can use, etc.). In other words, the object or character affordances can indicate the presence of a real-world object that can be interacted with, either within the artificial-reality environment or via the physical actions by the user within the physical environment. For example, a blue affordance 418 indicates the presence of a physical chair in that location that can be interacted with by the user from within the physical environment.

FIGS. 4E-4F show examples of a user interacting with representations of real-world scenes that include a real-world object in a physical location, where the corresponding digital twin has been removed from the location. In particular, FIGS. 4E-4F show toggling between a real-world view and a presented representation of a real-world scene.

FIG. 4E shows a user performing a gesture using a handheld controller towards a location in the physical scene. The gesture is configured to toggle between a real-world view and a representation of a real-world scene. In some embodiments, the gesture is configured to cause an AR system (e.g., artificial-reality headset) to present a reality-viewer window that operates as a passthrough view (e.g., is configured to provide a passthrough display of the real-world scene based on image data obtained via cameras of the artificial-reality headset). The reality-viewer window is controlled by the controller and removes the illusion presented by the AR system (e.g., ceases to present a portion of a virtual AR environment (e.g., a representation of a real-world scene, a representation of a real-world object, and/or a digital twin) and presents the real-world environment (e.g., real-world objects and a real-world scene) within the user's physical environment). For example, in accordance with a user moving the reality-viewer window over a portion of a representation of a real-world scene that camouflages a physical chair, the portion of the camouflage within the reality-viewer window is removed such that the user can view the physical chair. In this way, the user can quickly view their real-world environment if the virtual AR environment is overwhelming. Additionally, the reality-viewer window allows the user to view their real-world environment in order to avoid running into physical objects, walls, etc.

FIG. 4F shows another example of a real-world view while a representation of a real-world scene is presented. In some embodiments, an AR system can present an indication (e.g., a guardian boundary indication) at or over (e.g., as a two-dimensional or three-dimensional overlay on) a real-world object in the user's physical space. More specifically, the guardian boundary indication notifies a user of physical objects while a representation of a real-world scene is presented such that the user can avoid the physical objects. In some embodiments, the guardian boundary indication is presented over physical objects that have been replaced with a digital twin and/or are camouflaged. In some embodiments, a guardian boundary indication is presented based on a user's relative proximity to the real-world object within the physical environment, even if the user is not in proximity to the digital twin of the real-world object. In some embodiments, guardian boundary indication is presented as an additional safety measurement so as to notify the user of real-world objects that they can interact with and/or should avoid. The user can selectively toggle the guardian boundary indication based on their preferences (e.g., safety preferences). In some embodiments, the user can set safety preferences to adjust how and when the guardian boundary indication is presented (e.g., adjusting a threshold distance from the real-world object for which the guardian boundary indication will be presented).

FIG. 4G shows a digitally-generated assistant 450 animating (e.g., moving) within a representation of a real-world scene. As shown in FIG. 4G, the digitally-generated assistant 450 can be presented in conjunction with a plurality of pathing indicators (e.g., pathing indicators 454a-454g), which indicate possible paths of movement for the digitally-generated assistant 450. In some embodiments, the user can select a particular pathing of the plurality of pathing indicators, and cause the digitally-generated assistant 450 to proceed along the selected pathing.

FIGS. 4H-4I show a sequence where two users are interacting via a shared artificial-reality application. A remote user 496 is shown in an upper right corner of the field of view shown in FIGS. 4H-41. In some embodiments, imaging data of the remote user 496 is not shown in the field of view. The users are having a shared artificial-reality interaction where the users are sitting in physical chairs (e.g., real-world objects) within their respective physical environments that include respective and distinct and separate real-world scenes. A virtual character 494 is representing the remote user 496 in the representation of the real-world scene being presented within the user's artificial-reality environment (e.g., via an artificial-reality headset). The virtual character 494 is caused to sit at the real-world table within the representation of the real-world scene, at one of the representations of the real-world chairs within the real-world scene. The virtual character 494 causes the representation of the chair to become a digital twin of the chair, and pulls the chair away from the table. Such scene responsiveness causes the animation to be presented to evoke the technical effect of situating the user within the artificial-reality environment by presenting the real-world scene in a way that is representative of not only the visual (e.g., photometric) elements of the real-world scene, but also the semantic aspects of the physical environment in which the real-world scene is situated.

FIG. 5 shows an example logical flow diagram 500 indicating interactive relationships between users and virtual characters presented by artificial-reality systems, in accordance with some embodiments. As described above, the systems and method provided herein provide an interconnected artificial-reality environment 502 that provides for interactions that integrate a physical scene and a virtual scene (e.g., via seamless blending, which may be described herein as a reality toggle). The logical flow diagram 500 illustrates a framework for interactions by and between one or more user(s) 504 and one or more virtual character(s) 506 (e.g., digitally-generated assistants), such that the user(s) 504 and/or the virtual character(s) can perform interactions with a representation of a real-world object or a digital twin corresponding to the real-world object. In some embodiments, the user is associated with a first set of available interactions (e.g., user-environment interactions 508), and the virtual characters are associated with a second set of available interactions (e.g., NPC-environment interactions 510). The first and second set of available interactions can be the same or distinct, in accordance with some embodiments. In some embodiments, the first set of available interactions associated with the user includes all of the second set of available interactions associated with the virtual character(s) 506, and the second set of available interactions associated with the virtual character(s) 506 include a subset, less than all, of the first set of available interactions. For example, there can be a first predefined set of interactions available to users within the artificial-reality environment (e.g., actions that users can perform with digital twins of real-world objects within the real-world scene), and there can be a second predefined set of interactions available to virtual characters within the artificial-reality environments (e.g., animations that include the virtual character moving and/or interacting with digital twins of real-world objects within the real-world scene). In some embodiments, one or more of the user-environment interactions 508 that are available to the user allow for greater control of the representation of a real-world scene, whereas the interactions of the virtual characters are dependent on user input and limited to manipulations and non-rigid transformations within the representation of the real-world scene. One of skill in the art will appreciate that a non-rigid transformation is a transformation that changes the size but not the shape of the real-world object (e.g., the image of the real-world object obtained via image data). For example, interactions from the first predefined set of interactions can include disintegrating, shrinking, summoning, throwing, exploding, and/or sabering (e.g., cutting via a directed gesture) some or all digital twins of real-world objects. And interactions from the second predefined set of interactions can include manipulative rigid or non-rigid transformations with digital twins of real-world objects within the representation of the real-world scene. In other words, virtual characters can have different (e.g., less) ways of manipulating objects within the real-world scene.

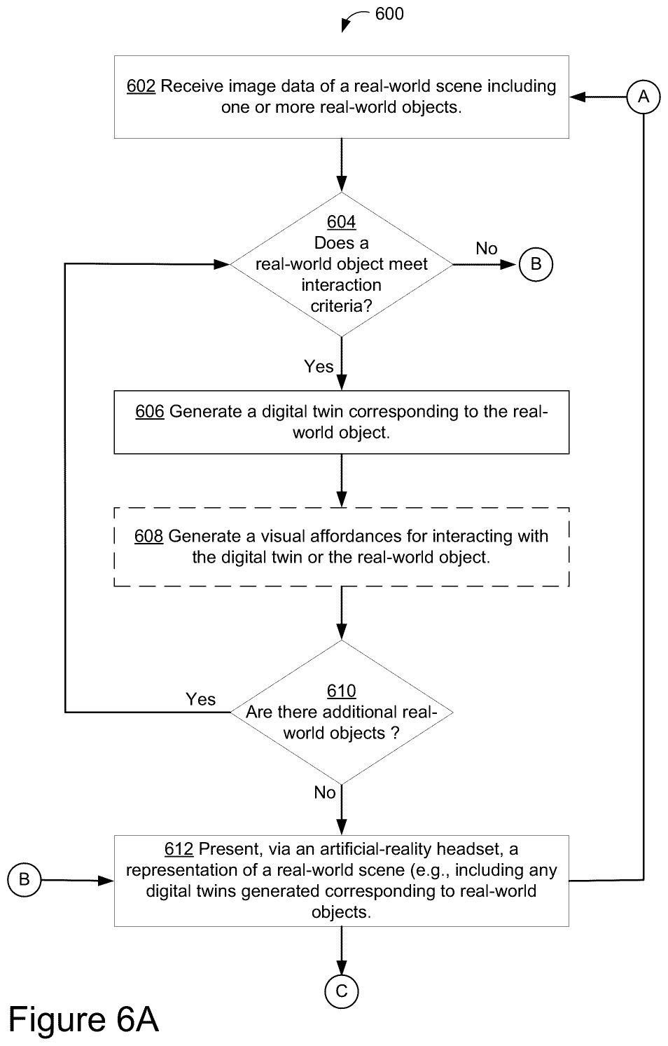

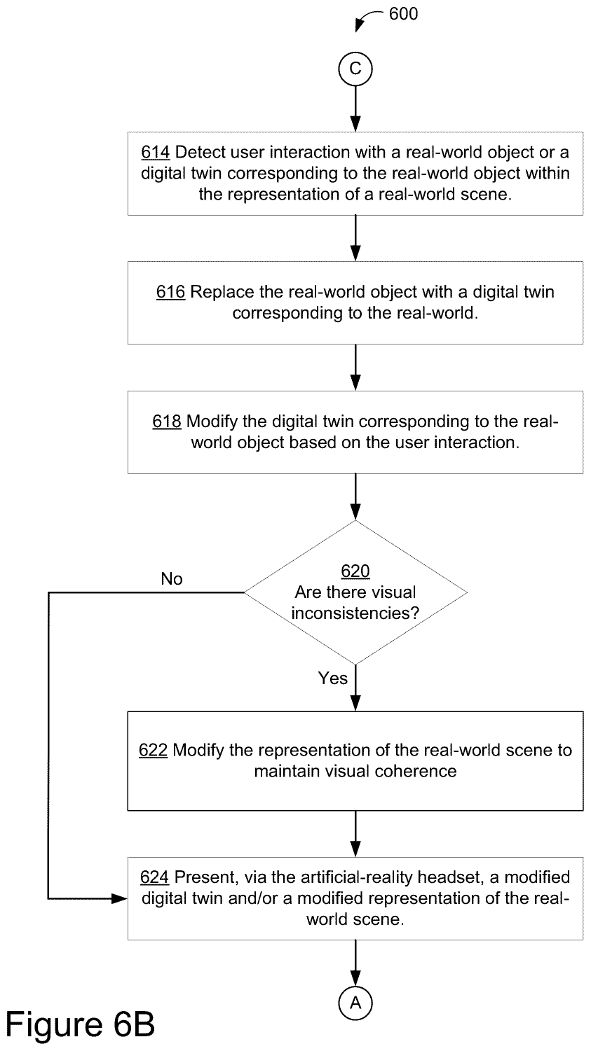

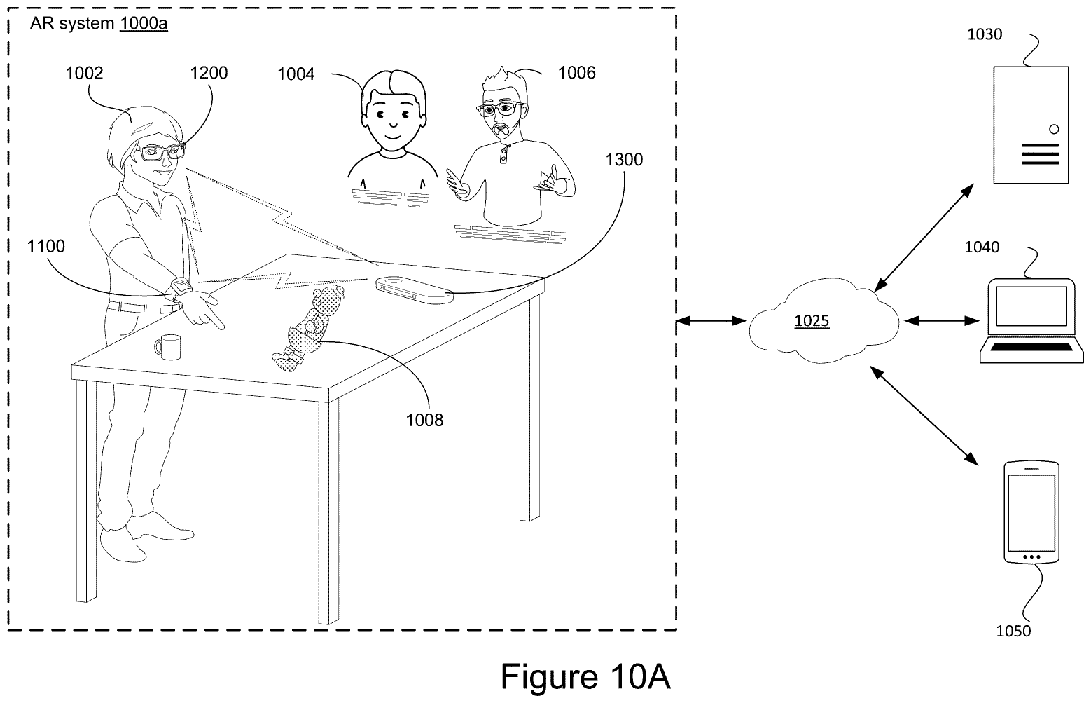

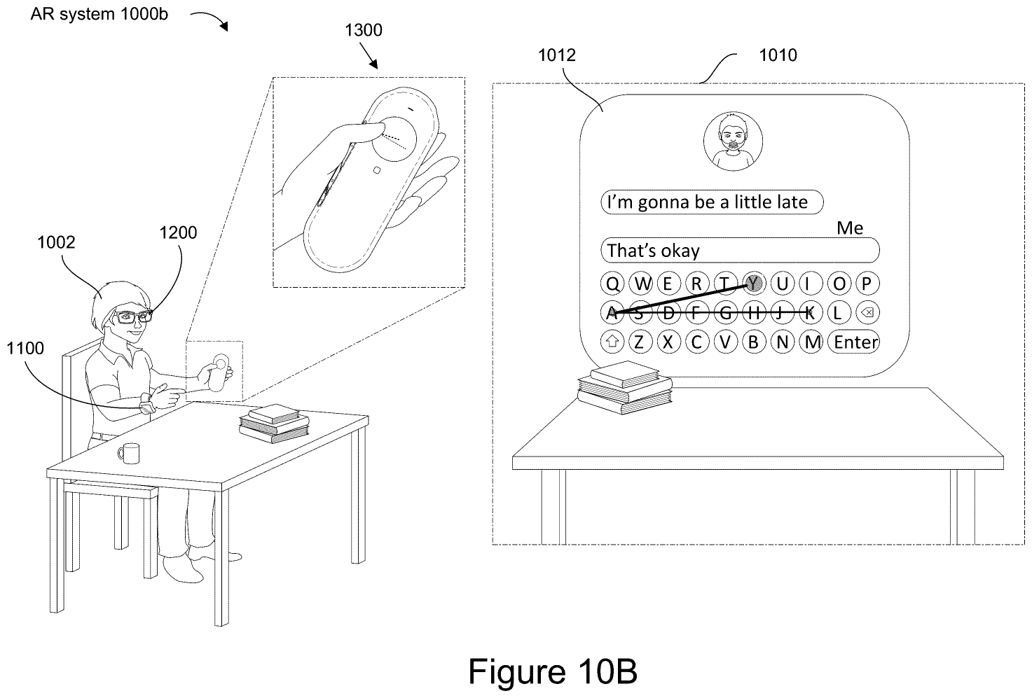

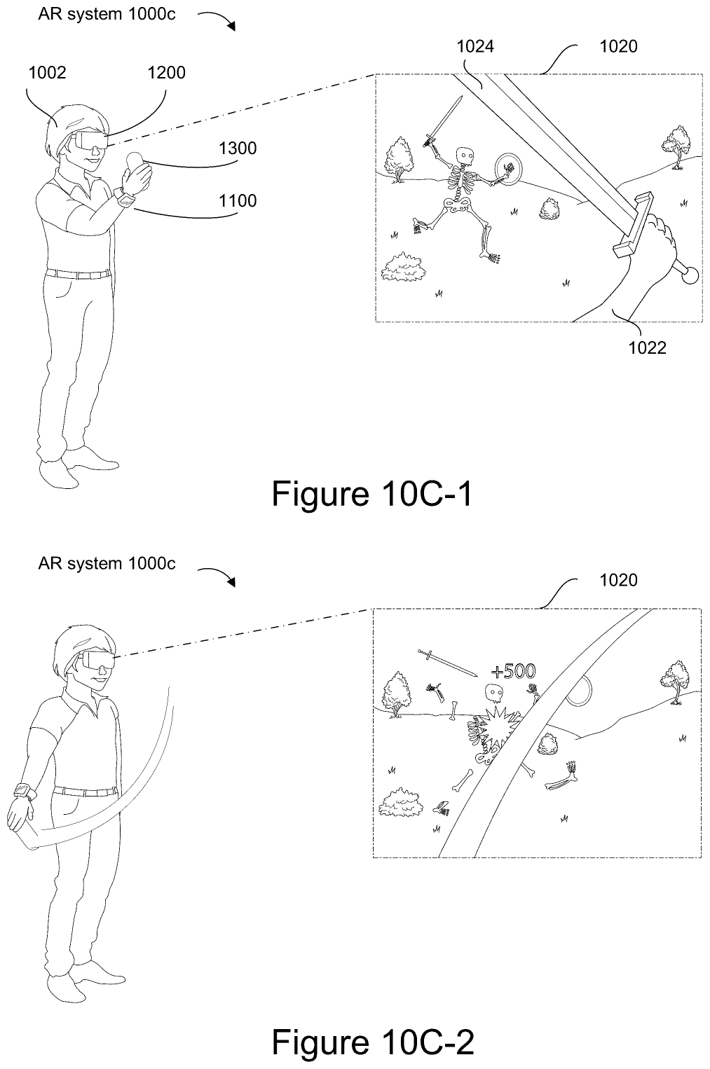

FIGS. 6A-6B illustrates a flow diagram of a method for the generation of a representation of a real-world scene and one or more digital twins, in accordance with some embodiments. Operations (e.g., steps) of the method 600 can be performed by one or more processors of an AR device 1200 (e.g., processors 1248, FIG. 12C). In some embodiments, the AR device 1200 is coupled with one or more sensors (e.g., various sensors discussed in reference to FIGS. 12A-12C), a display, a speaker, an image sensor (e.g., imaging device(s) or cameras 1239; FIGS. 12A-12C), and a microphone to perform the one or more operations of the method 600. At least some of the operations shown in FIGS. 6A and 6B correspond to instructions stored in a computer memory or computer-readable storage medium (e.g., storage, ram, and/or memory, FIGS. 12A-12C). Operations of the method 600 can be performed by the AR device 1200 alone or in conjunction with one or more processors and/or hardware components of another device communicatively coupled to the AR device 1200 (e.g., a wrist-wearable device 1100, a handheld intermediary processing device 1300, a smartphone, a laptop, a tablet, and/or other devices descried below in reference to FIGS. 10A-10C-2) and/or instructions stored in memory or computer-readable medium of the other device communicatively coupled to the AR device 1200.

In FIG. 6A, the method 600 includes receiving (602) image data of a real-world scene including one or more real-world objects. The image data can be received via one or more imaging devices of the AR device 1200 and/or imaging devices of another imaging device communicatively coupled with the AR device 1200. In some embodiments, the image data is captured while the method 600 is being performed. Alternatively, or additionally, in some embodiments, the image data is captured via a setup or enrollment phase. In some embodiments, a user is provided with instructions for capturing image data of a real-world scene. Examples of the instructions provided to a user for capturing image data of a real-world scene are provided above in reference to FIGS. 3A-3F.

The method 600 includes determining (604) whether a real-world object meets interaction criteria (also referred to as digital-interaction criteria). In particular, the image data of a real-world scene is processed to determine a real-world object with which a user can interact. In some embodiments, a real-world object is determined to meet the digital-interaction criteria based on a machine learning model determining that the real-world object is interactable. For example, the machine learning model can be a classifier and a classification of a real-world object can be used to determine that the real-world object is interactable (e.g., the real-world object can be classified as a cup, book, table, wall, etc., and the properties (e.g., moveable, unmovable, etc.) of the classified object can be used to determine if the real-world object is interactable). Any machine learning model can be used to determine that the real-world object is interactable, such as a supervised learning model, unsupervised learning model, semi-supervised learning model, reinforced learning model, etc. In some embodiments, the digital-interaction criteria can include one or more of (i) structure of the real-world object, (ii) function of the real-world object, (iii) appearance of the real-world object, (iv) pose of the real-world object, (v) physical characteristics of the real-world object, etc. The digital-interaction criteria is discussed above in reference to FIG. 1A.

In accordance with a determination that a real-world object does not meet the interaction criteria (“No” at operation 604), the method 600 proceeds to operation 612 and presents, via the artificial-reality headset, a representation of a real-world scene as discussed below. Alternatively, in accordance with a determination that a real-world object does meet the interaction criteria (“Yes” at operation 604), the method 600 includes generating (606) a digital twin corresponding to the real-world object. A digital twin is an interactive digital object configured to visually resemble a real-world object. Additionally, the digital twin is associated with semantic information such that the digital twin includes the real-world object's pose, shape, and state, as well as structural, functional, and other scene-related aspects. Examples of digital twins are shown and described above in reference to FIGS. 1A-4J (e.g., the chair digital twin 102b shown in FIGS. 1A-1V).

In some embodiments, the method 600 includes generating (608) a user-interface elements for interacting with the digital twin or the real-world object. This allows the user to move a focus selector to identify the digital twin or the real-world object with which they would like to interact before performing an action. The focus selectors are shown and described above in reference to FIGS. 1A-1V.

The method 600 further includes determining (610) whether there are additional real-world objects. In accordance with a determination that there are additional real-world objects (“Yes” at operation 610), the method 600 returns to operation 604 determines whether there is real-world object of the additional real-world objects that meets the interaction criteria. The method 600 performs the operations 604 through 610 for each additional real-world object. In some embodiments, additional iterations of the operations 604 through 610 can be performed based on a determination that a user is attempting to interact with a real-world object for which no digital twin has been generated.

In accordance with a determination that there are no additional real-world objects (“No” at operation 610), the method 600 includes presenting (612), via an artificial-reality headset, a representation of a real-world scene. The representation of the real-world scene can include one or more real-world objects and digital twins corresponding to the real-world objects. The user can interact with the different real-world objects and/or digital twins and the method 600 includes one or more operations to maintain scene responsiveness, scene awareness, and visual coherence as discussed below, as well as above in reference to FIGS. 1A-4J. Additionally, or alternatively, in some embodiments, the method 600 returns to the operation 602 and awaits to any updates to the real-world scene based on the image data.

Turning to FIG. 6B, the method 600 includes detecting (614) user interaction with a real-world object or a digital twin corresponding to the real-world object within the representation of a real-world scene. Responsive to detection of a user interaction with a real-world object or a digital twin, the method 600 includes replacing (616) the real-world object with a digital twin corresponding to the real-world. As discussed above in reference to FIGS. 1A-IV, the transition from a real-world object to a corresponding digital twin (e.g., the transition from the real-world object 102a to the chair digital twin 102b) is transparent to the user (e.g., there is no visually-perceptible indication provided to the user 103 that the representation of the real-world object 102a has transitioned to the chair digital twin 102b). In some embodiments, the real-world object is presented to the user until a user interaction selecting the real-world object is detected, at which point the real-world object is replaced with a corresponding digital twin. In this way, the user is presented with real-world objects until an interaction is performed, which reduces the battery consumption and overall processing of the AR device 1200 and/or communicatively coupled devices (e.g., rendering changes to a digital twin when user input is detected).

The method 600 includes modifying (618) the digital twin corresponding to the real-world object based on the user interaction. The user can modify the digital twin's pose, shape, and state. The user's modifications to the digital twin maintain scene are responsiveness and awareness. For example, the digital twin will continue to impact different surfaces and/or interact with other real-world objects (or corresponding digital twins). Examples of changes to digital twins based on user interactions are described above in reference to, for example, FIGS. 1A-2D.

The method 600 includes also determining (620) whether there are any visual inconsistencies between the real-world scene and the representation of the real-world scene that is presented to the user within the artificial-reality environment. In accordance with a determination that there are no visual inconsistencies (“No” at operation 620), the method 600 proceeds to operation 624 and presents, via the artificial-reality headset, a modified digital twin and/or a modified representation of the real-world scene.

Alternatively, in accordance with a determination that there are visual inconsistencies (“Yes” at operation 620), the method 600 includes modifying (622) the representation of the real-world scene to maintain visual coherence. In particular, the method 600 includes determining whether there are any changes to the representation of the real-world scene and modifies the representation of the real-world scene to address one or more inconsistencies. For example, if a real-world object is moved (e.g., via the corresponding digital twin), the representation of the real-world scene is modified to camouflage the original location of the real-world object. Similarly, if a digital twin is caused to interact with another digital twin or real-world object, the representation of the real-world scene is modified to be consistent (e.g., if a chair digital twin is thrown across a room and hits vase in the representation of the real-world scene, the vase will be knocked down and the representation of the real-world scene will be modified to be consistent). Additional examples of the modifications to the representation of the real-world scene are shown and described above in reference to FIGS. 1A-4J.

The method 600 further includes presenting (624), via the artificial-reality headset, a modified digital twin and/or a modified representation of the real-world scene. In other words, a user is presented with changes to a digital twin caused by their input, as well as changes to the representation of the real-world scene caused by the user's interaction with the digital twin, if any. The method 600 returns to operation 602 and awaits to any updates to the real-world scene based on the image data.

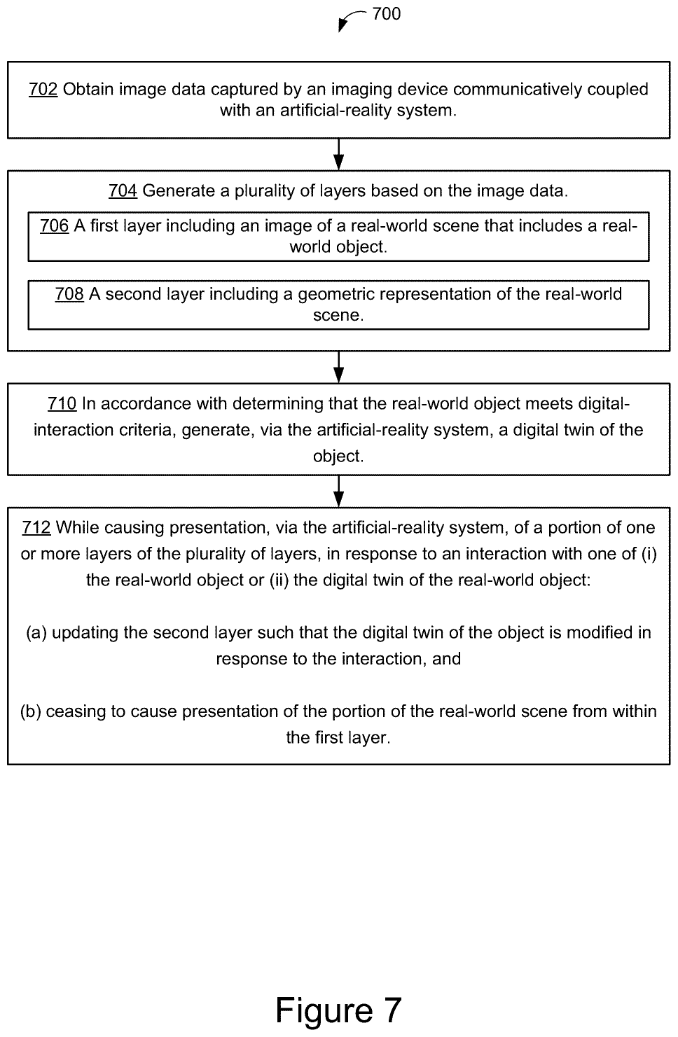

FIG. 7 shows an example method 700 for presenting a visual representation of a real-world scene within an artificial-reality environment, in accordance with some embodiments. In some embodiments, the artificial-reality environment can be presented by a head-wearable device that includes some or all components of the AR devices 1200 and/or the VR devices 1210. In some embodiments, one or more operations from the method 700 can be performed in conjunction with one or more operations from one or more of the methods 600, 800, and/or 900.

The method 700 includes obtaining (702) image data captured by an imaging device communicatively coupled with an artificial-reality system (e.g., the artificial-reality system used to present the artificial-reality environments shown in FIGS. 1A-IV). In some embodiments, a scanning user interface (e.g., the scanning user interface 302) is provided via an artificial-reality headset and/or another electronic device that is in communication with, and/or capable of forming an electronic communication with, the artificial-reality headset. For example, in accordance with some embodiments, a scanning user interface can be provided at a user's mobile device, and after the user has obtained image data via the mobile device, the user can provide the obtained image data to the artificial-reality headset (e.g., via non-transitory computer-readable storage media, via a remote server, etc.).

The method 700 includes generating (704) a plurality of layers based on the image data (e.g., two or more of the layers 322, 324, and 326 shown in FIG. 3G). In some embodiments, more or less than all the layers shown in FIG. 3G are generated in order to present a representation of the real-world scene to the user. Further, in some embodiments, different layers of a plurality of available layers are used based on a type of interaction that the user is performing with a particular portion of the representation of the real-world scene.

The plurality of layers includes (706) a first layer (e.g., an image layer, a photometric layer, or passthrough layer that includes corresponding colors for a plurality of respective locations) including an image of a real-world scene (e.g., a background) that includes a real-world object (e.g., a physical object within the physical scene, such as a chair). The plurality of layers includes (708) a second layer (e.g., a geometric layer, a physics layer, a first characterization of the physical scene (e.g., a first semantic layer)) including a geometric representation of the real-world scene.

The method 700 includes, in accordance with determining (710) that the real-world object meets digital interaction criteria, generating, via the artificial-reality system, a digital twin of the real-world object (e.g., an interactive digital object configured to visually resemble a real-world object). In some embodiments, digital-interaction criteria are determined to be met (e.g., satisfied) based on, for example, an artificial-intelligence model configured to classify real-world objects as interactable and/or detect pre-tagged interactivity. As discussed with respect to FIG. 1A, digital-interaction criteria can include, for example, a structure of the real-world object (which can be represented, in part, by the geometric layer 322 shown in FIG. 3G), as well as other aspects of the real-world object identified via image data obtained about the real-world scene.

The method 700 includes, while causing presentation (712), via the artificial-reality system, of a portion of one or more layers of the plurality of layers, in response to an interaction with one of (i) the real-world object or (ii) the digital twin of the real-world object: (a) updating the second layer to create an updated second layer such that the digital twin of the real-world object is modified in response to the interaction, and (b) ceasing to causing presentation of the portion of the real-world scene from within the first layer. In some embodiments, the interaction can be a user's interaction with the object or with the digital twin and can also be a virtual object's (e.g., a virtual character, such as a digitally-generated assistant) interaction with the digital twin.

One of ordinary skill in the art will appreciate that the first and second layer can in fact be represented in software as a singular object as defined by software. In some embodiments, the first and second layers can be separately represented in software and/or hardware of the artificial-reality system. However, the first and second layers can be merely a semantic construct not meant to be literally analogous to all possible implementations of the embodiments described herein. In some implementations, a plurality of layers can be represented in, for example, software being executed based on instructions stored in a non-transitory computer-readable storage medium, as a single layer (e.g., a single variable and/or software object). The present disclosure contemplates embodiments where such a single layer would include information about an image of a real-world scene, and information about a geometric representation of a real-world scene.

(A2) In some embodiments of A1, the real-world scene includes another real-world object. The method 700 further includes, in accordance with determining the other real-world object meets the digital-interaction criteria, generating, by the artificial-reality system, another digital twin of the other real-world object. And the method 700 further includes, while causing presentation, via the artificial-reality system, of the portion of the one or more layers of the plurality of layers, in response to another interaction with one of (i) the other real-world object, or (ii) the other digital twin of the other real-world object: (a) updating the second layer to create another updated second layer such that the other digital twin of the other real-world object is modified in response to the other interaction, and (b) ceasing to cause presentation of another portion of the real-world scene from within the first layer. In other words, the operations are caused in response to the user causing performance of a command recognized by the artificial-reality system, or a physical interaction with the real-world object (e.g., picking up the real-world object).

(A3) In some embodiments of A2, the method 700 includes detecting the interaction at a first point in time. And the method 700 includes, while causing presentation, via the artificial-reality system, of an updated portion of one or more layers of the plurality of layers including the updated second layer, in response to detecting the other interaction at a second point in time, updating the updated second layer to create a subsequent updated second layer such that the other digital twin of the other real-world object is modified in response to the other interaction.

(A4) In some embodiments of A2-A3, the real-world object is a portion, less than all of the other real-world object (e.g., a book on a bookshelf). And the object meets different digital-interaction criteria than the other object, such that the object is responsive to a different set of interactions than the other object. For example, the user can be able to perform a force grab gesture on the book to interact with the digital twin of the book, but cannot cause the digital twin of the bookshelf with the same gesture, in accordance with some embodiments.

(A5) In some embodiments of A1-A4, the method includes determining a visually-responsive relationship (e.g., a locational mapping, a one-to-one correspondence) between the first and second layers of the plurality of layers such that (i) respective layers of the plurality of layers are indistinguishable (e.g., visually imperceptible, visually merged, visually coherent) to a user of the artificial-reality system while the user is viewing the plurality of layers and (ii) interactions by the user with the real-world object or the digital twin of the real-world object are interconnected ((e.g., the first and second layers). For example, a user interaction with a digital twin of a real-world object can affect the first layer, even if the digital twin of the physical object is generated in the second layer, and a user interaction with a physical object can affect the second layer, even if the representation of the physical object is in the second layer.).

(A6) In some embodiments of A5, determining the visually-responsive relationship includes applying the geometric representation of the real-world scene of the second layer related to the image of the real-world scene of the first layer to allow for generation of the digital twin of the real-world object. For example, the visually-responsive relationship can be achieved by a combination of factors that includes, geometrically coherent world-locked rendering, and occlusion, and physically coherent lighting, gravity, and collision via a geometric 3D environment representation and six-degree-of-freedom device tracking.

(A7) In some embodiments of A6, the method 700 includes, in accordance with determining that a different portion of the real-world scene is occluded based on the updated the second layer in response to the interaction (e.g., based on the information in the second layer that is not coherent with information in the first layer), causing presentation of a portion of the updated second layer in place of the different portion of the real-world scene.

(A8) In some embodiments of A7, the portion of the updated second layer is a camouflage layer based on the visually-responsive relationship between the first and second layers, wherein the camouflage layer is a modification of a portion of the second layer such that the modification of the portion of the second layer replaces the representation the different portion of the real-world scene. For example, the camouflage layer can include a modified lighting for the portion of the geometric representation corresponding to a location where the real-world object was located in the real-world scene. In other words, lighting of the representation of the real-world scene can include modifications to the real-world light of the physical scene based on merging the modifications caused by interactions with digital twins of real-world objects in the real-world scene.

(A9) In some embodiments of A5-A8, the interaction at the real-world object or the digital twin of the real-world object being interconnected includes causing a modification to the second layer to account for the real-world scene of the first layer, based on the interaction such that a change between the second layer and the first layer is visually transparent (e.g., visually imperceptible in conjunction with viewing the plurality of layers, in accordance with a user interaction with the artificial-reality system, and/or interaction with via a component of the artificial-reality environment (e.g., a virtual character, such a digitally-generated assistant within the representation of the real-world scene)).

(A10) In some embodiments of A1-A9, the plurality of layers includes a third layer (e.g., a semantic layer). In some embodiments, the third layer includes one or more affordances (e.g., user interface elements corresponding to physics rules, which can be represented as interactive visual affordances) based on the real-world scene, the third layer defining a user-interface element for interacting with the real-world object or the digital twin of the real-world object. For example, the semantic layer can identify the floor and/or one or more walls of the physical scene (e.g., the object affordances 328 shown in FIG. 3G), and apply semantic rules regarding the physics of interactions between objects and the identified floor and walls, such that the interactions of geometric representations of objects with the geometric representations of the physical scene are adjusted based on the predefined rules applied by the semantic layer.

In some embodiments of A10, the one or more affordances include at least one character affordance configured to define how to situate an animation within the real-world scene, and the one or more affordances includes at least one receptive affordance configured to define a change in state of a real-world object being modified within the representation of the real-world environment. In some embodiments, two or more affordances can include distinct visual elements to distinguish their function within the artificial-reality environment (e.g., blue 418 and brown 415 indications of affordances in FIGS. 4C-4D).

(A11) In some embodiments of A10, the third layer is spatially annotated to the first and second layers. For example, the semantic layer 326 shown in FIG. 3G includes spatial annotation of object affordances 328 corresponding to real-world objects meeting digital-interaction criteria, and navigational affordances 330 indicating surfaces for navigating within the representation of the real-world scene illustrated in FIG. 3G.

(A12) In some embodiments of A10-A11, the one or more affordances are configured to provide structural scene understanding, functional scene understanding, and/or scene-related understanding between the first and second layers. For example, a navigational affordance can be generated based on an identified floor within the geometric representation of the physical scene, where the navigational affordance allows the user to move within the geometric representation of the physical scene. In some embodiments, the digital twin of the real-world object in the updated second layer is also modified based on semantic information of the third layer.

(A13) In some embodiments of A12, generating the plurality of layers includes: (i) prompting the user to capture image data via the imaging device communicatively coupled with the artificial-reality system, (ii) while the imaging device is active, providing instructions to the user for capturing image data of their real-world environment that defines the real-world scene, and (iii) in accordance with a determination that the image data captured by the user meets artificial-reality immersion criteria prompting the user to cease capturing image data. In some embodiments, the user is prompted to scan a room or a building to be used by the artificial-reality system. In some embodiments, in accordance with a determination that the captured image data is incomplete and/or insufficient (e.g., to present a representation of the real-world scene to the user and/or generate digital twins of one or more real-world objects within the real-world scene), the artificial-reality system is configured to request the user to provide additional image data to capture the missing image data or additional image data to meet minimum interactivity criteria. In some embodiments, indicators can be presented to the user to indicating one or more walls and/or other features to scan within the real-world scene. In some embodiments, after imaging data has been collected via the scanned image data, the method further includes obtaining mesh reconstruction via RGBD photogrammetry. For example, the scanning sequence shown in FIGS. 3A-3F includes various indications (e.g., the progress indicator user interface element 306), affordances (e.g., the mapping indicator user interface elements 308, 310, and 312), and prompts (e.g., the prompt shown in FIG. 3F indicating that scanning of the real-world scene is sufficient to generate a representation of the real-world scene) related to the progress of the user in obtaining, via the scanning, imaging data for generating a representation of the real-world scene within an artificial-reality environment.

(A14) In some embodiments of any of A1-A13, determining that the real-world object meets the digital-interaction criteria is based on a comparison of the first and second layers. For example, the determination that a real-world object meets digital-interaction criteria may be based on aspects of a real-world object identified in the photometric layer 324 shown in FIG. 3G being represented by at least one corresponding aspect in the geometric layer 322 and/or the semantic layer 326.

(A15) In some embodiments of any of A1-A14: (i) the real-world object includes a two-dimensional screen (e.g., a television, a laptop, etc.), and (ii) in addition (and/or alternatively) to the digital twin of the real-world object, a screen user-interface element is presented at a location corresponding to the two-dimensional screen of the real-world object. For example, a real-world television may be represented by the digital twin as a screen user-interface element (e.g., a home screen user-interface element). In some embodiments, the generating of the plurality of layers further includes generating a neural radiance field (e.g., a NeRF model that includes one or more neural graphics primitives) of at least a portion of the real-world scene.

In other words, once the respective layers of the plurality of the plurality of layers have the visually-responsive relationship (e.g., are interconnected), the user's interactions with the geometric representation will be reflected in the image layer (in addition to the mesh layer), and adjustments to other objects in the image layer detected by obtaining new image data, are reflected in the mesh layer, so that each respective adjustment to either layer is indistinguishable to the user of the virtual-reality headset. For example, a change in lighting detected by new image data can change the visual appearance of a geometric representation of an object (e.g., a chair) that the user has begun interacting with via the AR environment.

In some embodiments of any of A1-A15, a user can perform a user command to cause a portion of the representation of the real-world scene can be replaced (e.g., overlayed) by image data of the real-world scene (e.g., real-time image data), as shown in FIG. 4E. In some embodiments, the user can perform an operation to toggle between showing the representation of the real-world scene and the real-time image data of the real-world scene. In some embodiments, the image data can be displayed within a reality-viewer window, that the user can move around within the representation of the real-world scene to cause different portions of the representation of the real-world scene to be replaced by the real-time image data.

In some embodiments of any of A1-A15, after a digital twin of a real-world object has been moved within the representation of the real-world scene, in accordance with detecting that the user is within a threshold proximity of the real-world object (corresponding to the digital twin that has been displaced), a guardian boundary indication can be presented to the user to indicate the presence of the real-world object (as shown in FIG. 4F).

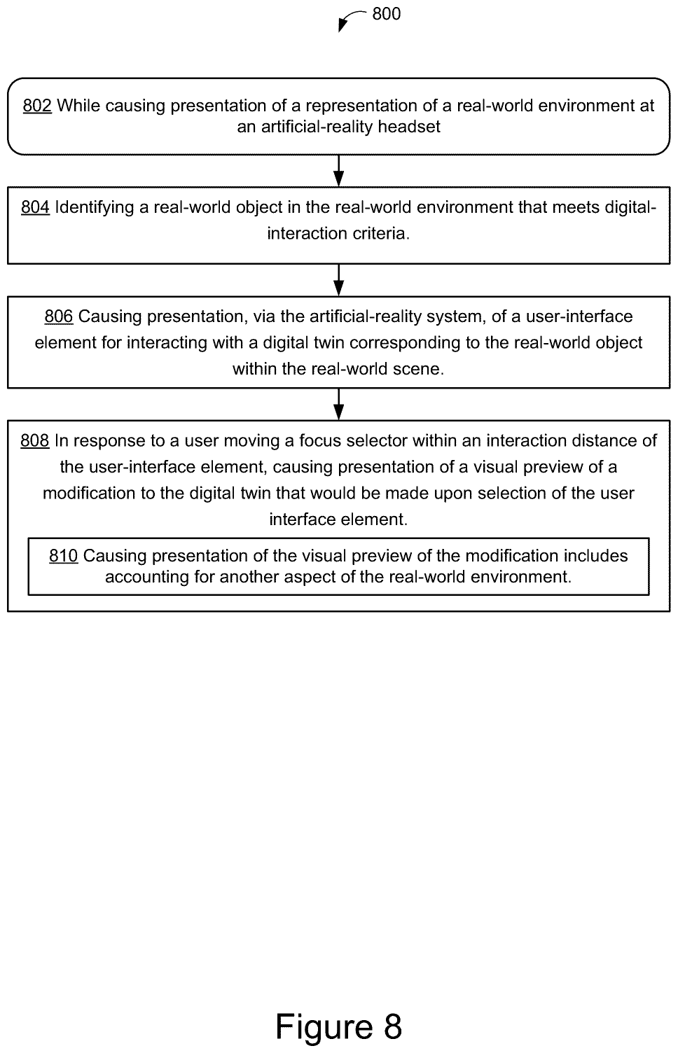

(B1) FIG. 8 shows an example method for presenting visual previews of modifications that would be caused by an interaction with a digital twin of a real-world object in the user's real-world scene, in accordance with some embodiments.

The method 800 includes one or more operations that are configured to occur while causing (802) presentation of a representation of a real-world environment at an artificial-reality headset (e.g., the AR device 1200 and/or the VR devices 1210 shown in FIGS. 12A-12C).

The method 800 includes identifying (804) a real-world object (e.g., a physical object) in the real-world environment that meets digital-interaction criteria (e.g., the real-world object 102a in FIGS. 1A-1V).

The method 800 includes causing (806) presentation, via the artificial-reality system, of a user-interface element (e.g., an affordance) for interacting with a digital twin corresponding to the real-world object within the real-world scene (e.g., an indication that the one or more objects can be interacted with within the artificial-reality environment, separately from the physical environment). In some embodiments, the digital twin is a visually-similar representation of the real-world object (e.g., a mesh reconstruction of the real-world object). In some embodiments, the digital twin includes one or more interactive properties that are based on one or more identified aspects of the real-world object (e.g., the size of the object).

The method 800 includes, in response to (808) a user moving a focus selector within an interaction distance of the user-interface element, causing presentation of a visual preview of a modification to the digital twin that would be made upon selection of the user-interface element. In some embodiments, the visual preview can be dynamically updated while the interaction is performed within the artificial-reality environment, as shown in FIGS. 1G-1P.

Causing presentation of the visual preview of the modification includes (810) accounting for another aspect of the real-world environment, distinct from the real-world object (e.g., a navigable area within the real-world scene, which may be spatially annotated in at least one layer used to present the representation of the real-world scene, as discussed with respect to FIG. 3G).

(B2) In some embodiments of B1, the visual preview of the modification to the digital twin includes semantic information (e.g., an affordance of a semantic layer generated for the real-world scene) associated with another real-world object in the real-world scene. For example, the visual preview can include an indication that the real-world object will be moved along a navigable portion of the floor of the real-world scene, and/or around a wall in the real-world scene. For example, the visual preview of the animation of the digitally-generated assistant 110 in FIGS. 1G-1H indicates a path that the digitally-generated assistant will travel along a navigable area of the real-world scene.

(B3) In some embodiments of B2, the visual preview of the modification includes an intermediate position of the digital twin based on semantic information associated with the real-world scene (e.g., a navigable (e.g., “walkable”) area). For example, the visual preview shown in FIG. 1H includes the intermediary pathing 112a, indicating an intermediate position of the digitally-generated assistant 110, which can be based on semantic information associated with the real-world scene, in accordance with some embodiments.

(B4) In some embodiments of any of B1-B3, the user-interface element for interacting with the digital twin is associated with an assistant interaction performed by a digitally-generated assistant. And the method 800 includes: (i) in response to a user input selecting the user-interface element for interacting with the digital twin (e.g., a virtual character, an animated virtual object), determining the assistant interaction based on the user input, the assistant interact accounting for the other aspect of the real-world environment, and (ii) causing the digitally-generated assistant to perform the assistant interaction including the modification to the digital twin.

(B5) In some embodiments of B4, the method 800 includes determining an assistant pathing based on the user input that accounts for the other aspect of the real-world environment. And the method includes causing the digitally-generated assistant to perform the assistant pathing as the digitally-generated assistant navigates to the digital twin. In some embodiments, a plurality of pathing options (which can be visually represented by a plurality of pathing indicators) can be generated for a particular interaction (e.g., the plurality of pathing indicators 454a to 454g), and a particular pathing of the plurality of pathings can be selected by a user and/or automatically determined based on pathing selection criteria.

(B6) In some embodiments of B5, causing the digitally-generated assistant to perform the assistant pathing includes causing the digitally-generated assistant to interact with another digital twin corresponding to another real-world object within the real-world scene that (i) meets the digital-interaction criteria, and (ii) is within the assistant pathing. In some embodiments, a digitally-generated assistant can cause a digital twin of a real-world object to be generated in accordance with performance of a pathing and/or interaction performed by the digitally-generated assistant. For example, the virtual character 404 causes the digital twin 406b to be generated based on the real-world object 406a based on the interaction being performed by the virtual character 404.

(B7) In some embodiments of B3-B6, the assistant interaction is performed in accordance with a determination that the digitally-generated assistant is adjacent to the digital twin. For example, as the digitally-generated assistant is approaching an interaction target, another real-world object may be located at a position along an unimpeded pathing of the digitally-generated assistant within the representation of the real-world scene. And the digitally-generated assistant can be configured to recognize one or more semantic properties of the other real-world object, such that the digitally-generated assistant performs an interaction related to the other real-world object. For example, the assistant pathing 106 for the digitally-generated assistant 110 can be generated based on the location of the real-world object 102a and/or the chair digital twin 102b.

(B8) In some embodiments of B3-B7, the modification of the digital twin includes one or more of: (i) adjusting a pose (e.g., a position and/or an orientation) of the digital twin, (ii) adjusting a structure of the digital twin (e.g., opening a book), (iii) adjusting functionality of the digital twin (e.g., the chair when lifted can no longer be used as a chair while lifted), (iv) adjusting visual coherence of the digital twin (e.g., occlusion), and (v) adjusting visual coherence of the representation of the real-world scene presented by the artificial-reality system. For example, a modification of the chair digital twin 102b discussed with respect to FIGS. 1A-1V can include any of the aforementioned operations, which can include adjustments to layers of the representation of the real-world scene 100 corresponding to any of the layers shown in FIGS. 3G-3M (e.g., the geometric layer 322, the photometric layer 324, and/or the semantic layer 326).

In some embodiments, updating the at least one layer of the plurality of layers includes ceasing to cause presentation of the real-world object in another layer of the plurality of layers. For example, if a digital twin of a real-world object no longer represents any locational properties of the real-world object, then a representation of the real-world object can be removed from a photometric layer of a plurality of layers that are being used to form the artificial-reality environment.

In some embodiments, the representation of the real-world environment is formed via a plurality of layers based on image data, the visual preview of a modification to the digital twin that would be made upon selection of the user-interface element is presented while the real-world object is visually represented in a first layer of the plurality of layers, and in response to the user performing an input to cause the modification: (i) generating a digital twin of the real-world object in a second layer of the plurality of layers, and (ii) ceasing to cause presentation of the real-world object within the first layer of the plurality of layers. In other words, the preview of the interaction can be presented before the digital twin of the real-world object has been generated, based on a determination that the real-world object meets digital interaction criteria for causing the modification for which the preview is shown.

In some embodiments, the visual preview of the modification includes a second digital twin at a second location, distinct from a first location of the real-world object within the real-world scene, and the second location corresponds to a real-world object that meets similarity criteria for the real-world object.

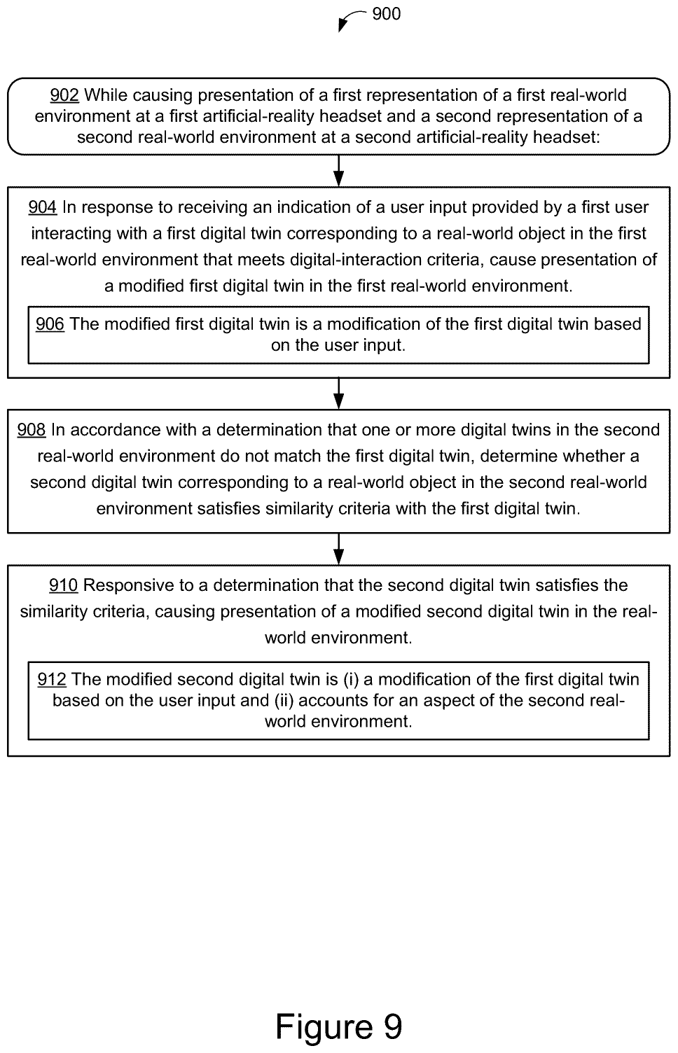

(C1) FIG. 9 shows an example method 900 for facilitating interactions, via artificial-reality environments, between different users in different real-world scenes (e.g., the first and second users 201 and 251 shown in FIGS. 2A-2D), in accordance with some embodiments. In some embodiments, the operations are performed as part of providing a shared artificial-reality interaction (e.g., a cooperative activity) between the users. In some embodiments, the shared artificial-reality activity is presented at each of the users' respective artificial-reality headsets (e.g., the first and second artificial-reality headsets 202 and 252).

One or more of the operations of the method 900 are performed while a computing system (e.g., an artificial-reality headset and/or an intermediary device in electronic communication with an artificial-reality headset) is causing presentation (902) of a first real-world environment at a first artificial-reality headset and a second representation of a second real-world environment at a second artificial-reality headset. For example, in FIGS. 2A-2D, the first artificial-reality headset 202 is presenting a first representation of a real-world environment to the first user 201, and the artificial-reality headset 252 is presenting a second representation of a real-world environment to the second user 251. In some embodiments, the first artificial-reality headset is an augmented-reality system (e.g., augmented-reality glasses, such as AR device 1200 shown and described below in reference to FIGS. 12A-12C), and the second artificial-reality headset is a virtual-reality system (e.g., the VR device 1210 shown and described below in reference to FIGS. 12A-12C).

The method 900 includes, in response to (904) receiving an indication of a user input provided by a first user interacting with a first digital twin corresponding to a real-world object in the first real-world environment that meets digital-interaction criteria, causing presentation of a modified first digital twin in the first real-world environment. In some embodiments, the modified first digital twin is (906) a modification of the first digital twin based on the user input. In some embodiments, the indication of the user input can further cause the digital twin of the of the real-world object to be generated before the digital twin is modified. For example, in accordance with the first user 201 performing the gesture 208 in FIG. 2B, a determination can be made whether a digital twin of the real-world object 204 has already been generated (e.g., the digital twin 214), in conjunction with causing the modification to the digital twin 214 in accordance with the gesture 208.

The method 900 includes, in accordance with a determination that no digital twins in the second real-world environment match the first digital twin, determining (908) whether a second digital twin corresponding to a real-world object in the second real-world environment satisfies similarity criteria with the first digital twin. For example, in accordance with a determination that no real-world objects in the real-world scene of the second user 251 correspond to the digital twin 214, the digital twin 264 of the real-world object 254 is generated in accordance with a determination that the real-world object meets similarity criteria of the digital twin 214.

The method 900 includes, responsive to a determination that the second digital twin satisfies the similarity criteria, causing (910) presentation of a modified second digital twin in the real-world environment (e.g., the digital twin 264 of the real-world object 254 in FIG. 2B). The modified second digital twin is (912): (i) a modification of the first digital twin based on the user input, and (ii) accounts for an aspect of the second real-world environment (e.g., the similarity criteria are met by the real-world object 254 in accordance with a determination that the table 256 has a surface similar to the surface of the desk 206).

(C2) In some embodiments of C1, the method 900 includes, in response to receiving another indication of a different user input provided by the first user interacting with a third digital twin corresponding to another real-world object in the first real-world environment that meets digital-interaction criteria: (i) causing presentation of a modified third digital twin in the first real-world environment, wherein the modified third digital twin is a modification of the third digital twin based on the user input, and (ii) in accordance with a determination that a fourth digital twin in the second real-world environment matches the third digital twin, modifying the fourth digital twin in the second real-world environment and causing presentation of the modified fourth digital twin in the second real-world environment. In other words, if there is a match between the first digital twin in the first-real world scene and the second real-world scene, then it may not be necessary to determine whether any similarity criteria are met with respect to the first digital twin and the second digital twin, in accordance with some embodiments. For example, the first and second users of the first and second artificial-reality headsets may be co-located in the same real-world scene, such that the first and second digital twins correspond to the same object in the real-world scene.

(C3) In some embodiments of any of C1-C2, the method 900 includes, in response to receiving another indication of a different user input provided by the first user interacting with a fifth digital twin corresponding to yet another real-world object in the first real-world environment that meets digital-interaction criteria: (a) causing presentation of a modified fifth digital twin in the first real-world environment, wherein the modified fifth digital twin is a modification of the fifth digital twin based on the user input, (b) in accordance with a determination that no digital twins in the second real-world environment match the fifth digital twin, determining whether a sixth digital twin corresponding to a real-world object in the second real-world environment satisfies similarity criteria with the fifth digital twin, and (c) responsive to a determination that the sixth digital twin does not meet the similarity criteria, generating a new digital twin in the second real-world environment, wherein the new digital twin (i) is generated based on the fifth digital twin in the first real-world environment and (ii) accounts for aspects of the second real-world environment. In other words, if there are no real-world objects or digital twins in the second real-world environment corresponding to the fifth digital twin in the first real-world environment, then the artificial-reality system can cause the fifth digital twin to be duplicated or otherwise proxied in the second real-world environment. For example, in accordance with the second user 251 performing the gesture 272 in FIG. 2D, the artificial-reality content 270 is generated in the representation of the real-world scene presented by the artificial-reality headset 252. And the artificial-reality content item 220 is generated in the representation of the real-world scene presented by the first artificial-reality headset 202 in accordance with a determination that there are no objects in the real-world scene corresponding the artificial-reality content 270.

(C4) In some embodiments of any of C2-C3, the method 900 includes, prior to modifying the fourth digital twin, the accounting for the aspect of the second real-world environment includes determining that the fourth digital twin meets situational criteria with respect to relative orientations (e.g., a correspondence between respective locations and orientations) of the second artificial-reality headset (e.g., the orientation of the user's head), and the fourth digital twin within the second real-world environment. In other words, even if there is a substantially identical real-world object in the second real-world environment, the artificial-reality system can still determine whether the second user's orientation relative to the substantially identical real-world object is similar enough to that of the first user's orientation to the third real-world object. For example, the real-world object 254 meeting similarity criteria of the digital twin 214 in FIG. 2B may be further based on the real-world object 254 being at a similar location within the field of view of the second user 251 to the digital twin 214 with respect to the field of view of the first user 201.

(C5) In some embodiments of any of C1-C4, the method 900 includes, in response to receiving an indication that a first digitally-generated assistant presented in the first real-world environment is performing an animated interaction with the first digital twin, causing a second digitally-generated assistant presented in the second real-world environment to perform another animated interaction with the second digital twin, wherein the other animated interaction is different than the animated interaction with the first digital twin (e.g., the digital twin 260 performs the animation sequence shown in FIGS. 2B-2C in accordance with the digitally-generated assistant 210 initiating the animating sequence in first artificial-reality environment presented to the first user 201). For example, a first digitally-generated assistant in the first real-world environment can perform an animated interaction to sit in a digital twin of a chair that is located to the left of the first user. And a second digitally-generated assistant in the second real-world environment can perform a corresponding animated interaction to sit in a digital twin of a different chair that is located to the right of the second user in the second real-world environment.

In some embodiments of any of C1-C5, the first and/or second user can be represented in the representation of the real-world scene of the other respective user as a virtual character. For example, in FIGS. 4H-4J, the remote user 496 is represented within the artificial-reality environment as the virtual character 494.

(D1) In some embodiments, an artificial-reality system is provided that is configured to perform one or more operations of any of A1-C5. In some embodiments, the artificial-reality system includes one or more of an artificial-reality headset (e.g., the AR device 1200 or the VR devices 1210 shown and described in reference to FIGS. 12A-12C, respectively), a wrist-wearable device (e.g., the wrist-wearable device 1100 shown in FIGS. 11A and 11B), and/or an intermediary device configured to process data and/or instructions (e.g., stored at one or more non-transitory computer-readable storage media) (e.g., the intermediary device discussed with respect to the system 1200 shown in FIGS. 12A-12B).

(E1) In some embodiments, an intermediary device is configured to coordinate operations of a head-wearable device and a wrist-wearable device. The intermediary device is configured to convey information between the head-wearable device and the wrist-wearable device in conjunction with performance of one or more operations of any of A1-C5.

(F1) In some embodiments, a system that includes one or more wrist-wearable devices and an artificial-reality headset is configured to cause performance of one or more operations of any of A1-C5.

(G1) In some embodiments, a non-transitory computer-readable storage medium is provided that includes instructions which, when executed by a computing device (e.g., an handheld intermediary processing device, a wrist-wearable device, or any other device described below in reference to FIG. 10A) in communication with an artificial-reality headset, cause the computing device to perform one or more operations of any of A1-C5.

(H1) In some embodiments, a method of operating an artificial-reality headset is provided that includes operations corresponding to any one of A1-C5.

(I1) In some embodiments, a means for performing or causing the performance of the operations corresponding to any one of A1-C5.

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device 1100, a head-wearable device, an HIPD 1300, a smart textile-based garment (not shown), or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) artificial-reality (AR) applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example AR Systems

FIGS. 10A-10C-2 illustrate example artificial-reality systems, in accordance with some embodiments. FIG. 10A shows a first AR system 1000a and first example user interactions using a wrist-wearable device 1100, a head-wearable device (e.g., AR device 1200), and/or a handheld intermediary processing device (HIPD) 1300. FIG. 10B shows a second AR system 1000b and second example user interactions using a wrist-wearable device 1100, AR device 1200, and/or an HIPD 1300. FIGS. 10C-1 and 10C-2 show a third AR system 1000c and third example user interactions using a wrist-wearable device 1100, a head-wearable device (e.g., virtual-reality (VR) device 1210), and/or an HIPD 1300. As the skilled artisan will appreciate upon reading the descriptions provided herein, the above-example AR systems (described in detail below) can perform various functions and/or operations described above with reference to FIGS. 1A-9.

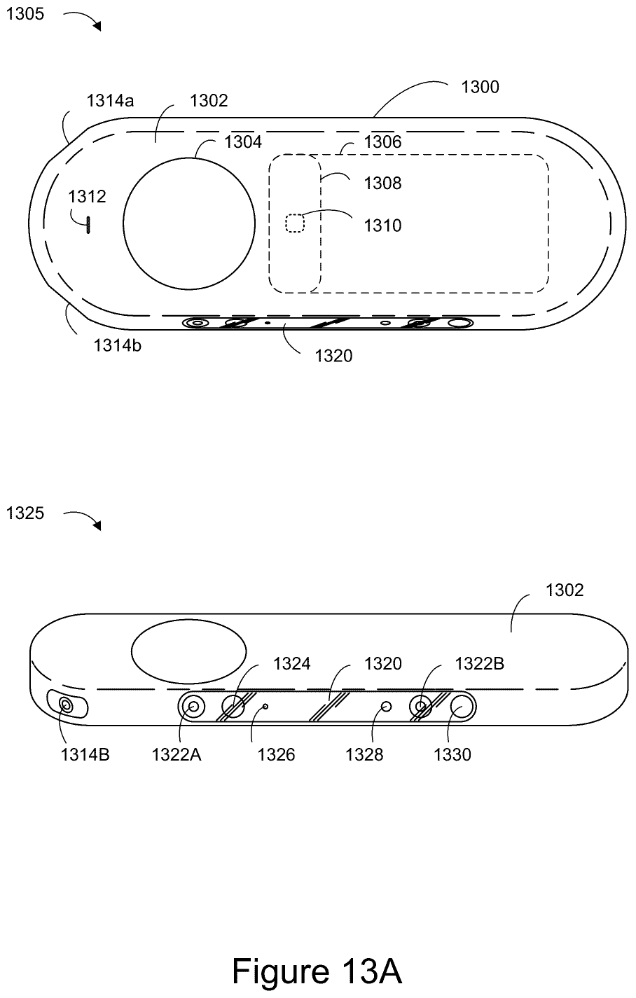

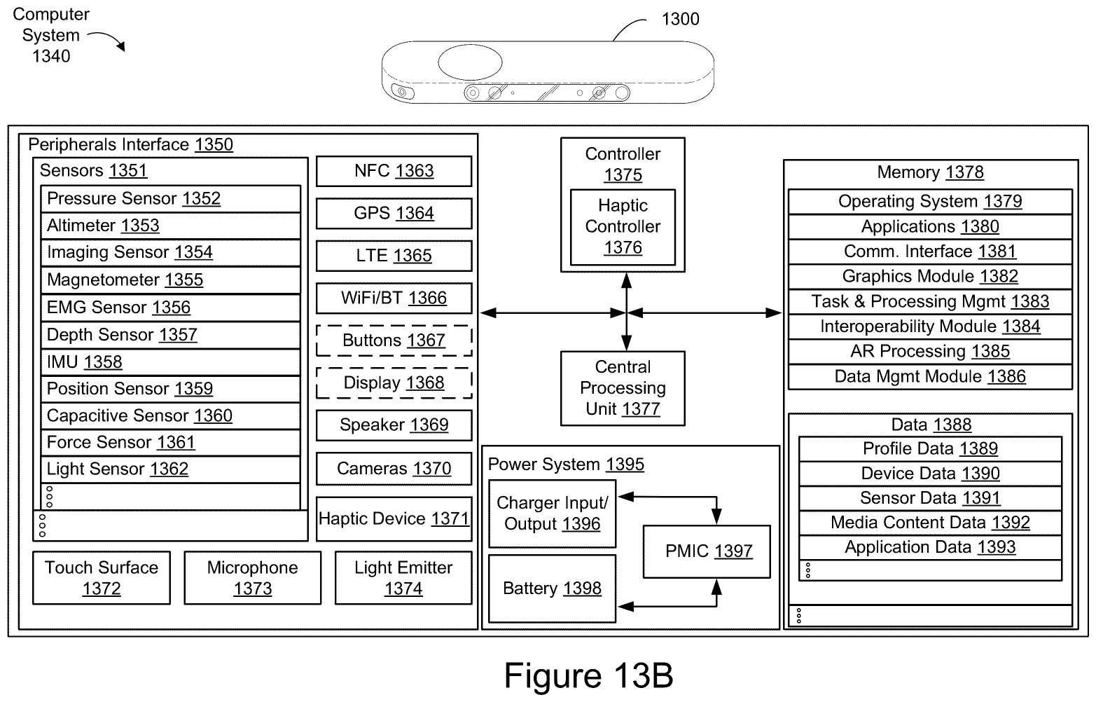

The wrist-wearable device 1100 and its constituent components are described below in reference to FIGS. 11A-11B, the head-wearable devices and their constituent components are described below in reference to FIGS. 12A-12D, and the HIPD 1300 and its constituent components are described below in reference to FIGS. 13A-13B. The wrist-wearable device 1100, the head-wearable devices, and/or the HIPD 1300 can communicatively couple via a network 1025 (e.g., cellular, near field, Wi-Fi, personal area network, wireless LAN, etc.). Additionally, the wrist-wearable device 1100, the head-wearable devices, and/or the HIPD 1300 can also communicatively couple with one or more servers 1030, computers 1040 (e.g., laptops, computers, etc.), mobile devices 1050 (e.g., smartphones, tablets, etc.), and/or other electronic devices via the network 1025 (e.g., cellular, near field, Wi-Fi, personal area network, wireless LAN, etc.)

Turning to FIG. 10A, a user 1002 is shown wearing the wrist-wearable device 1100 and the AR device 1200, and having the HIPD 1300 on their desk. The wrist-wearable device 1100, the AR device 1200, and the HIPD 1300 facilitate user interaction with an AR environment. In particular, as shown by the first AR system 1000a, the wrist-wearable device 1100, the AR device 1200, and/or the HIPD 1300 cause presentation of one or more avatars 1004, digital representations of contacts 1006, and virtual objects 1008. As discussed below, the user 1002 can interact with the one or more avatars 1004, digital representations of the contacts 1006, and virtual objects 1008 via the wrist-wearable device 1100, the AR device 1200, and/or the HIPD 1300.

The user 1002 can use any of the wrist-wearable device 1100, the AR device 1200, and/or the HIPD 1300 to provide user inputs. For example, the user 1002 can perform one or more hand gestures that are detected by the wrist-wearable device 1100 (e.g., using one or more EMG sensors and/or IMUs, described below in reference to FIGS. 11A-11B) and/or AR device 1200 (e.g., using one or more image sensors or cameras, described below in reference to FIGS. 12A-12B) to provide a user input. Alternatively, or additionally, the user 1002 can provide a user input via one or more touch surfaces of the wrist-wearable device 1100, the AR device 1200, and/or the HIPD 1300, and/or voice commands captured by a microphone of the wrist-wearable device 1100, the AR device 1200, and/or the HIPD 1300. In some embodiments, the wrist-wearable device 1100, the AR device 1200, and/or the HIPD 1300 include a digital assistant to help the user in providing a user input (e.g., completing a sequence of operations, suggesting different operations or commands, providing reminders, confirming a command). In some embodiments, the user 1002 can provide a user input via one or more facial gestures and/or facial expressions. For example, cameras of the wrist-wearable device 1100, the AR device 1200, and/or the HIPD 1300 can track the user 1002's eyes for navigating a user interface.

The wrist-wearable device 1100, the AR device 1200, and/or the HIPD 1300 can operate alone or in conjunction to allow the user 1002 to interact with the AR environment. In some embodiments, the HIPD 1300 is configured to operate as a central hub or control center for the wrist-wearable device 1100, the AR device 1200, and/or another communicatively coupled device. For example, the user 1002 can provide an input to interact with the AR environment at any of the wrist-wearable device 1100, the AR device 1200, and/or the HIPD 1300, and the HIPD 1300 can identify one or more back-end and front-end tasks to cause the performance of the requested interaction and distribute instructions to cause the performance of the one or more back-end and front-end tasks at the wrist-wearable device 1100, the AR device 1200, and/or the HIPD 1300. In some embodiments, a back-end task is a background-processing task that is not perceptible by the user (e.g., rendering content, decompression, compression, etc.), and a front-end task is a user-facing task that is perceptible to the user (e.g., presenting information to the user, providing feedback to the user, etc.)). As described below in reference to FIGS. 13A-13B, the HIPD 1300 can perform the back-end tasks and provide the wrist-wearable device 1100 and/or the AR device 1200 operational data corresponding to the performed back-end tasks such that the wrist-wearable device 1100 and/or the AR device 1200 can perform the front-end tasks. In this way, the HIPD 1300, which has more computational resources and greater thermal headroom than the wrist-wearable device 1100 and/or the AR device 1200, performs computationally intensive tasks and reduces the computer resource utilization and/or power usage of the wrist-wearable device 1100 and/or the AR device 1200.

In the example shown by the first AR system 1000a, the HIPD 1300 identifies one or more back-end tasks and front-end tasks associated with a user request to initiate an AR video call with one or more other users (represented by the avatar 1004 and the digital representation of the contact 1006) and distributes instructions to cause the performance of the one or more back-end tasks and front-end tasks. In particular, the HIPD 1300 performs back-end tasks for processing and/or rendering image data (and other data) associated with the AR video call and provides operational data associated with the performed back-end tasks to the AR device 1200 such that the AR device 1200 performs front-end tasks for presenting the AR video call (e.g., presenting the avatar 1004 and the digital representation of the contact 1006).

In some embodiments, the HIPD 1300 can operate as a focal or anchor point for causing the presentation of information. This allows the user 1002 to be generally aware of where information is presented. For example, as shown in the first AR system 1000a, the avatar 1004 and the digital representation of the contact 1006 are presented above the HIPD 1300. In particular, the HIPD 1300 and the AR device 1200 operate in conjunction to determine a location for presenting the avatar 1004 and the digital representation of the contact 1006. In some embodiments, information can be presented within a predetermined distance from the HIPD 1300 (e.g., within five meters). For example, as shown in the first AR system 1000a, virtual object 1008 is presented on the desk some distance from the HIPD 1300. Similar to the above example, the HIPD 1300 and the AR device 1200 can operate in conjunction to determine a location for presenting the virtual object 1008. Alternatively, in some embodiments, presentation of information is not bound by the HIPD 1300. More specifically, the avatar 1004, the digital representation of the contact 1006, and the virtual object 1008 do not have to be presented within a predetermined distance of the HIPD 1300.

User inputs provided at the wrist-wearable device 1100, the AR device 1200, and/or the HIPD 1300 are coordinated such that the user can use any device to initiate, continue, and/or complete an operation. For example, the user 1002 can provide a user input to the AR device 1200 to cause the AR device 1200 to present the virtual object 1008 and, while the virtual object 1008 is presented by the AR device 1200, the user 1002 can provide one or more hand gestures via the wrist-wearable device 1100 to interact and/or manipulate the virtual object 1008.

FIG. 10B shows the user 1002 wearing the wrist-wearable device 1100 and the AR device 1200, and holding the HIPD 1300. In the second AR system 1000b, the wrist-wearable device 1100, the AR device 1200, and/or the HIPD 1300 are used to receive and/or provide one or more messages to a contact of the user 1002. In particular, the wrist-wearable device 1100, the AR device 1200, and/or the HIPD 1300 detect and coordinate one or more user inputs to initiate a messaging application and prepare a response to a received message via the messaging application.

In some embodiments, the user 1002 initiates, via a user input, an application on the wrist-wearable device 1100, the AR device 1200, and/or the HIPD 1300 that causes the application to initiate on at least one device. For example, in the second AR system 1000b the user 1002 performs a hand gesture associated with a command for initiating a messaging application (represented by messaging user interface 1012); the wrist-wearable device 1100 detects the hand gesture; and, based on a determination that the user 1002 is wearing AR device 1200, causes the AR device 1200 to present a messaging user interface 1012 of the messaging application. The AR device 1200 can present the messaging user interface 1012 to the user 1002 via its display (e.g., as shown by user 1002's field of view 1010). In some embodiments, the application is initiated and can be run on the device (e.g., the wrist-wearable device 1100, the AR device 1200, and/or the HIPD 1300) that detects the user input to initiate the application, and the device provides another device operational data to cause the presentation of the messaging application. For example, the wrist-wearable device 1100 can detect the user input to initiate a messaging application, initiate and run the messaging application, and provide operational data to the AR device 1200 and/or the HIPD 1300 to cause presentation of the messaging application. Alternatively, the application can be initiated and run at a device other than the device that detected the user input. For example, the wrist-wearable device 1100 can detect the hand gesture associated with initiating the messaging application and cause the HIPD 1300 to run the messaging application and coordinate the presentation of the messaging application.

Further, the user 1002 can provide a user input provided at the wrist-wearable device 1100, the AR device 1200, and/or the HIPD 1300 to continue and/or complete an operation initiated at another device. For example, after initiating the messaging application via the wrist-wearable device 1100 and while the AR device 1200 presents the messaging user interface 1012, the user 1002 can provide an input at the HIPD 1300 to prepare a response (e.g., shown by the swipe gesture performed on the HIPD 1300). The user 1002's gestures performed on the HIPD 1300 can be provided and/or displayed on another device. For example, the user 1002's swipe gestures performed on the HIPD 1300 are displayed on a virtual keyboard of the messaging user interface 1012 displayed by the AR device 1200.

In some embodiments, the wrist-wearable device 1100, the AR device 1200, the HIPD 1300, and/or other communicatively coupled devices can present one or more notifications to the user 1002. The notification can be an indication of a new message, an incoming call, an application update, a status update, etc. The user 1002 can select the notification via the wrist-wearable device 1100, the AR device 1200, or the HIPD 1300 and cause presentation of an application or operation associated with the notification on at least one device. For example, the user 1002 can receive a notification that a message was received at the wrist-wearable device 1100, the AR device 1200, the HIPD 1300, and/or other communicatively coupled device and provide a user input at the wrist-wearable device 1100, the AR device 1200, and/or the HIPD 1300 to review the notification, and the device detecting the user input can cause an application associated with the notification to be initiated and/or presented at the wrist-wearable device 1100, the AR device 1200, and/or the HIPD 1300.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 1200 can present to the user 1002 game application data and the HIPD 1300 can use a controller to provide inputs to the game. Similarly, the user 1002 can use the wrist-wearable device 1100 to initiate a camera of the AR device 1200, and the user can use the wrist-wearable device 1100, the AR device 1200, and/or the HIPD 1300 to manipulate the image capture (e.g., zoom in or out, apply filters, etc.) and capture image data.

Turning to FIGS. 10C-1 and 10C-2, the user 1002 is shown wearing the wrist-wearable device 1100 and a VR device 1210, and holding the HIPD 1300. In the third AR system 1000c, the wrist-wearable device 1100, the VR device 1210, and/or the HIPD 1300 are used to interact within an AR environment, such as a VR game or other AR application. While the VR device 1210 present a representation of a VR game (e.g., first AR game environment 1020) to the user 1002, the wrist-wearable device 1100, the VR device 1210, and/or the HIPD 1300 detect and coordinate one or more user inputs to allow the user 1002 to interact with the VR game.

In some embodiments, the user 1002 can provide a user input via the wrist-wearable device 1100, the VR device 1210, and/or the HIPD 1300 that causes an action in a corresponding AR environment. For example, the user 1002 in the third AR system 1000c (shown in FIG. 10C-1) raises the HIPD 1300 to prepare for a swing in the first AR game environment 1020. The VR device 1210, responsive to the user 1002 raising the HIPD 1300, causes the AR representation of the user 1022 to perform a similar action (e.g., raise a virtual object, such as a virtual sword 1024). In some embodiments, each device uses respective sensor data and/or image data to detect the user input and provide an accurate representation of the user 1002's motion. For example, image sensors 1358 (e.g., SLAM cameras or other cameras discussed below in FIGS. 13A and 13B) of the HIPD 1300 can be used to detect a position of the 1300 relative to the user 1002's body such that the virtual object can be positioned appropriately within the first AR game environment 1020; sensor data from the wrist-wearable device 1100 can be used to detect a velocity at which the user 1002 raises the HIPD 1300 such that the AR representation of the user 1022 and the virtual sword 1024 are synchronized with the user 1002's movements; and image sensors 1226 (FIGS. 12A-12C) of the VR device 1210 can be used to represent the user 1002's body, boundary conditions, or real-world objects within the first AR game environment 1020.

In FIG. 10C-2, the user 1002 performs a downward swing while holding the HIPD 1300. The user 1002's downward swing is detected by the wrist-wearable device 1100, the VR device 1210, and/or the HIPD 1300 and a corresponding action is performed in the first AR game environment 1020. In some embodiments, the data captured by each device is used to improve the user's experience within the AR environment. For example, sensor data of the wrist-wearable device 1100 can be used to determine a speed and/or force at which the downward swing is performed and image sensors of the HIPD 1300 and/or the VR device 1210 can be used to determine a location of the swing and how it should be represented in the first AR game environment 1020, which, in turn, can be used as inputs for the AR environment (e.g., game mechanics, which can use detected speed, force, locations, and/or aspects of the user 1002's actions to classify a user's inputs (e.g., user performs a light strike, hard strike, critical strike, glancing strike, miss) or calculate an output (e.g., amount of damage)).

While the wrist-wearable device 1100, the VR device 1210, and/or the HIPD 1300 are described as detecting user inputs, in some embodiments, user inputs are detected at a single device (with the single device being responsible for distributing signals to the other devices for performing the user input). For example, the HIPD 1300 can operate an application for generating the first AR game environment 1020 and provide the VR device 1210 with corresponding data for causing the presentation of the first AR game environment 1020, as well as detect the 1002's movements (while holding the HIPD 1300) to cause the performance of corresponding actions within the first AR game environment 1020. Additionally or alternatively, in some embodiments, operational data (e.g., sensor data, image data, application data, device data, and/or other data) of one or more devices is provide to a single device (e.g., the HIPD 1300) to process the operational data and cause respective devices to perform an action associated with processed operational data.

Having discussed example AR systems, devices for interacting with such AR systems, and other computing systems more generally, will now be discussed in greater detail below. Some definitions of devices and components that can be included in some or all of the example devices discussed below are defined here for ease of reference. A skilled artisan will appreciate that certain types of the components described below may be more suitable for a particular set of devices, and less suitable for a different set of devices. But subsequent reference to the components defined here should be considered to be encompassed by the definitions provided.

In some embodiments discussed below example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

### Example Wrist-Wearable Devices

FIGS. 11A and 11B illustrate an example wrist-wearable device 1100, in accordance with some embodiments. The wrist-wearable device 1100 is an instance of the wearable device described in reference to 1A-9 herein, such that the wrist-wearable devices should be understood to have the features of the wrist-wearable device 1100 and vice versa. FIG. 11A illustrates components of the wrist-wearable device 1100, which can be used individually or in combination, including combinations that include other electronic devices and/or electronic components.

FIG. 11A shows a wearable band 1110 and a watch body 1120 (or capsule) being coupled, as discussed below, to form the wrist-wearable device 1100. The wrist-wearable device 1100 can perform various functions and/or operations associated with navigating through user interfaces and selectively opening applications, as well as the functions and/or operations described above with reference to FIGS. 1A-9.

As will be described in more detail below, operations executed by the wrist-wearable device 1100 can include (i) presenting content to a user (e.g., displaying visual content via a display 1105); (ii) detecting (e.g., sensing) user input (e.g., sensing a touch on peripheral button 1123 and/or at a touch screen of the display 1105, a hand gesture detected by sensors (e.g., biopotential sensors)); (iii) sensing biometric data via one or more sensors 1113 (e.g., neuromuscular signals, heart rate, temperature, sleep, etc.); messaging (e.g., text, speech, video, etc.); image capture via one or more imaging devices or cameras 1125; wireless communications (e.g., cellular, near field, Wi-Fi, personal area network, etc.); location determination; financial transactions; providing haptic feedback; alarms; notifications; biometric authentication; health monitoring; sleep monitoring.

The above-example functions can be executed independently in the watch body 1120, independently in the wearable band 1110, and/or via an electronic communication between the watch body 1120 and the wearable band 1110. In some embodiments, functions can be executed on the wrist-wearable device 1100 while an AR environment is being presented (e.g., via one of the AR systems 1000a to 1000c). As the skilled artisan will appreciate upon reading the descriptions provided herein, the novel wearable devices described herein can be used with other types of AR environments.

The wearable band 1110 can be configured to be worn by a user such that an inner (or inside) surface of the wearable structure 1111 of the wearable band 1110 is in contact with the user's skin. When worn by a user, sensors 1113 contact the user's skin. The sensors 1113 can sense biometric data such as a user's heart rate, saturated oxygen level, temperature, sweat level, neuromuscular signal sensors, or a combination thereof. The sensors 1113 can also sense data about a user's environment, including a user's motion, altitude, location, orientation, gait, acceleration, position, or a combination thereof. In some embodiments, the sensors 1113 are configured to track a position and/or motion of the wearable band 1110. The one or more sensors 1113 can include any of the sensors defined above and/or discussed below with respect to FIG. 11B.

The one or more sensors 1113 can be distributed on an inside and/or an outside surface of the wearable band 1110. In some embodiments, the one or more sensors 1113 are uniformly spaced along the wearable band 1110. Alternatively, in some embodiments, the one or more sensors 1113 are positioned at distinct points along the wearable band 1110. As shown in FIG. 11A, the one or more sensors 1113 can be the same or distinct. For example, in some embodiments, the one or more sensors 1113 can be shaped as a pill (e.g., sensor 1113a), an oval, a circle a square, an oblong (e.g., sensor 1113c) and/or any other shape that maintains contact with the user's skin (e.g., such that neuromuscular signal and/or other biometric data can be accurately measured at the user's skin). In some embodiments, the one or more sensors 1113 are aligned to form pairs of sensors (e.g., for sensing neuromuscular signals based on differential sensing within each respective sensor). For example, sensor 1113b is aligned with an adjacent sensor to form sensor pair 1114a and sensor 1113d is aligned with an adjacent sensor to form sensor pair 1114b. In some embodiments, the wearable band 1110 does not have a sensor pair. Alternatively, in some embodiments, the wearable band 1110 has a predetermined number of sensor pairs (one pair of sensors, three pairs of sensors, four pairs of sensors, six pairs of sensors, sixteen pairs of sensors, etc.).

The wearable band 1110 can include any suitable number of sensors 1113. In some embodiments, the number and arrangements of sensors 1113 depend on the particular application for which the wearable band 1110 is used. For instance, a wearable band 1110 configured as an armband, wristband, or chest-band may include a plurality of sensors 1113 with different number of sensors 1113 and different arrangement for each use case, such as medical use cases, compared to gaming or general day-to-day use cases.

In accordance with some embodiments, the wearable band 1110 further includes an electrical ground electrode and a shielding electrode. The electrical ground and shielding electrodes, like the sensors 1113, can be distributed on the inside surface of the wearable band 1110 such that they contact a portion of the user's skin. For example, the electrical ground and shielding electrodes can be at an inside surface of coupling mechanism 1116 or an inside surface of a wearable structure 1111. The electrical ground and shielding electrodes can be formed and/or use the same components as the sensors 1113. In some embodiments, the wearable band 1110 includes more than one electrical ground electrode and more than one shielding electrode.

The sensors 1113 can be formed as part of the wearable structure 1111 of the wearable band 1110. In some embodiments, the sensors 1113 are flush or substantially flush with the wearable structure 1111 such that they do not extend beyond the surface of the wearable structure 1111. While flush with the wearable structure 1111, the sensors 1113 are still configured to contact the user's skin (e.g., via a skin-contacting surface). Alternatively, in some embodiments, the sensors 1113 extend beyond the wearable structure 1111 a predetermined distance (e.g., 0.1 mm to 2 mm) to make contact and depress into the user's skin. In some embodiments, the sensors 1113 are coupled to an actuator (not shown) configured to adjust an extension height (e.g., a distance from the surface of the wearable structure 1111) of the sensors 1113 such that the sensors 1113 make contact and depress into the user's skin. In some embodiments, the actuators adjust the extension height between 0.01 mm to 1.2 mm. This allows the user to customize the positioning of the sensors 1113 to improve the overall comfort of the wearable band 1110 when worn while still allowing the sensors 1113 to contact the user's skin. In some embodiments, the sensors 1113 are indistinguishable from the wearable structure 1111 when worn by the user.

The wearable structure 1111 can be formed of an elastic material, elastomers, etc., configured to be stretched and fitted to be worn by the user. In some embodiments, the wearable structure 1111 is a textile or woven fabric. As described above, the sensors 1113 can be formed as part of a wearable structure 1111. For example, the sensors 1113 can be molded into the wearable structure 1111 or be integrated into a woven fabric (e.g., the sensors 1113 can be sewn into the fabric and mimic the pliability of fabric (e.g., the sensors 1113 can be constructed from a series of woven strands of fabric)).

The wearable structure 1111 can include flexible electronic connectors that interconnect the sensors 1113, the electronic circuitry, and/or other electronic components (described below in reference to FIG. 11B) that are enclosed in the wearable band 1110. In some embodiments, the flexible electronic connectors are configured to interconnect the sensors 1113, the electronic circuitry, and/or other electronic components of the wearable band 1110 with respective sensors and/or other electronic components of another electronic device (e.g., watch body 1120). The flexible electronic connectors are configured to move with the wearable structure 1111 such that the user adjustment to the wearable structure 1111 (e.g., resizing, pulling, folding, etc.) does not stress or strain the electrical coupling of components of the wearable band 1110.

As described above, the wearable band 1110 is configured to be worn by a user. In particular, the wearable band 1110 can be shaped or otherwise manipulated to be worn by a user. For example, the wearable band 1110 can be shaped to have a substantially circular shape such that it can be configured to be worn on the user's lower arm or wrist. Alternatively, the wearable band 1110 can be shaped to be worn on another body part of the user, such as the user's upper arm (e.g., around a bicep), forearm, chest, legs, etc. The wearable band 1110 can include a retaining mechanism 1112 (e.g., a buckle, a hook and loop fastener, etc.) for securing the wearable band 1110 to the user's wrist or other body part. While the wearable band 1110 is worn by the user, the sensors 1113 sense data (referred to as sensor data) from the user's skin. In particular, the sensors 1113 of the wearable band 1110 obtain (e.g., sense and record) neuromuscular signals.

The sensed data (e.g., sensed neuromuscular signals) can be used to detect and/or determine the user's intention to perform certain motor actions. In particular, the sensors 1113 sense and record neuromuscular signals from the user as the user performs muscular activations (e.g., movements, gestures, etc.). The detected and/or determined motor actions (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 1105 of the wrist-wearable device 1100 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 1113 can be used to provide a user with an enhanced interaction with a physical object (e.g., devices communicatively coupled with the wearable band 1110) and/or a virtual object in an artificial-reality application generated by an artificial-reality system (e.g., user interface objects presented on the display 1105 or another computing device (e.g., a smartphone)).

In some embodiments, the wearable band 1110 includes one or more haptic devices 1146 (FIG. 11B; e.g., a vibratory haptic actuator) that are configured to provide haptic feedback (e.g., a cutaneous and/or kinesthetic sensation, etc.) to the user's skin. The sensors 1113, and/or the haptic devices 1146 can be configured to operate in conjunction with multiple applications including, without limitation, health monitoring, social media, games, and artificial reality (e.g., the applications associated with artificial reality).

The wearable band 1110 can also include coupling mechanism 1116 (e.g., a cradle or a shape of the coupling mechanism can correspond to shape of the watch body 1120 of the wrist-wearable device 1100) for detachably coupling a capsule (e.g., a computing unit) or watch body 1120 (via a coupling surface of the watch body 1120) to the wearable band 1110. In particular, the coupling mechanism 1116 can be configured to receive a coupling surface proximate to the bottom side of the watch body 1120 (e.g., a side opposite to a front side of the watch body 1120 where the display 1105 is located), such that a user can push the watch body 1120 downward into the coupling mechanism 1116 to attach the watch body 1120 to the coupling mechanism 1116. In some embodiments, the coupling mechanism 1116 can be configured to receive a top side of the watch body 1120 (e.g., a side proximate to the front side of the watch body 1120 where the display 1105 is located) that is pushed upward into the cradle, as opposed to being pushed downward into the coupling mechanism 1116. In some embodiments, the coupling mechanism 1116 is an integrated component of the wearable band 1110 such that the wearable band 1110 and the coupling mechanism 1116 are a single unitary structure. In some embodiments, the coupling mechanism 1116 is a type of frame or shell that allows the watch body 1120 coupling surface to be retained within or on the wearable band 1110 coupling mechanism 1116 (e.g., a cradle, a tracker band, a support base, a clasp, etc.).

The coupling mechanism 1116 can allow for the watch body 1120 to be detachably coupled to the wearable band 1110 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 1120 to the wearable band 1110 and to decouple the watch body 1120 from the wearable band 1110. For example, a user can twist, slide, turn, push, pull, or rotate the watch body 1120 relative to the wearable band 1110, or a combination thereof, to attach the watch body 1120 to the wearable band 1110 and to detach the watch body 1120 from the wearable band 1110. Alternatively, as discussed below, in some embodiments, the watch body 1120 can be decoupled from the wearable band 1110 by actuation of the release mechanism 1129.

The wearable band 1110 can be coupled with a watch body 1120 to increase the functionality of the wearable band 1110 (e.g., converting the wearable band 1110 into a wrist-wearable device 1100, adding an additional computing unit and/or battery to increase computational resources and/or a battery life of the wearable band 1110, adding additional sensors to improve sensed data, etc.). As described above, the wearable band 1110 (and the coupling mechanism 1116) is configured to operate independently (e.g., execute functions independently) from watch body 1120. For example, the coupling mechanism 1116 can include one or more sensors 1113 that contact a user's skin when the wearable band 1110 is worn by the user and provide sensor data for determining control commands.

A user can detach the watch body 1120 (or capsule) from the wearable band 1110 in order to reduce the encumbrance of the wrist-wearable device 1100 to the user. For embodiments in which the watch body 1120 is removable, the watch body 1120 can be referred to as a removable structure, such that in these embodiments the wrist-wearable device 1100 includes a wearable portion (e.g., the wearable band 1110) and a removable structure (the watch body 1120).

Turning to the watch body 1120, the watch body 1120 can have a substantially rectangular or circular shape. The watch body 1120 is configured to be worn by the user on their wrist or on another body part. More specifically, the watch body 1120 is sized to be easily carried by the user, attached on a portion of the user's clothing, and/or coupled to the wearable band 1110 (forming the wrist-wearable device 1100). As described above, the watch body 1120 can have a shape corresponding to the coupling mechanism 1116 of the wearable band 1110. In some embodiments, the watch body 1120 includes a single release mechanism 1129 or multiple release mechanisms (e.g., two release mechanisms 1129 positioned on opposing sides of the watch body 1120, such as spring-loaded buttons) for decoupling the watch body 1120 and the wearable band 1110. The release mechanism 1129 can include, without limitation, a button, a knob, a plunger, a handle, a lever, a fastener, a clasp, a dial, a latch, or a combination thereof.

A user can actuate the release mechanism 1129 by pushing, turning, lifting, depressing, shifting, or performing other actions on the release mechanism 1129. Actuation of the release mechanism 1129 can release (e.g., decouple) the watch body 1120 from the coupling mechanism 1116 of the wearable band 1110, allowing the user to use the watch body 1120 independently from wearable band 1110, and vice versa. For example, decoupling the watch body 1120 from the wearable band 1110 can allow the user to capture images using rear-facing camera 1125B. Although the coupling mechanism 1116 is shown positioned at a corner of watch body 1120, the release mechanism 1129 can be positioned anywhere on watch body 1120 that is convenient for the user to actuate. In addition, in some embodiments, the wearable band 1110 can also include a respective release mechanism for decoupling the watch body 1120 from the coupling mechanism 1116. In some embodiments, the release mechanism 1129 is optional and the watch body 1120 can be decoupled from the coupling mechanism 1116 as described above (e.g., via twisting, rotating, etc.).

The watch body 1120 can include one or more peripheral buttons 1123 and 1127 for performing various operations at the watch body 1120. For example, the peripheral buttons 1123 and 1127 can be used to turn on or wake (e.g., transition from a sleep state to an active state) the display 1105, unlock the watch body 1120, increase or decrease a volume, increase or decrease brightness, interact with one or more applications, interact with one or more user interfaces, etc. Additionally, or alternatively, in some embodiments, the display 1105 operates as a touch screen and allows the user to provide one or more inputs for interacting with the watch body 1120.

In some embodiments, the watch body 1120 includes one or more sensors 1121. The sensors 1121 of the watch body 1120 can be the same or distinct from the sensors 1113 of the wearable band 1110. The sensors 1121 of the watch body 1120 can be distributed on an inside and/or an outside surface of the watch body 1120. In some embodiments, the sensors 1121 are configured to contact a user's skin when the watch body 1120 is worn by the user. For example, the sensors 1121 can be placed on the bottom side of the watch body 1120 and the coupling mechanism 1116 can be a cradle with an opening that allows the bottom side of the watch body 1120 to directly contact the user's skin. Alternatively, in some embodiments, the watch body 1120 does not include sensors that are configured to contact the user's skin (e.g., including sensors internal and/or external to the watch body 1120 that configured to sense data of the watch body 1120 and the watch body 1120's surrounding environment). In some embodiments, the sensors 1113 are configured to track a position and/or motion of the watch body 1120.

The watch body 1120 and the wearable band 1110 can share data using a wired communication method (e.g., a Universal Asynchronous Receiver/Transmitter (UART), a USB transceiver, etc.) and/or a wireless communication method (e.g., near field communication, Bluetooth, etc.). For example, the watch body 1120 and the wearable band 1110 can share data sensed by the sensors 1113 and 1121, as well as application- and device-specific information (e.g., active and/or available applications), output devices (e.g., display, speakers, etc.), input devices (e.g., touch screen, microphone, imaging sensors, etc.).

In some embodiments, the watch body 1120 can include, without limitation, a front-facing camera 1125A and/or a rear-facing camera 1125B, sensors 1121 (e.g., a biometric sensor, an IMU sensor, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 1163; FIG. 11B), a touch sensor, a sweat sensor, etc.). In some embodiments, the watch body 1120 can include one or more haptic devices 1176 (FIG. 11B; a vibratory haptic actuator) that is configured to provide haptic feedback (e.g., a cutaneous and/or kinesthetic sensation, etc.) to the user. The sensors 1121 and/or the haptic device 1176 can also be configured to operate in conjunction with multiple applications including, without limitation, health-monitoring applications, social media applications, game applications, and artificial-reality applications (e.g., the applications associated with artificial reality).

As described above, the watch body 1120 and the wearable band 1110, when coupled, can form the wrist-wearable device 1100. When coupled, the watch body 1120 and wearable band 1110 operate as a single device to execute functions (operations, detections, communications, etc.) described herein. In some embodiments, each device is provided with particular instructions for performing the one or more operations of the wrist-wearable device 1100. For example, in accordance with a determination that the watch body 1120 does not include neuromuscular signal sensors, the wearable band 1110 can include alternative instructions for performing associated instructions (e.g., providing sensed neuromuscular signal data to the watch body 1120 via a different electronic device). Operations of the wrist-wearable device 1100 can be performed by the watch body 1120 alone or in conjunction with the wearable band 1110 (e.g., via respective processors and/or hardware components) and vice versa. In some embodiments, operations of the wrist-wearable device 1100, the watch body 1120, and/or the wearable band 1110 can be performed in conjunction with one or more processors and/or hardware components of another communicatively coupled device (e.g., the HIPD 1300; FIGS. 13A-13B).

As described below with reference to the block diagram of FIG. 11B, the wearable band 1110 and/or the watch body 1120 can each include independent resources required to independently execute functions. For example, the wearable band 1110 and/or the watch body 1120 can each include a power source (e.g., a battery), a memory, data storage, a processor (e.g., a central processing unit (CPU)), communications, a light source, and/or input/output devices.

FIG. 11B shows block diagrams of a computing system 1130 corresponding to the wearable band 1110, and a computing system 1160 corresponding to the watch body 1120, according to some embodiments. A computing system of the wrist-wearable device 1100 includes a combination of components of the wearable band computing system 1130 and the watch body computing system 1160, in accordance with some embodiments.

The watch body 1120 and/or the wearable band 1110 can include one or more components shown in watch body computing system 1160. In some embodiments, a single integrated circuit includes all or a substantial portion of the components of the watch body computing system 1160 are included in a single integrated circuit. Alternatively, in some embodiments, components of the watch body computing system 1160 are included in a plurality of integrated circuits that are communicatively coupled. In some embodiments, the watch body computing system 1160 is configured to couple (e.g., via a wired or wireless connection) with the wearable band computing system 1130, which allows the computing systems to share components, distribute tasks, and/or perform other operations described herein (individually or as a single device).

The watch body computing system 1160 can include one or more processors 1179, a controller 1177, a peripherals interface 1161, a power system 1195, and memory (e.g., a memory 1180), each of which are defined above and described in more detail below.

The power system 1195 can include a charger input 1196, a power-management integrated circuit (PMIC) 1197, and a battery 1198, each are which are defined above. In some embodiments, a watch body 1120 and a wearable band 1110 can have respective charger inputs (e.g., charger input 1196 and 1157), respective batteries (e.g., battery 1198 and 1159), and can share power with each other (e.g., the watch body 1120 can power and/or charge the wearable band 1110, and vice versa). Although watch body 1120 and/or the wearable band 1110 can include respective charger inputs, a single charger input can charge both devices when coupled. The watch body 1120 and the wearable band 1110 can receive a charge using a variety of techniques. In some embodiments, the watch body 1120 and the wearable band 1110 can use a wired charging assembly (e.g., power cords) to receive the charge. Alternatively, or in addition, the watch body 1120 and/or the wearable band 1110 can be configured for wireless charging. For example, a portable charging device can be designed to mate with a portion of watch body 1120 and/or wearable band 1110 and wirelessly deliver usable power to a battery of watch body 1120 and/or wearable band 1110. The watch body 1120 and the wearable band 1110 can have independent power systems (e.g., power system 1195 and 1156) to enable each to operate independently. The watch body 1120 and wearable band 1110 can also share power (e.g., one can charge the other) via respective PMICs (e.g., PMICs 1197 and 1158) that can share power over power and ground conductors and/or over wireless charging antennas.

In some embodiments, the peripherals interface 1161 can include one or more sensors 1121, many of which listed below are defined above. The sensors 1121 can include one or more coupling sensors 1162 for detecting when the watch body 1120 is coupled with another electronic device (e.g., a wearable band 1110). The sensors 1121 can include imaging sensors 1163 (one or more of the cameras 1125 and/or separate imaging sensors 1163 (e.g., thermal-imaging sensors)). In some embodiments, the sensors 1121 include one or more SpO2 sensors 1164. In some embodiments, the sensors 1121 include one or more biopotential-signal sensors (e.g., EMG sensors 1165, which may be disposed on a user-facing portion of the watch body 1120 and/or the wearable band 1110). In some embodiments, the sensors 1121 include one or more capacitive sensors 1166. In some embodiments, the sensors 1121 include one or more heart rate sensors 1167. In some embodiments, the sensors 1121 include one or more IMUs 1168. In some embodiments, one or more IMUs 1168 can be configured to detect movement of a user's hand or other location that the watch body 1120 is placed or held.

In some embodiments, the peripherals interface 1161 includes an NFC component 1169, a global-position system (GPS) component 1170, a long-term evolution (LTE) component 1171, and/or a Wi-Fi and/or Bluetooth communication component 1172. In some embodiments, the peripherals interface 1161 includes one or more buttons 1173 (e.g., the peripheral buttons 1123 and 1127 in FIG. 11A), which, when selected by a user, cause operations to be performed at the watch body 1120. In some embodiments, the peripherals interface 1161 includes one or more indicators, such as a light emitting diode (LED), to provide a user with visual indicators (e.g., message received, low battery, an active microphone, and/or a camera, etc.).

The watch body 1120 can include at least one display 1105 for displaying visual representations of information or data to the user, including user-interface elements and/or three-dimensional (3D) virtual objects. The display can also include a touch screen for inputting user inputs, such as touch gestures, swipe gestures, and the like. The watch body 1120 can include at least one speaker 1174 and at least one microphone 1175 for providing audio signals to the user and receiving audio input from the user. The user can provide user inputs through the microphone 1175 and can also receive audio output from the speaker 1174 as part of a haptic event provided by the haptic controller 1178. The watch body 1120 can include at least one camera 1125, including a front-facing camera 1125A and a rear-facing camera 1125B. The cameras 1125 can include ultra-wide-angle cameras, wide-angle cameras, fish-eye cameras, spherical cameras, telephoto cameras, a depth-sensing cameras, or other types of cameras.

The watch body computing system 1160 can include one or more haptic controllers 1178 and associated componentry (e.g., haptic devices 1176) for providing haptic events at the watch body 1120 (e.g., a vibrating sensation or audio output in response to an event at the watch body 1120). The haptic controllers 1178 can communicate with one or more haptic devices 1176, such as electroacoustic devices, including a speaker of the one or more speakers 1174 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 1178 can provide haptic events to respective haptic actuators that are capable of being sensed by a user of the watch body 1120. In some embodiments, the one or more haptic controllers 1178 can receive input signals from an application of the applications 1182.

In some embodiments, the computer system 1130 and/or the computer system 1160 can include memory 1180, which can be controlled by a memory controller of the one or more controllers 1177 and/or one or more processors 1179. In some embodiments, software components stored in the memory 1180 include one or more applications 1182 configured to perform operations at the watch body 1120. In some embodiments, the one or more applications 1182 include games, word processors, messaging applications, calling applications, web browsers, social media applications, media streaming applications, financial applications, calendars, clocks, etc. In some embodiments, software components stored in the memory 1180 include one or more communication interface modules 1183 as defined above. In some embodiments, software components stored in the memory 1180 include one or more graphics modules 1184 for rendering, encoding, and/or decoding audio and/or visual data; and one or more data management modules 1185 for collecting, organizing, and/or providing access to the data 1187 stored in memory 1180. In some embodiments, software components stored in the memory 1180 include an AR processing module 1186A, which is configured to perform the features described above in reference to FIGS. 1A-9. In some embodiments, one or more of applications 1182 and/or one or more modules can work in conjunction with one another to perform various tasks at the watch body 1120.

In some embodiments, software components stored in the memory 1180 can include one or more operating systems 1181 (e.g., a Linux-based operating system, an Android operating system, etc.). The memory 1180 can also include data 1187. The data 1187 can include profile data 1188A, sensor data 1189A, media content data 1190, application data 1191, and AR processing data 1192A, which stores data related to the performance of the features described above in reference to FIGS. 1A-9.

It should be appreciated that the watch body computing system 1160 is an example of a computing system within the watch body 1120, and that the watch body 1120 can have more or fewer components than shown in the watch body computing system 1160, combine two or more components, and/or have a different configuration and/or arrangement of the components. The various components shown in watch body computing system 1160 are implemented in hardware, software, firmware, or a combination thereof, including one or more signal processing and/or application-specific integrated circuits.

Turning to the wearable band computing system 1130, one or more components that can be included in the wearable band 1110 are shown. The wearable band computing system 1130 can include more or fewer components than shown in the watch body computing system 1160, combine two or more components, and/or have a different configuration and/or arrangement of some or all of the components. In some embodiments, all, or a substantial portion of the components of the wearable band computing system 1130 are included in a single integrated circuit. Alternatively, in some embodiments, components of the wearable band computing system 1130 are included in a plurality of integrated circuits that are communicatively coupled. As described above, in some embodiments, the wearable band computing system 1130 is configured to couple (e.g., via a wired or wireless connection) with the watch body computing system 1160, which allows the computing systems to share components, distribute tasks, and/or perform other operations described herein (individually or as a single device).

The wearable band computing system 1130, similar to the watch body computing system 1160, can include one or more processors 1149, one or more controllers 1147 (including one or more haptics controller 1148), a peripherals interface 1131 that can include one or more sensors 1113 and other peripheral devices, power source (e.g., a power system 1156), and memory (e.g., a memory 1150) that includes an operating system (e.g., an operating system 1151), data (e.g., data 1154 including profile data 1188B, sensor data 1189B, AR processing data 1192B], etc.), and one or more modules (e.g., a communications interface module 1152, a data management module 1153, an AR processing module 1186B], etc.).

The one or more sensors 1113 can be analogous to sensors 1121 of the computer system 1160 in light of the definitions above. For example, sensors 1113 can include one or more coupling sensors 1132, one or more SpO2 sensors 1134, one or more EMG sensors 1135, one or more capacitive sensors 1136, one or more heart rate sensors 1137, and one or more IMU sensors 1138.

The peripherals interface 1131 can also include other components analogous to those included in the peripheral interface 1161 of the computer system 1160, including an NFC component 1139, a GPS component 1140, an LTE component 1141, a Wi-Fi and/or Bluetooth communication component 1142, and/or one or more haptic devices 1176 as described above in reference to peripherals interface 1161. In some embodiments, the peripherals interface 1131 includes one or more buttons 1143, a display 1133, a speaker 1144, a microphone 1145, and a camera 1155. In some embodiments, the peripherals interface 1131 includes one or more indicators, such as an LED.

It should be appreciated that the wearable band computing system 1130 is an example of a computing system within the wearable band 1110, and that the wearable band 1110 can have more or fewer components than shown in the wearable band computing system 1130, combine two or more components, and/or have a different configuration and/or arrangement of the components. The various components shown in wearable band computing system 1130 can be implemented in one or a combination of hardware, software, and firmware, including one or more signal processing and/or application-specific integrated circuits.

The wrist-wearable device 1100 with respect to FIG. 11A is an example of the wearable band 1110 and the watch body 1120 coupled, so the wrist-wearable device 1100 will be understood to include the components shown and described for the wearable band computing system 1130 and the watch body computing system 1160. In some embodiments, wrist-wearable device 1100 has a split architecture (e.g., a split mechanical architecture or a split electrical architecture) between the watch body 1120 and the wearable band 1110. In other words, all of the components shown in the wearable band computing system 1130 and the watch body computing system 1160 can be housed or otherwise disposed in a combined watch device 1100, or within individual components of the watch body 1120, wearable band 1110, and/or portions thereof (e.g., a coupling mechanism 1116 of the wearable band 1110).

The techniques described above can be used with any device for sensing neuromuscular signals, including the arm-wearable devices of FIG. 11A-11B, but could also be used with other types of wearable devices for sensing neuromuscular signals (such as body-wearable or head-wearable devices that might have neuromuscular sensors closer to the brain or spinal column).

In some embodiments, a wrist-wearable device 1100 can be used in conjunction with a head-wearable device described below (e.g., AR device 1200 and VR device 1210) and/or an HIPD 1300, and the wrist-wearable device 1100 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable device, attention will now be turned to example head-wearable devices, such AR device 1200 and VR device 1210.

### Example Head-Wearable Devices

FIGS. 12A-12C show example head-wearable devices, in accordance with some embodiments. Head-wearable devices can include, but are not limited to, AR devices 1210 (e.g., AR or smart eyewear devices, such as smart glasses, smart monocles, smart contacts, etc.), VR devices 1210 (e.g., VR headsets, head-mounted displays (HMD) s, etc.), or other ocularly coupled devices. The AR devices 1200 and the VR devices 1210 are instances of the head-wearable devices described in reference to FIGS. 1A-9 herein, such that the head-wearable device should be understood to have the features of the AR devices 1200 and/or the VR devices 1210, and vice versa. The AR devices 1200 and the VR devices 1210 can perform various functions and/or operations associated with navigating through user interfaces and selectively opening applications, as well as the functions and/or operations described above with reference to FIGS. 1A-9.

In some embodiments, an AR system (e.g., AR systems 1000a-1000c; FIGS. 10A-10C-2) includes an AR device 1200 (as shown in FIG. 12A) and/or VR device 1210 (as shown in FIGS. 12B-1 and 12B-2). In some embodiments, the AR device 1200 and the VR device 1210 can include one or more analogous components (e.g., components for presenting interactive artificial-reality environments, such as processors, memory, and/or presentation devices, including one or more displays and/or one or more waveguides), some of which are described in more detail with respect to FIG. 12C. The head-wearable devices can use display projectors (e.g., display projector assemblies 1207A and 1207B) and/or waveguides for projecting representations of data to a user. Some embodiments of head-wearable devices do not include displays.

FIG. 12A shows an example visual depiction of the AR device 1200 (e.g., which may also be described herein as augmented-reality glasses and/or smart glasses). The AR device 1200 can work in conjunction with additional electronic components that are not shown in FIGS. 12A, such as a wearable accessory device and/or an intermediary processing device, in electronic communication or otherwise configured to be used in conjunction with the AR device 1200. In some embodiments, the wearable accessory device and/or the intermediary processing device may be configured to couple with the AR device 1200 via a coupling mechanism in electronic communication with a coupling sensor 1224, where the coupling sensor 1224 can detect when an electronic device becomes physically or electronically coupled with the AR device 1200. In some embodiments, the AR device 1200 can be configured to couple to a housing (e.g., a portion of frame 1204 or temple arms 1205), which may include one or more additional coupling mechanisms configured to couple with additional accessory devices. The components shown in FIG. 12A can be implemented in hardware, software, firmware, or a combination thereof, including one or more signal-processing components and/or application-specific integrated circuits (ASICs).

The AR device 1200 includes mechanical glasses components, including a frame 1204 configured to hold one or more lenses (e.g., one or both lenses 1206-1 and 1206-2). One of ordinary skill in the art will appreciate that the AR device 1200 can include additional mechanical components, such as hinges configured to allow portions of the frame 1204 of the AR device 1200 to be folded and unfolded, a bridge configured to span the gap between the lenses 1206-1 and 1206-2 and rest on the user's nose, nose pads configured to rest on the bridge of the nose and provide support for the AR device 1200, earpieces configured to rest on the user's ears and provide additional support for the AR device 1200, temple arms 1205 configured to extend from the hinges to the earpieces of the AR device 1200, and the like. One of ordinary skill in the art will further appreciate that some examples of the AR device 1200 can include none of the mechanical components described herein. For example, smart contact lenses configured to present artificial-reality to users may not include any components of the AR device 1200.

The lenses 1206-1 and 1206-2 can be individual displays or display devices (e.g., a waveguide for projected representations). The lenses 1206-1 and 1206-2 may act together or independently to present an image or series of images to a user. In some embodiments, the lenses 1206-1 and 1206-2 can operate in conjunction with one or more display projector assemblies 1207A and 1207B to present image data to a user. While the AR device 1200 includes two displays, embodiments of this disclosure may be implemented in AR devices with a single near-eye display (NED) or more than two NEDs.

The AR device 1200 includes electronic components, many of which will be described in more detail below with respect to FIG. 12C. Some example electronic components are illustrated in FIG. 12A, including sensors 1223-1, 1223-2, 1223-3, 1223-4, 1223-5, and 1223-6, which can be distributed along a substantial portion of the frame 1204 of the AR device 1200. The different types of sensors are described below in reference to FIG. 12C. The AR device 1200 also includes a left camera 1239A and a right camera 1239B, which are located on different sides of the frame 1204. And the eyewear device includes one or more processors 1248A and 1248B (e.g., an integral microprocessor, such as an ASIC) that is embedded into a portion of the frame 1204.

FIGS. 12B-1 and 12B-2 show an example visual depiction of the VR device 1210 (e.g., a head-mounted display (HMD) 1212, also referred to herein as an artificial-reality headset, a head-wearable device, a VR headset, etc.). The HMD 1212 includes a front body 1214 and a frame 1216 (e.g., a strap or band) shaped to fit around a user's head. In some embodiments, the front body 1214 and/or the frame 1216 includes one or more electronic elements for facilitating presentation of and/or interactions with an AR and/or VR system (e.g., displays, processors (e.g., processor 1248A-1), IMUs, tracking emitter or detectors, sensors, etc.). In some embodiments, the HMD 1212 includes output audio transducers (e.g., an audio transducer 1218-1), as shown in FIG. 12B-2. In some embodiments, one or more components, such as the output audio transducer(s) 1218-1 and the frame 1216, can be configured to attach and detach (e.g., are detachably attachable) to the HMD 1212 (e.g., a portion or all of the frame 1216, and/or the output audio transducer 1218-1), as shown in FIG. 12B-2. In some embodiments, coupling a detachable component to the HMD 1212 causes the detachable component to come into electronic communication with the HMD 1212. The VR device 1210 includes electronic components, many of which will be described in more detail below with respect to FIG. 12C

FIG. 12B-1 to 12B-2 also show that the VR device 1210 one or more cameras, such as the left camera 1239A and the right camera 1239B, which can be analogous to the left and right cameras on the frame 1204 of the AR device 1200. In some embodiments, the VR device 1210 includes one or more additional cameras (e.g., cameras 1239C and 1239D), which can be configured to augment image data obtained by the cameras 1239A and 1239B by providing more information. For example, the camera 1239C can be used to supply color information that is not discerned by cameras 1239A and 1239B. In some embodiments, one or more of the cameras 1239A to 1239D can include an optional IR cut filter configured to remove IR light from being received at the respective camera sensors.

The VR device 1210 can include a housing 1290 storing one or more components of the VR device 1210 and/or additional components of the VR device 1210. The housing 1290 can be a modular electronic device configured to couple with the VR device 1210 (or an AR device 1200) and supplement and/or extend the capabilities of the VR device 1210 (or an AR device 1200). For example, the housing 1290 can include additional sensors, cameras, power sources, processors (e.g., processor 1248A-2), etc. to improve and/or increase the functionality of the VR device 1210. Examples of the different components included in the housing 1290 are described below in reference to FIG. 12C.

Alternatively or in addition, in some embodiments, the head-wearable device, such as the VR device 1210 and/or the AR device 1200), includes, or is communicatively coupled to, another external device (e.g., a paired device), such as an HIPD 1300 (discussed below in reference to FIGS. 13A-13B) and/or an optional neckband. The optional neckband can couple to the head-wearable device via one or more connectors (e.g., wired or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckband may also apply to various other paired devices, such as smart watches, smart phones, wrist bands, other wearable devices, hand-held controllers, tablet computers, or laptop computers.

In some situations, pairing external devices, such as an intermediary processing device (e.g., an HIPD device 1300, an optional neckband, and/or wearable accessory device) with the head-wearable devices (e.g., an AR device 1200 and/or VR device 1210) enables the head-wearable devices to achieve a similar form factor of a pair of glasses while still providing sufficient battery and computation power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable devices overall while allowing the head-wearable devices to retain its desired functionality. For example, the intermediary processing device (e.g., the HIPD 1300) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, storage, etc.) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, like an HIPD 1300, can process information generated by one or more sensors of its sensors and/or information provided by other communicatively coupled devices. For example, a head-wearable device can include an IMU, and the intermediary processing device (neckband and/or an HIPD 1300) can compute all inertial and spatial calculations from the IMUs located on the head-wearable device. Additional examples of processing performed by a communicatively coupled device, such as the HIPD 1300, are provided below in reference to FIGS. 13A and 13B.

Artificial-reality systems may include a variety of types of visual feedback mechanisms. For example, display devices in the AR devices 1200 and/or the VR devices 1210 may include one or more liquid-crystal displays (LCDs), light emitting diode (LED) displays, organic LED (OLED) displays, and/or any other suitable type of display screen. Artificial-reality systems may include a single display screen for both eyes or may provide a display screen for each eye, which may allow for additional flexibility for varifocal adjustments or for correcting a refractive error associated with the user's vision. Some artificial-reality systems also include optical subsystems having one or more lenses (e.g., conventional concave or convex lenses, Fresnel lenses, or adjustable liquid lenses) through which a user may view a display screen. In addition to or instead of using display screens, some artificial-reality systems include one or more projection systems. For example, display devices in the AR device 1200 and/or the VR device 1210 may include micro-LED projectors that project light (e.g., using a waveguide) into display devices, such as clear combiner lenses that allow ambient light to pass through. The display devices may refract the projected light toward a user's pupil and may enable a user to simultaneously view both artificial-reality content and the real world. Artificial-reality systems may also be configured with any other suitable type or form of image projection system. As noted, some AR systems may, instead of blending an artificial reality with actual reality, substantially replace one or more of a user's sensory perceptions of the real world with a virtual experience.

While the example head-wearable devices are respectively described herein as the AR device 1200 and the VR device 1210, either or both of the example head-wearable devices described herein can be configured to present fully-immersive VR scenes presented in substantially all of a user's field of view, additionally or alternatively to, subtler augmented-reality scenes that are presented within a portion, less than all, of the user's field of view.

In some embodiments, the AR device 1200 and/or the VR device 1210 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices (e.g., wrist-wearable devices which may be incorporated into headwear, gloves, body suits, handheld controllers, environmental devices (e.g., chairs or floormats), and/or any other type of device or system, such as a wrist-wearable device 1100, an HIPD 1300, smart textile-based garment (not shown), etc.), and/or other devices described herein.

FIG. 12C illustrates a computing system 1220 and an optional housing 1290, each of which show components that can be included in a head-wearable device (e.g., the AR device 1200 and/or the VR device 1210). In some embodiments, more or less components can be included in the optional housing 1290 depending on practical restraints of the respective head-wearable device being described. Additionally or alternatively, the optional housing 1290 can include additional components to expand and/or augment the functionality of a head-wearable device.

In some embodiments, the computing system 1220 and/or the optional housing 1290 can include one or more peripheral interfaces 1222A and 1222B, one or more power systems 1242A and 1242B (including charger input 1243, PMIC 1244, and battery 1245), one or more controllers 1246A 1246B (including one or more haptic controllers 1247), one or more processors 1248A and 1248B (as defined above, including any of the examples provided), and memory 1250A and 1250B, which can all be in electronic communication with each other. For example, the one or more processors 1248A and/or 1248B can be configured to execute instructions stored in the memory 1250A and/or 1250B, which can cause a controller of the one or more controllers 1246A and/or 1246B to cause operations to be performed at one or more peripheral devices of the peripherals interfaces 1222A and/or 1222B. In some embodiments, each operation described can occur based on electrical power provided by the power system 1242A and/or 1242B.

In some embodiments, the peripherals interface 1222A can include one or more devices configured to be part of the computing system 1220, many of which have been defined above and/or described with respect to wrist-wearable devices shown in FIGS. 11A and 11B. For example, the peripherals interface can include one or more sensors 1223A. Some example sensors include: one or more coupling sensors 1224, one or more acoustic sensors 1225, one or more imaging sensors 1226, one or more EMG sensors 1227, one or more capacitive sensors 1228, and/or one or more IMUs 1229. In some embodiments, the sensors 1223A further include depth sensors 1267, light sensors 1268 and/or any other types of sensors defined above or described with respect to any other embodiments discussed herein.

In some embodiments, the peripherals interface can include one or more additional peripheral devices, including one or more NFC devices 1230, one or more GPS devices 1231, one or more LTE devices 1232, one or more WiFi and/or Bluetooth devices 1233, one or more buttons 1234 (e.g., including buttons that are slidable or otherwise adjustable), one or more displays 1235A, one or more speakers 1236A, one or more microphones 1237A, one or more cameras 1238A (e.g., including the a first camera 1239-1 through nth camera 1239-n, which are analogous to the left camera 1239A and/or the right camera 1239B), one or more haptic devices 1240; and/or any other types of peripheral devices defined above or described with respect to any other embodiments discussed herein.

The head-wearable devices can include a variety of types of visual feedback mechanisms (e.g., presentation devices). For example, display devices in the AR device 1200 and/or the VR device 1210 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes), and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 1235A can be coupled to each of the lenses 1206-1 and 1206-2 of the AR device 1200. The displays 1235A coupled to each of the lenses 1206-1 and 1206-2 can act together or independently to present an image or series of images to a user. In some embodiments, the AR device 1200 and/or the VR device 1210 includes a single display 1235A (e.g., a near-eye display) or more than two displays 1235A.

In some embodiments, a first set of one or more displays 1235A can be used to present an augmented-reality environment, and a second set of one or more display devices 1235A can be used to present a virtual-reality environment. In some embodiments, one or more waveguides are used in conjunction with presenting artificial-reality content to the user of the AR device 1200 and/or the VR device 1210 (e.g., as a means of delivering light from a display projector assembly and/or one or more displays 1235A to the user's eyes). In some embodiments, one or more waveguides are fully or partially integrated into the AR device 1200 and/or the VR device 1210. Additionally, or alternatively to display screens, some artificial-reality systems include one or more projection systems. For example, display devices in the AR device 1200 and/or the VR device 1210 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. The head-wearable devices can also be configured with any other suitable type or form of image projection system. In some embodiments, one or more waveguides are provided additionally or alternatively to the one or more display(s) 1235A.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15-50% of the ambient light and/or the real-world live view) can be passed through the user interface element, such that the user can distinguish at least a portion of the physical environment over which the user interface element is being displayed.

The head-wearable devices can include one or more external displays 1235A for presenting information to users. For example, an external display 1235A can be used to show a current battery level, network activity (e.g., connected, disconnected, etc.), current activity (e.g., playing a game, in a call, in a meeting, watching a movie, etc.), and/or other relevant information. In some embodiments, the external displays 1235A can be used to communicate with others. For example, a user of the head-wearable device can cause the external displays 1235A to present a do not disturb notification. The external displays 1235A can also be used by the user to share any information captured by the one or more components of the peripherals interface 1222A and/or generated by head-wearable device (e.g., during operation and/or performance of one or more applications).

The memory 1250A can include instructions and/or data executable by one or more processors 1248A (and/or processors 1248B of the housing 1290) and/or a memory controller of the one or more controllers 1246A (and/or controller 1246B of the housing 1290). The memory 1250A can include one or more operating systems 1251; one or more applications 1252; one or more communication interface modules 1253A; one or more graphics modules 1254A; one or more AR processing modules 1255A (which is configured for performing the features described above in reference to FIGS. 1A-9 as well as other features in an AR environment); and/or any other types of modules or components defined above or described with respect to any other embodiments discussed herein.

The data 1260 stored in memory 1250A can be used in conjunction with one or more of the applications and/or programs discussed above. The data 1260 can include profile data 1261; sensor data 1262; media content data 1263; AR application data 1264 (which stores data related to the performance of the features described above in reference to FIGS. 1A-9); and/or any other types of data defined above or described with respect to any other embodiments discussed herein.

In some embodiments, the controller 1246A of the head-wearable devices processes information generated by the sensors 1223A on the head-wearable devices and/or another component of the head-wearable devices and/or communicatively coupled with the head-wearable devices (e.g., components of the housing 1290, such as components of peripherals interface 1222B). For example, the controller 1246A can process information from the acoustic sensors 1225 and/or image sensors 1226. For each detected sound, the controller 1246A can perform a direction of arrival (DOA) estimation to estimate a direction from which the detected sound arrived at a head-wearable device. As one or more of the acoustic sensors 1225 detects sounds, the controller 1246A can populate an audio data set with the information (e.g., represented by sensor data 1262).

In some embodiments, a physical electronic connector can convey information between the head-wearable devices and another electronic device, and/or between one or more processors 1248A of the head-wearable devices and the controller 1246A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 1300) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 1200 and/or the VR device 1210 can include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. A head-wearable device can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with in AR environment), among a variety of other functions. For example, FIGS. 12B-1 and 12B-2 show the VR device 1210 having cameras 1239A-1239D, which can be used to provide depth information for creating a voxel field and a two-dimensional mesh to provide object information to the user to avoid collisions.

The optional housing 1290 can include analogous components to those describe above with respect to the computing system 1220. For example, the optional housing 1290 can include a respective peripherals interface 1222B including more or less components to those described above with respect to the peripherals interface 1222A. As described above, the components of the optional housing 1290 can be used augment and/or expand on the functionality of the head-wearable devices. For example, the optional housing 1290 can include respective sensors 1223B, speakers 1236B, displays 1235B, microphones 1237B, cameras 1238B, and/or other components to capture and/or present data. Similarly, the optional housing 1290 can include one or more processors 1248B, controllers 1246B, and/or memory 1250B (including respective communication interface modules 1253B; one or more graphics modules 1254B; one or more AR processing modules 1255B, etc.) that can be used individually and/or in conjunction with the components of the computing system 1220.

The techniques described above in FIGS. 12A-12C can be used with different head-wearable devices. In some embodiments, the head-wearable devices (e.g., the AR device 1200 and/or the VR device 1210) can be used in conjunction with one or more wearable device such as a wrist-wearable device 1100 (or components thereof), as well as an HIPD 1300. Having thus described example the head-wearable devices, attention will now be turned to example handheld intermediary processing devices, such as HIPD 1300.

### Example Handheld Intermediary Processing Devices

FIGS. 13A and 13B illustrate an example handheld intermediary processing device (HIPD) 1300, in accordance with some embodiments. The HIPD 1300 is an instance of the intermediary device described in reference to FIGS. 1A-9 herein, such that the HIPD 1300 should be understood to have the features described with respect to any intermediary device defined above or otherwise described herein, and vice versa. The HIPD 1300 can perform various functions and/or operations associated with navigating through user interfaces and selectively opening applications, as well as the functions and/or operations described above with reference to FIGS. 1A-9.

FIG. 13A shows a top view 1305 and a side view 1325 of the HIPD 1300. The HIPD 1300 is configured to communicatively couple with one or more wearable devices (or other electronic devices) associated with a user. For example, the HIPD 1300 is configured to communicatively couple with a user's wrist-wearable device 1100 (or components thereof, such as the watch body 1120 and the wearable band 1110), AR device 1200, and/or VR device 1210. The HIPD 1300 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which the HIPD 1300 can successfully be communicatively coupled with an electronic device, such as a wearable device).

The HIPD 1300 can perform various functions independently and/or in conjunction with one or more wearable devices (e.g., wrist-wearable device 1100, AR device 1200, VR device 1210, etc.). The HIPD 1300 is configured to increase and/or improve the functionality of communicatively coupled devices, such as the wearable devices. The HIPD 1300 is configured to perform one or more functions or operations associated with interacting with user interfaces and applications of communicatively coupled devices, interacting with an AR environment, interacting with VR environment, and/or operating as a human-machine interface controller, as well as functions and/or operations described above with reference to FIGS. 1A-9. Additionally, as will be described in more detail below, functionality and/or operations of the HIPD 1300 can include, without limitation, task offloading and/or handoffs; thermals offloading and/or handoffs; 6 degrees of freedom (6DoF) raycasting and/or gaming (e.g., using imaging devices or cameras 1314A and 1314B, which can be used for simultaneous localization and mapping (SLAM) and/or with other image processing techniques); portable charging; messaging; image capturing via one or more imaging devices or cameras (e.g., cameras 1322A and 1322B); sensing user input (e.g., sensing a touch on a multi-touch input surface 1302); wireless communications and/or interlining (e.g., cellular, near field, Wi-Fi, personal area network, etc.); location determination; financial transactions; providing haptic feedback; alarms; notifications; biometric authentication; health monitoring; sleep monitoring; etc. The above-example functions can be executed independently in the HIPD 1300 and/or in communication between the HIPD 1300 and another wearable device described herein. In some embodiments, functions can be executed on the HIPD 1300 in conjunction with an AR environment. As the skilled artisan will appreciate upon reading the descriptions provided herein, the novel the HIPD 1300 described herein can be used with any type of suitable AR environment.

While the HIPD 1300 is communicatively coupled with a wearable device and/or other electronic device, the HIPD 1300 is configured to perform one or more operations initiated at the wearable device and/or the other electronic device. In particular, one or more operations of the wearable device and/or the other electronic device can be offloaded to the HIPD 1300 to be performed. The HIPD 1300 performs the one or more operations of the wearable device and/or the other electronic device and provides to data corresponded to the completed operations to the wearable device and/or the other electronic device. For example, a user can initiate a video stream using AR device 1200 and back-end tasks associated with performing the video stream (e.g., video rendering) can be offloaded to the HIPD 1300, which the HIPD 1300 performs and provides corresponding data to the AR device 1200 to perform remaining front-end tasks associated with the video stream (e.g., presenting the rendered video data via a display of the AR device 1200). In this way, the HIPD 1300, which has more computational resources and greater thermal headroom than a wearable device, can perform computationally intensive tasks for the wearable device improving performance of an operation performed by the wearable device.

The HIPD 1300 includes a multi-touch input surface 1302 on a first side (e.g., a front surface) that is configured to detect one or more user inputs. In particular, the multi-touch input surface 1302 can detect single tap inputs, multi-tap inputs, swipe gestures and/or inputs, force-based and/or pressure-based touch inputs, held taps, and the like. The multi-touch input surface 1302 is configured to detect capacitive touch inputs and/or force (and/or pressure) touch inputs. The multi-touch input surface 1302 includes a first touch-input surface 1304 defined by a surface depression, and a second touch-input surface 1306 defined by a substantially planar portion. The first touch-input surface 1304 can be disposed adjacent to the second touch-input surface 1306. In some embodiments, the first touch-input surface 1304 and the second touch-input surface 1306 can be different dimensions, shapes, and/or cover different portions of the multi-touch input surface 1302. For example, the first touch-input surface 1304 can be substantially circular and the second touch-input surface 1306 is substantially rectangular. In some embodiments, the surface depression of the multi-touch input surface 1302 is configured to guide user handling of the HIPD 1300. In particular, the surface depression is configured such that the user holds the HIPD 1300 upright when held in a single hand (e.g., such that the using imaging devices or cameras 1314A and 1314B are pointed toward a ceiling or the sky). Additionally, the surface depression is configured such that the user's thumb rests within the first touch-input surface 1304.

In some embodiments, the different touch-input surfaces include a plurality of touch-input zones. For example, the second touch-input surface 1306 includes at least a first touch-input zone 1308 within a second touch-input zone 1306 and a third touch-input zone 1310 within the first touch-input zone 1308. In some embodiments, one or more of the touch-input zones are optional and/or user defined (e.g., a user can specific a touch-input zone based on their preferences). In some embodiments, each touch-input surface and/or touch-input zone is associated with a predetermined set of commands. For example, a user input detected within the first touch-input zone 1308 causes the HIPD 1300 to perform a first command and a user input detected within the second touch-input zone 1306 causes the HIPD 1300 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, the first touch-input zone 1308 can be configured to detect force touch inputs (e.g., a magnitude at which the user presses down) and capacitive touch inputs, and the second touch-input zone 1306 can be configured to detect capacitive touch inputs.

The HIPD 1300 includes one or more sensors 1351 for sensing data used in the performance of one or more operations and/or functions. For example, the HIPD 1300 can include an IMU that is used in conjunction with cameras 1314 for 3-dimensional object manipulation (e.g., enlarging, moving, destroying, etc. an object) in an AR or VR environment. Non-limiting examples of the sensors 1351 included in the HIPD 1300 include a light sensor, a magnetometer, a depth sensor, a pressure sensor, and a force sensor. Additional examples of the sensors 1351 are provided below in reference to FIG. 13B.

The HIPD 1300 can include one or more light indicators 1312 to provide one or more notifications to the user. In some embodiments, the light indicators are LEDs or other types of illumination devices. The light indicators 1312 can operate as a privacy light to notify the user and/or others near the user that an imaging device and/or microphone are active. In some embodiments, a light indicator is positioned adjacent to one or more touch-input surfaces. For example, a light indicator can be positioned around the first touch-input surface 1304. The light indicators can be illuminated in different colors and/or patterns to provide the user with one or more notifications and/or information about the device. For example, a light indicator positioned around the first touch-input surface 1304 can flash when the user receives a notification (e.g., a message), change red when the HIPD 1300 is out of power, operate as a progress bar (e.g., a light ring that is closed when a task is completed (e.g., 0% to 100%)), operates as a volume indicator, etc.).

In some embodiments, the HIPD 1300 includes one or more additional sensors on another surface. For example, as shown FIG. 13A, HIPD 1300 includes a set of one or more sensors (e.g., sensor set 1320) on an edge of the HIPD 1300. The sensor set 1320, when positioned on an edge of the of the HIPD 1300, can be pe positioned at a predetermined tilt angle (e.g., 26 degrees), which allows the sensor set 1320 to be angled toward the user when placed on a desk or other flat surface. Alternatively, in some embodiments, the sensor set 1320 is positioned on a surface opposite the multi-touch input surface 1302 (e.g., a back surface). The one or more sensors of the sensor set 1320 are discussed in detail below.

The side view 1325 of the of the HIPD 1300 shows the sensor set 1320 and camera 1314B. The sensor set 1320 includes one or more cameras 1322A and 1322B, a depth projector 1324, an ambient light sensor 1328, and a depth receiver 1330. In some embodiments, the sensor set 1320 includes a light indicator 1326. The light indicator 1326 can operate as a privacy indicator to let the user and/or those around them know that a camera and/or microphone is active. The sensor set 1320 is configured to capture a user's facial expression such that the user can puppet a custom avatar (e.g., showing emotions, such as smiles, laughter, etc., on the avatar or a digital representation of the user). The sensor set 1320 can be configured as a side stereo RGB system, a rear indirect Time-of-Flight (iToF) system, or a rear stereo RGB system. As the skilled artisan will appreciate upon reading the descriptions provided herein, the novel HIPD 1300 described herein can use different sensor set 1320 configurations and/or sensor set 1320 placement.

In some embodiments, the HIPD 1300 includes one or more haptic devices 1371 (FIG. 13B; e.g., a vibratory haptic actuator) that are configured to provide haptic feedback (e.g., kinesthetic sensation). The sensors 1351, and/or the haptic devices 1371 can be configured to operate in conjunction with multiple applications and/or communicatively coupled devices including, without limitation, a wearable devices, health monitoring applications, social media applications, game applications, and artificial reality applications (e.g., the applications associated with artificial reality).

The HIPD 1300 is configured to operate without a display. However, in optional embodiments, the HIPD 1300 can include a display 1368 (FIG. 13B). The HIPD 1300 can also income one or more optional peripheral buttons 1367 (FIG. 13B). For example, the peripheral buttons 1367 can be used to turn on or turn off the HIPD 1300. Further, the HIPD 1300 housing can be formed of polymers and/or elastomer elastomers. The HIPD 1300 can be configured to have a non-slip surface to allow the HIPD 1300 to be placed on a surface without requiring a user to watch over the HIPD 1300. In other words, the HIPD 1300 is designed such that it would not easily slide off a surfaces. In some embodiments, the HIPD 1300 include one or magnets to couple the HIPD 1300 to another surface. This allows the user to mount the HIPD 1300 to different surfaces and provide the user with greater flexibility in use of the HIPD 1300.

As described above, the HIPD 1300 can distribute and/or provide instructions for performing the one or more tasks at the HIPD 1300 and/or a communicatively coupled device. For example, the HIPD 1300 can identify one or more back-end tasks to be performed by the HIPD 1300 and one or more front-end tasks to be performed by a communicatively coupled device. While the HIPD 1300 is configured to offload and/or handoff tasks of a communicatively coupled device, the HIPD 1300 can perform both back-end and front-end tasks (e.g., via one or more processors, such as CPU 1377; FIG. 13B). The HIPD 1300 can, without limitation, can be used to perform augmenting calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. The HIPD 1300 can perform the above operations alone or in conjunction with a wearable device (or other communicatively coupled electronic device).

FIG. 13B shows block diagrams of a computing system 1340 of the HIPD 1300, in accordance with some embodiments. The HIPD 1300, described in detail above, can include one or more components shown in HIPD computing system 1340. The HIPD 1300 will be understood to include the components shown and described below for the HIPD computing system 1340. In some embodiments, all, or a substantial portion of the components of the HIPD computing system 1340 are included in a single integrated circuit. Alternatively, in some embodiments, components of the HIPD computing system 1340 are included in a plurality of integrated circuits that are communicatively coupled.

The HIPD computing system 1340 can include a processor (e.g., a CPU 1377, a GPU, and/or a CPU with integrated graphics), a controller 1375, a peripherals interface 1350 that includes one or more sensors 1351 and other peripheral devices, a power source (e.g., a power system 1395), and memory (e.g., a memory 1378) that includes an operating system (e.g., an operating system 1379), data (e.g., data 1388), one or more applications (e.g., applications 1380), and one or more modules (e.g., a communications interface module 1381, a graphics module 1382, a task and processing management module 1383, an interoperability module 1384, an AR processing module 1385, a data management module 1386, etc.). The HIPD computing system 1340 further includes a power system 1395 that includes a charger input and output 1396, a PMIC 1397, and a battery 1398, all of which are defined above.

In some embodiments, the peripherals interface 1350 can include one or more sensors 1351. The sensors 1351 can include analogous sensors to those described above in reference to FIG. 11B. For example, the sensors 1351 can include imaging sensors 1354, (optional) EMG sensors 1356, IMUs 1358, and capacitive sensors 1360. In some embodiments, the sensors 1351 can include one or more pressure sensor 1352 for sensing pressure data, an altimeter 1353 for sensing an altitude of the HIPD 1300, a magnetometer 1355 for sensing a magnetic field, a depth sensor 1357 (or a time-of flight sensor) for determining a difference between the camera and the subject of an image, a position sensor 1359 (e.g., a flexible position sensor) for sensing a relative displacement or position change of a portion of the HIPD 1300, a force sensor 1361 for sensing a force applied to a portion of the HIPD 1300, and a light sensor 1362 (e.g., an ambient light sensor) for detecting an amount of lighting. The sensors 1351 can include one or more sensors not shown in FIG. 13B.

Analogous to the peripherals described above in reference to FIGS. 11B, the peripherals interface 1350 can also include an NFC component 1363, a GPS component 1364, an LTE component 1365, a Wi-Fi and/or Bluetooth communication component 1366, a speaker 1369, a haptic device 1371, and a microphone 1373. As described above in reference to FIG. 13A, the HIPD 1300 can optionally include a display 1368 and/or one or more buttons 1367. The peripherals interface 1350 can further include one or more cameras 1370, touch surfaces 1372, and/or one or more light emitters 1374. The multi-touch input surface 1302 described above in reference to FIG. 13A is an example of touch surface 1372. The light emitters 1374 can be one or more LEDs, lasers, etc. and can be used to project or present information to a user. For example, the light emitters 1374 can include light indicators 1312 and 1326 described above in reference to FIG. 13A. The cameras 1370 (e.g., cameras 1314A, 1314B, and 1322 described above in FIG. 13A) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other available cameras. Cameras 1370 can be used for SLAM; 6 DoF ray casting, gaming, object manipulation, and/or other rendering; facial recognition and facial expression recognition, etc.

Similar to the watch body computing system 1160 and the watch band computing system 1130 described above in reference to FIG. 11B, the HIPD computing system 1340 can include one or more haptic controllers 1376 and associated componentry (e.g., haptic devices 1371) for providing haptic events at the HIPD 1300.

Memory 1378 can include high-speed random-access memory and/or non-volatile memory, such as one or more magnetic disk storage devices, flash memory devices, or other non-volatile solid-state memory devices. Access to the memory 1378 by other components of the HIPD 1300, such as the one or more processors and the peripherals interface 1350, can be controlled by a memory controller of the controllers 1375.

In some embodiments, software components stored in the memory 1378 include one or more operating systems 1379, one or more applications 1380, one or more communication interface modules 1381, one or more graphics modules 1382, one or more data management modules 1385, which are analogous to the software components described above in reference to FIG. 11B.

In some embodiments, software components stored in the memory 1378 include a task and processing management module 1383 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 1383 uses data 1388 (e.g., device data 1390) to distribute the one or more front-end and/or back-end tasks based on communicatively coupled devices' computing resources, available power, thermal headroom, ongoing operations, and/or other factors. For example, the task and processing management module 1383 can cause the performance of one or more back-end tasks (of an operation performed at communicatively coupled AR device 1200) at the HIPD 1300 in accordance with a determination that the operation is utilizing a predetermined amount (e.g., at least 70%) of computing resources available at the AR device 1200.

In some embodiments, software components stored in the memory 1378 include an interoperability module 1384 for exchanging and utilizing information received and/or provided to distinct communicatively coupled devices. The interoperability module 1384 allows for different systems, devices, and/or applications to connect and communicate in a coordinated way without user input. In some embodiments, software components stored in the memory 1378 include an AR module 1385 that is configured to process signals based at least on sensor data for use in an AR and/or VR environment. For example, the AR processing module 1385 can be used for 3D object manipulation, gesture recognition, facial and facial expression, recognition, etc.

The memory 1378 can also include data 1388, including structured data. In some embodiments, the data 1388 can include profile data 1389, device data 1389 (including device data of one or more devices communicatively coupled with the HIPD 1300, such as device type, hardware, software, configurations, etc.), sensor data 1391, media content data 1392, application data 1393, and/or other data for performance of the features described above in reference to FIGS. 1A-9.

It should be appreciated that the HIPD computing system 1340 is an example of a computing system within the HIPD 1300, and that the HIPD 1300 can have more or fewer components than shown in the HIPD computing system 1340, combine two or more components, and/or have a different configuration and/or arrangement of the components. The various components shown in HIPD computing system 1340 are implemented in hardware, software, firmware, or a combination thereof, including one or more signal processing and/or application-specific integrated circuits.

The techniques described above in FIG. 13A-13B can be used with any device used as a human-machine interface controller. In some embodiments, an HIPD 1300 can be used in conjunction with one or more wearable device such as a head-wearable device (e.g., AR device 1200 and VR device 1210) and/or a wrist-wearable device 1100 (or components thereof).

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory computer-readable storage medium including instructions that, when executed by a computing device in communication with a head-wearable device, cause the computing device to perform:
obtaining image data captured by an imaging device communicatively coupled with an artificial-reality system;
generating a plurality of layers based on the image data, the plurality of layers including:
a first layer including an image of a real-world scene that includes a real-world object; and
a second layer including a geometric representation of the real-world scene;
in accordance with determining that the real-world object meets digital-interaction criteria, generating, via the artificial-reality system, a digital twin of the real-world object; and
while causing presentation, via the artificial-reality system, of a portion of one or more layers of the plurality of layers:
in response to an interaction with one of (i) the real-world object or (ii) the digital twin of the real-world object:
updating the second layer to create an updated second layer such that the digital twin of the real-world object is modified in response to the interaction; and
ceasing to cause presentation of the portion of the real-world scene from within the first layer.

2. The non-transitory computer-readable storage medium of claim 1, wherein the real-world scene includes another real-world object, and the instructions, when executed by the computing device, further cause the computing device to perform:
in accordance with determining the other real-world object meets the digital-interaction criteria, generating, by the artificial-reality system, another digital twin of the other real-world object; and
while causing presentation, via the artificial-reality system, of the portion of the one or more layers of the plurality of layers:
in response to another interaction with one of (i) the other real-world object, or (ii) the other digital twin of the other real-world object:
updating the second layer to create another updated second layer such that the other digital twin of the other real-world object is modified in response to the other interaction, and
ceasing to cause presentation of another portion of the real-world scene from within the first layer.

3. The non-transitory computer-readable storage medium of claim 2, wherein the instructions, when executed by the computing device, further cause the computing device to perform:
detecting the interaction at a first point in time;
while causing presentation, via the artificial-reality system, of an updated portion of one or more layers of the plurality of layers including the updated second layer:
in response to detecting the other interaction at a second point in time:
updating the updated second layer to create a subsequent updated second layer such that the other digital twin of the other real-world object is modified in response to the other interaction.

4. The non-transitory computer-readable storage medium of claim 2, wherein:
the real-world object is a portion, less than all of the other real-world object; and
the object meets different digital-interaction criteria than the other object, such that the object is responsive to a different set of interactions than the other object.

5. The non-transitory computer-readable storage medium of claim 1, wherein the instructions, when executed by the computing device, further cause the computing device to perform:
determining a visually-responsive relationship between the first and second layers of the plurality of layers such that (i) respective layers of the plurality of layers are indistinguishable to a user of the artificial-reality system while the user is viewing the plurality of layers and (ii) interactions by the user with the real-world object or the digital twin of the real-world object are interconnected.

6. The non-transitory computer-readable storage medium of claim 5, wherein determining the visually-responsive relationship includes applying the geometric representation of the real-world scene of the second layer related to the image of the real-world scene of the first layer to allow for generation of the digital twin of the real-world object.

7. The non-transitory computer-readable storage medium of claim 6, wherein the instructions, when executed by the computing device, further cause the computing device to perform:
in accordance with determining that a different portion of the real-world scene is occluded based on the updated the second layer in response to the interaction, causing presentation of a portion of the updated second layer in place of the different portion of the real-world scene.

8. The non-transitory computer-readable storage medium of claim 7, wherein the portion of the updated second layer is a camouflage layer based on the visually-responsive relationship between the first and second layers, wherein the camouflage layer is a modification of a portion of the second layer such that the modification of the portion of the second layer replaces the representation the different portion of the real-world scene.

9. The non-transitory computer-readable storage medium of claim 5, wherein the interaction at the real-world object or the digital twin of the real-world object being interconnected includes causing a modification to the second layer to account for the real-world scene of the first layer, based on the interaction such that a change between the second layer and the first layer is visually transparent.

10. The non-transitory computer-readable storage medium of claim 1, wherein:
the plurality of layers includes a third layer; and
the third layer includes one or more affordances based on the real-world scene, the third layer defining a user-interface element for interacting with the real-world object or the digital twin of the real-world object.

11. The non-transitory computer-readable storage medium of claim 10, wherein the third layer is spatially annotated to the first and second layers.

12. The non-transitory computer-readable storage medium of claim 10, wherein:
the one or more affordances are configured to provide structural scene understanding, functional scene understanding, and scene-related user understanding between the first and second layers.

13. The non-transitory computer-readable storage medium of claim 11, wherein generating the plurality of layers includes:
prompting the user to capture image data via the imaging device communicatively coupled with the artificial-reality system;
while the imaging device is active, providing instructions to the user for capturing image data of their real-world environment that defines the real-world scene;
in accordance with a determination that the image data captured by the user meets artificial-reality immersion criteria prompting the user to cease capturing image data. The non-transitory computer-readable storage medium of claim 1, wherein determining that the real-world object meets the digital-interaction criteria is based on a comparison of the first and second layers.

15. The non-transitory computer-readable storage medium of claim 1, wherein:
the real-world object includes a two-dimensional screen; and
in addition to the digital twin of the real-world object, a screen user-interface element is presented at a location corresponding to the two-dimensional screen of the real-world object.

16. A method comprising:
obtaining image data captured by an imaging device communicatively coupled with an artificial-reality system;
generating a plurality of layers based on the image data, the plurality of layers including:
a first layer including an image of a real-world scene that includes a real-world object; and
a second layer including a geometric representation of the real-world scene;
in accordance with determining that the real-world object meets digital-interaction criteria, generating, via the artificial-reality system, a digital twin of the real-world object; and
while causing presentation, via the artificial-reality system, of a portion of one or more layers of the plurality of layers:
in response to an interaction with one of (i) the real-world object or (ii) the digital twin of the real-world object:
updating the second layer to create an updated second layer such that the digital twin of the real-world object is modified in response to the interaction; and
ceasing to cause presentation of the portion of the real-world scene from within the first layer.

17. The method of claim 16, wherein the real-world scene includes another real-world object, and the method further comprises:
in accordance with determining the other real-world object meets the digital-interaction criteria, generating, by the artificial-reality system, another digital twin of the other real-world object; and
while causing presentation, via the artificial-reality system, of the portion of the one or more layers of the plurality of layers:
in response to another interaction with one of (i) the other real-world object, or (ii) the other digital twin of the other real-world object:
updating the second layer to create another updated second layer such that the other digital twin of the other real-world object is modified in response to the other interaction, and
ceasing to cause presentation of another portion of the real-world scene from within the first layer.

18. The method of claim 17, further comprising:
detecting the interaction at a first point in time;
while causing presentation, via the artificial-reality system, of an updated portion of one or more layers of the plurality of layers including the updated second layer:
in response to detecting the other interaction at a second point in time:
updating the updated second layer to create a subsequent updated second layer such that the other digital twin of the other real-world object is modified in response to the other interaction.

19. A head-wearable device, comprising:
a display;
one or more processors; and
memory including instructions that, when executed by the one or more processors, cause the head-wearable device to:
obtain image data captured by an imaging device communicatively coupled with an artificial-reality system;
generate a plurality of layers based on the image data, the plurality of layers including:
a first layer including an image of a real-world scene that includes a real-world object; and
a second layer including a geometric representation of the real-world scene;
in accordance with determining that the real-world object meets digital-interaction criteria, generate, via the artificial-reality system, a digital twin of the real-world object; and
while causing presentation, via the artificial-reality system, of a portion of one or more layers of the plurality of layers:
in response to an interaction with one of (i) the real-world object or (ii) the digital twin of the real-world object:
update the second layer to create an updated second layer such that the digital twin of the real-world object is modified in response to the interaction; and
cease to cause presentation of the portion of the real-world scene from within the first layer.

20. The head-wearable device of claim 19, wherein the real-world scene includes another real-world object, and the instructions, when executed by the one or more processors, further cause the head-wearable device to:
in accordance with determining the other real-world object meets the digital-interaction criteria, generate, by the artificial-reality system, another digital twin of the other real-world object; and
while causing presentation, via the artificial-reality system, of the portion of the one or more layers of the plurality of layers:
in response to another interaction with one of (i) the other real-world object, or (ii) the other digital twin of the other real-world object:
update the second layer to create another updated second layer such that the other digital twin of the other real-world object is modified in response to the other interaction, and
cease to cause presentation of another portion of the real-world scene from within the first layer.
